(19) United States
(12) Patent Application Publication
(10) Pub. No.: US 2005/0049381 A1
(43) Pub. Date: Mar. 3, 2005

(54) Silicon compounds

(76) Inventors: Mikio Yamahiro, Kanagawa (JP); Kazuhiro Yoshida, Kanagawa (JP); Yasuhiro Yamamoto, Kanagawa (JP); Kenichi Watanabe, Kanagawa (JP); Nobumasa Ootake, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/482,816

(22) PCT Filed: Jul. 4, 2002
(86) PCT No.: PCT/JP02/06821

(30) Foreign Application Priority Data
Jul. 5, 2001 (JP) 2001-205173
Jul. 24, 2001 (JP) 2001-223001

(51) Int. Cl. C08G 77/00

(52) U.S. Cl. 528/10

(57) ABSTRACT

The present invention relates to a novel silicon compound characterized by having a polymerization-initiating ability to polymerizable monomers and a polymer obtained using the same. Provided is a so-called organic-inorganic composite material of cage type silsesquioxane in which an organic substituent is bonded to a silicon atom and an organic polymer. A preparing method thereof is mixing with an organic polymer or copolymerization making use of a polymerizable functional group of cage type silsesquioxane. However, it is considered to be very difficult to evenly disperse an inorganic component in an organic polymer in either method and maintain characteristics thereof.
The present invention provides a silicon compound represented by Formula (1): 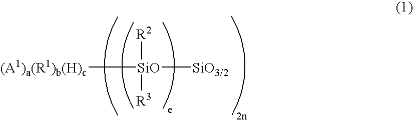
in Formula (1), A¹ is a group having a polymerization-initiating ability to a monomer; R¹ is alkyl having 2 to 10 carbon atoms; in these alkyls, at least one hydrogen may be replaced by halogen; one —CH₂— may be replaced by —O—; one hydrogen may be replaced by an aromatic group or an alicyclic group; this aromatic group or alicyclic group may have a substituent; R² and R³ are independently alkyl having 1 to 8 carbon atoms, phenyl or cyclohexyl; n is an integer of 2 to 30; e is 0 or 1; a is an integer of 1 to 2n; b is an integer of 0 to (2n−1); c is an integer of 0 to (2n−1); and the total of a, b and c is 2n. The preferred examples of A¹ are a group having halogenated alkylphenyl, a group having an MgBr group and a group having a dithiocarbamate group. If initiating the polymerization of, for example, an acrylic monomer with this silsesquioxane derivative acting as a starting point, a very homogeneous organic-inorganic composite material is obtained without causing coagulation of silsesquioxane, and therefore problems in conventional methods are solved.

### FIELD OF THE INVENTION

The present invention relates to a novel silicon compound characterized by having a polymerization-initiating ability to polymerizable monomers, and a polymer obtained using the same.

### BACKGROUND OF THE INVENTION

Si—H functional cage type silsesquioxane is a compound which can be synthesized by hydrolytic condensation of trialkoxysilane or trichlorosilane. A well known example is cage type silsesquioxane having 8 silicon atoms. In addition thereto, known are various cage type silsesquioxanes including cage type silsesquioxane having 10 silicon atoms and cage type silsesquioxane having 12 silicon atoms.

A cage type silsesquioxane derivative having a dimethylsiloxy group is known as well. A production process for this derivative is disclosed in J. Organometallic Cem., 441 (1992), 373-, J. Chem. Soc., Chem. Comm., 4 (1989), 208-, J. Sol-Gel Science and Technology, 1 (1) (1993), 57- and Sol-Gel Science and Technology, 2 (1/2/3) (1994), 127-. Both of Si—H functional cage type silsesquioxane and a cage type silsesquioxane derivative having a dimethylsiloxy group have a structure similar to the structural units of silica and zeolite, and therefore they are expected to be applied to inorganic materials of the next generation such as precursors of organic/inorganic hybrid materials, low dielectric materials, optical crystals and liquid crystal materials.

Cage type silsesquioxane in which an organic substituent such as methyl and phenyl is bonded to a silicon atom is well known as well. Those having a functional group such as 3-chloroammoniumpropyl, epoxy, vinyl ether, methacrylate and phenylpropyl as an organic substituent are known as well. In recent years, so-called organic-inorganic composite materials of organic polymers with silsesquioxane are prepared by making use of these functional groups. An example making use of, for example, an intermolecular hydrogen bond includes an example in which cage type silsesquioxane having a 3-chloroammoniumpropyl group is added to polyvinylpyrrolidone, polydimethylacrylamide, polyvinyl alcohol or polyethylene glycol. This example is reported in “Polymer Preprints, Japan”, vol. 48, No. 14, 4253 (1999). An example making use of π-π electron interaction includes an example in which phenylprpopyl group-containing cage type silsesquioxane is added to polystyrene. This example is reported in “Polymer Preprints, Japan”, vol. 48, No. 14, 4255 (1999).

An organic-inorganic composite material is obtained by polymerizing cage type silsesquioxane having a polymerizable functional group such as γ-methacryloyloxypropyl. An example in which this cage type silsesquioxane is radically polymerized with azobisisobutyronitrile being used as a catalyst is described in Macromolecules, 28 (1995), 8435-. An example in which this cage type silsesquioxane is subjected to atom transfer radical copolymerization in the coexistence of other acrylic monomers is described in Macromolecules, 33 (2000), 217-. In addition thereto, it is tried to introduce polyethylene oxide by coupling reaction of Si—H functional cage type silsesquioxane with a polymer having a double bond at a terminal (hereinafter the coupling reaction of Si—H functional cage type silsesquioxane with the polymer shall be referred to as a polymer coupling method). This example is described in Langmuir, 15 (1999), 4752-.

In the case of a cage type silsesquioxane derivative having a dimethylsiloxy group, reported are derivatives in which bonded to a silicon atom in the dimethylsiloxy group are hydrogen and functional groups such as a hydroxyl group (J. Am. Chem. Soc., 122 (2000), 6979-), an epoxy-containing group (Chemistry of Materials, 8 (1996), 1592-) and methacryloyloxy (Macromolecules, 29 (1996), 2327-). Organic-inorganic composite materials of organic polymers with silsesquioxane are prepared by making use of these functional groups. In the case of cage type silsesquioxane derivative having methacryloyloxy, organic-inorganic composite materials can be prepared as well by radically polymerizing this compound alone or in the presence of other acrylic monomers.

Organic-inorganic composite materials making use of intermolecular interaction are obtained by mechanically blending the silsesquioxanes described above with organic polymers, and therefore aggregation of silsesquioxane is not avoided. That is, it is considered that it is very difficult in this material to evenly disperse silsesquioxane as an inorganic component. This composite material makes use of weak intermolecular interaction and is considered to have problems on a water resistance and a chemical resistance. In the case of cage type silsesquioxane having a polymerizable functional group, it is not liable to be radically polymerized in terms of a structure thereof, and therefore it is considered to be very difficult that all functional groups thereof participate in polymer formation in either case of homopolymerization and copolymerization. Accordingly, a lot of unreacted matters remain in the product, and it is presumed that aggregation of silsesquioxane which does not contribute to polymerization reaction takes place. Accordingly, it is considered to be very difficult in this method to evenly disperse an inorganic component in an organic polymer and maintain the stable characteristics. In a polymer coupling method, a polymer itself has a structure of a very low motility, and a concentration of the terminal group which contributes to the reaction is low, so that it is difficult that the whole of the polymer takes part in coupling reaction with cage type silsesquioxane. As a result thereof, it is considered that an amount of the polymer chain introduced into the inorganic component is restricted. In the foregoing conventional technique for preparing an organic-inorganic composite material, it is considered to be difficult in any case to evenly disperse the inorganic component in the organic polymer.

### DISCLOSURE OF THE INVENTION

An object of the present invention is to solve these problems in producing an organic-inorganic composite material.

The present inventors have investigated a method for evenly dispersing a cage type silsesquioxane in an organic polymer, and obtained an idea to provide this silsesquioxane with a function as a polymerization initiator. That is, if a cage type silsesquioxane derivative having a polymerization-initiating ability is used to initiate the polymerization of, for example, an acrylic monomer, an organic polymer can be formed with this silsesquioxane derivative acting as a starting point. A very homogeneous organic-inorganic composite material is obtained by this method without causing aggregation of silsesquioxane, and therefore problems in conventional methods are solved. In particular, in the case of silsesquioxane having a diorganosiloxy group, a polymerization-initiating point is strongly bonded to cage type silsesquioxane via the diorganosiloxy group which is highly flexible, and therefore an organic-inorganic composite material showing characteristics, which are quite different from previous data, is expected to be obtained. Accordingly, the present invention is expected to bring about variety on the characteristics and the uses of silsesquioxane.

That is, the present invention comprises the following structures. In the present invention, all of alkyl, alkylene, alkenyl, alkenylene, alkoxy, alkenyloxy and halides thereof are used as terms including the branched groups.

[1] A silicon compound represented by Formula (1): 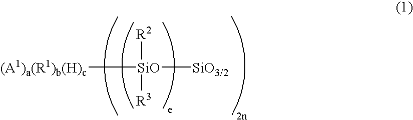
wherein symbols in Formula (1) are defined as follows;
A¹ is a group having a polymerization-initiating ability to a monomer;
R¹ is alkyl having 2 to 10 carbon atoms; in these alkyls, at least one hydrogen may be replaced by halogen, one —CH₂— may be replaced by —O—, and one hydrogen may be replaced by an aromatic group or an alicyclic group; and this aromatic group or alicyclic group may have a substituent;
R² and R³ are independently alkyl having 1 to 8 carbon atoms, phenyl or cyclohexyl;
n is an integer of 2 to 30;
e is 0 or 1;
a is an integer of 1 to 2n, b is an integer of 0 to (2n−1), c is an integer of 0 to (2n−1); and the total of a, b and c is 2n.

[2] The silicon compound as described in the item [1], wherein A¹ in Formula (1) is a group selected from a group having halogenated alkylphenyl, a group having an MgBr group and a group having a dithiocarbamate group.

[3] The silicon compound as described in the item 1, wherein A¹ in Formula (1) is the group having halogenated alkylphenyl.

[4] The silicon compound as described in the item 3, wherein the group having halogenated alkylphenyl is a group represented by Formula (2): 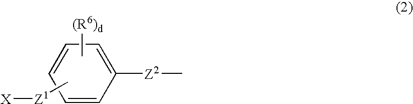
wherein symbols and the bonding positions of the substituents in Formula (2) are defined as follows;
X is halogen;
Z¹ is alkylene having 1 to 3 carbon atoms; Z² is alkylene having 2 to 10 carbon atoms; in these alkylenes, one —CH₂— may be replaced by —O—; and a bonding position of Z¹ to the benzene ring is a meta position or a para position to a bonding position of Z²;
R⁶ is alkyl having 1 to 3 carbon atoms; and a bonding position of R⁶ to the benzene ring is an optional position excluding the respective bonding positions of Z¹ and Z²; and
d is an integer of 0 to 2.

[5] The silicon compound as described in the item 4, wherein Z² in Formula (2) is Z³-C₂H₄—; Z³ is a single bond or alkylene having 1 to 8 carbon atoms; and in this alkylene, one —CH₂— may be replaced by —O—.

[6] The silicon compound as described in any one of items 1 to 5, wherein in Formula (1) as described in the item 1, both of R² and R³ are methyl, and n is an integer of 3 to 5.

[7] The silicon compound as described in the item 4 or 5, wherein in Formula (1) as described in the item 1, both of R² and R³ are methyl; a is 8; n is 4; and in Formula (2) as described in the item 4, d is 0.

[8] The silicon compound as described in the item 7, wherein in Formula (2) as described in the item 4, Z¹ is —CH₂— and Z² is —CH₂CH₂—.

[9] The silicon compound as described in the item 1, wherein A¹ in Formula (1) is the group having a dithiocarbamate group.

[10] The silicon compound as described in the item 9, wherein the group having a dithiocarbamate group is a group represented by Formula (3): 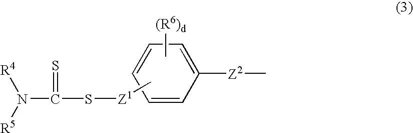
wherein symbols and the bonding positions of the substituents in Formula (3) are defined as follows;
R⁴ and R⁵ are independently hydrogen, alkyl having 1 to 12 carbon atoms, an alicyclic group having 5 to 10 carbon atoms or an aromatic group having 6 to 10 carbon atoms;
R⁴ and R⁵ may be combined with each other to form a ring together with N;
Z¹ is alkylene having 1 to 3 carbon atoms; Z² is alkylene having 2 to 10 carbon atoms; in these alkylenes, one —CH₂— may be replaced by —O—; and a bonding position of Z¹ to the benzene ring is a meta position or a para position to a bonding position of Z²;
R⁶ is alkyl having 1 to 3 carbon atoms; and a bonding position of R⁶ to the benzene ring is an optional position excluding the respective bonding positions of Z¹ and Z²; and
d is an integer of 0 to 2.

[11] The silicon compound as described in the item 10, wherein Z² in Formula (3) is a group represented by Z³-C₂H₄—; Z³ is a single bond or alkylene having 1 to 8 carbon atoms; and in this alkylene, one —CH₂— may be replaced by —O—.

[12] The silicon compound as described in any one of the items 9 to 11, wherein in Formula (1) as described in the item 1, both of R² and R³ are methyl, and n is an integer of 3 to 5.

[13] The silicon compound as described in the item 10 or 11, wherein in Formula (1) as described in the item 1, both of R² and R³ are methyl; a is 8; n is 4; and in Formula (3) as described in the item 10, both of R⁴ and R⁵ are ethyl, and d is 0.

[14] The silicon compound as described in the item 13, wherein in Formula (3) as described in the item 10, Z¹ is —CH₂— and Z² is —CH₂CH₂—.

[15] A production process for a compound represented by Formula (1-1), characterized by carrying out, in the presence of a transition metal base catalyst, any of a process in which a compound represented by Formula (5) is reacted with a compound represented by Formula (6), a process in which the compound represented by Formula (5) is reacted with the compound represented by Formula (6) and a compound represented by Formula (7) at the same time, a process in which the compound represented by Formula (5) is reacted with the compound represented by Formula (6) and then reacted with the compound represented by Formula (7), and a process in which the compound represented by Formula (5) is reacted with the compound represented by Formula (7) and then reacted with the compound represented by Formula (6): 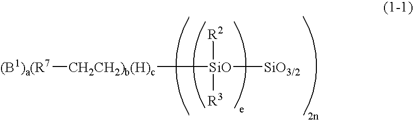
wherein symbols in Formula (1-1) are defined as follows;
R², R³, a, b, c, e and n each are the same as these symbols in Formula (1) as described in the item 1;
R⁷ is hydrogen, halogen or alkyl having 1 to 8 carbon atoms; in these alkyls, at least one hydrogen may be replaced by halogen, one —CH₂— may be replaced by —O— and one hydrogen may be replaced by an aromatic group or an alicyclic group; and this aromatic group or alicyclic group may have a substituent;
B¹ is a group represented by the following Formula (4): 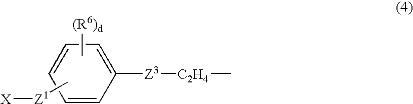
   wherein symbols and the bonding positions of the substituents in Formula (4) are defined as follows;
X, Z¹, R⁶ and d each are the same as these symbols in Formula (2) as described in the item 4;
Z³ is a single bond or alkylene having 1 to 8 carbon atoms; in this alkylene, one —CH₂— may be replaced by —O—;
a bonding position of Z¹ to the benzene ring is a meta position or a para position to a bonding position of Z³; and
a bonding position of R⁶ to the benzene ring is an optional position excluding the respective bonding positions of Z¹ and Z³; 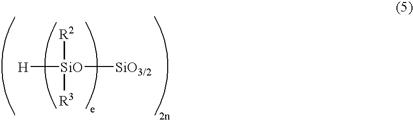
   wherein R², R³, e and n in Formula (5) each are the same as these symbols in Formula (1-1); 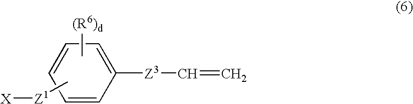
   wherein symbols and the bonding positions of the substituents in Formula (6) each are the same as the symbols and the bonding positions of the substituents in Formula (4);
   R⁷—CH═CH₂ (7)
   wherein R⁷ in Formula (7) is the same as R⁷ in Formula (1-1).

[16] A production process for a silicon compound represented by Formula (1-2), characterized by reacting the compound represented by Formula (1-1) as described in the item 15 with a compound represented by Formula (9): 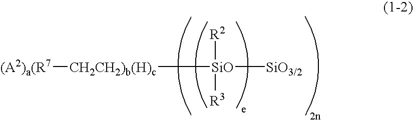
wherein symbols in Formula (1-2) are defined as follows;
R², R³, R⁷, a, b, c, e and n each are the same as these symbols in Formula (1-1) as described in the item 15;
A² is a group represented by the following Formula (8): 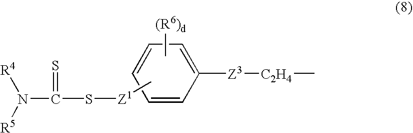
   wherein symbols and the bonding positions of the substituents in Formula (8) are defined as follows;
R⁴ to R⁶, Z¹ and d each are the same as these symbols in Formula (3) as described in the item 10;
Z³ is a single bond or alkylene having 1 to 8 carbon atoms; in this alkylene, one —CH₂— may be replaced by —O—;
a bonding position of Z¹ to the benzene ring is a meta position or a para position to a bonding position of Z³;
a bonding position of R⁶ to the benzene ring is an optional position excluding the respective bonding positions of Z¹ and Z³; 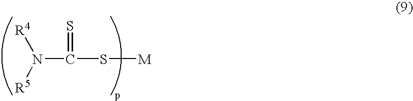
   wherein symbols in Formula (9) are defined as follows;
R⁴ and R⁵ each are the same as these symbols in Formula (8);
M is a metal element of the first group or the second group in the periodic table; and
p is the same value as an atomic value of M.

[17] A production process for the compound represented by Formula (1-2) as described in the item 16, characterized by carrying out the following step (a) and then (b);
(a) a step in which a compound represented by Formula (6) is reacted with a compound represented by Formula (9) to obtain a compound represented by Formula (10): 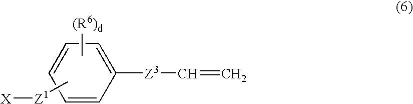
   wherein symbols and the bonding positions of the substituents in Formula (6) are defined as follows;
X is halogen;
Z¹, Z³, R⁶, d and the bonding positions of the substituents each are the same as these symbols and the bonding positions of the substituents in Formula (8) as described in the item 16; 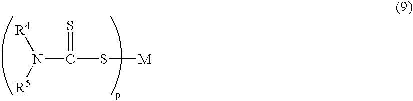
   wherein symbols in Formula (9) are defined as follows;
R⁴ and R⁵ are the same as these symbols in Formula (8) as described in the item 16;
M is a metal element of the first group or the second group in the periodic table; and
p is the same value as an atomic value of M; 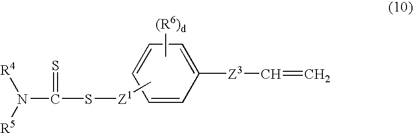
   wherein symbols and the bonding positions of the substituents in Formula (10) each are the same as the symbols and the bonding positions of the substituents in Formula (8) as described in the item 16;
   (b) a step for obtaining the compound represented by Formula (1-2) by carrying out, in the presence of a transition metal base catalyst, any of a process in which a compound represented by Formula (5) is reacted with the compound represented by Formula (10), a process in which the compound represented by Formula (5) is reacted with the compound represented by Formula (10) and a compound represented by Formula (7) at the same time, a process in which the compound represented by Formula (5) is reacted with the compound represented by Formula (10) and then reacted with the compound represented by Formula (7), and a process in which the compound represented by Formula (5) is reacted with the compound represented by Formula (7) and then reacted with the compound represented by Formula (10): 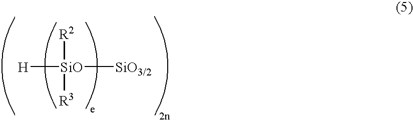
      wherein R², R³, e and n in Formula (5) each are the same as these symbols in Formula (1-2) as described in the item 16;
      R⁷—CH═CH₂ (7)
      wherein R⁷ in Formula (7) is the same as R⁷ in Formula (1-2) as described in the item 16.

[18] A silicon compound obtained by polymerizing a vinyl type monomer with the compound represented by Formula (1) as described in the item 1 being used as an initiator.

[19] A silicon compound represented by Formula (11) obtained by polymerizing a vinyl type monomer with the compound represented by Formula (1-1) as described in the item 15 being used as an initiator and a transition metal complex being used as a catalyst: 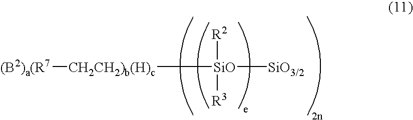
wherein symbols in Formula (11) are defined as follows;
R², R³, R⁷, a, b, c, e and n each are the same as these symbols in Formula (1-1) as described in the item 15;
B² is represented by the following Formula (4-1): 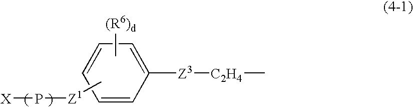
   wherein symbols and the bonding positions of the substituents in Formula (4-1) are defined as follows;
X, Z¹, R⁶, d, Z³ and the bonding positions of the substituents each are the same as these symbols and the bonding positions in Formula (4) as described in the item 15; and
P is a vinyl based polymer.

[20] A silicon compound represented by Formula (12) obtained by photopolymerizing a vinyl type monomer with the compound represented by Formula (1-2) as described in the item 16 being used as an initiator: 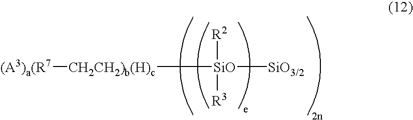
wherein symbols and the bonding positions of the substituents in Formula (12) are defined as follows;
R², R³, R⁷, a, b, c, e and n each are the same as these symbols in Formula (1-2) as described in the item 16;
A³ is represented by the following Formula (8-1): 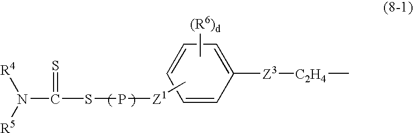
   wherein symbols and the bonding positions of the substituents in Formula (8-1) are defined as follows;
R⁴ to R⁶, Z¹, d, Z³ and the bonding positions of the substituents each are the same as these symbols and the bonding positions of the substituents in Formula (8) as described in the item 16; and
P is a vinyl based polymer.

[21] The silicon compound as described in any one of the items 18 to 20, wherein the vinyl type monomer is at least one compound selected from the group consisting of styrene derivatives and (meth)acrylic acid derivatives.

[22] The silicon compound as described in any one of the items 18 to 20, wherein the vinyl type monomer is at least one compound selected from the group consisting of the (meth)acrylic acid derivatives.

[23] A production process for a silicon compound represented by Formula (11), characterized by polymerizing a vinyl type monomer with the compound represented by Formula (1-1) as described in the item 15 being used as an initiator and a transition metal complex being used as a catalyst: 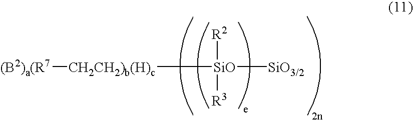
wherein symbols in Formula (11) are defined as follows;
R², R³, R⁷, a, b, c, e and n each are the same as these symbols in Formula (1-1) as described in the item 15;
B² is represented by the following Formula (4-1): 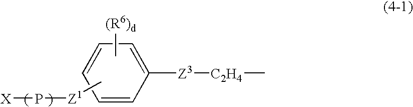
   wherein symbols and the bonding positions of the substituents in Formula (4-1) are defined as follows;
X, Z¹, R⁶, d, Z³ and the bonding positions of the substituents each are the same as these symbols and the bonding positions of the substituents in Formula (4) as described in the item 15; and
P is a vinyl based polymer.

[24] A production process for a silicon compound represented by Formula (12), characterized by photopolymerizing a vinyl type monomer with the compound represented by Formula (1-2) as described in the item 16 being used as an initiator: 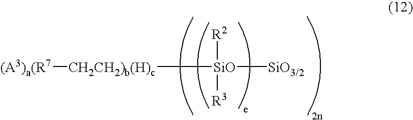
wherein symbols and the bonding positions of the substituents in Formula (12) are defined as follows;
R², R³, R⁷, a, b, c, e and n each are the same as these symbols in Formula (1-2) as described in the item 16;
A³ is represented by the following Formula (8-1): 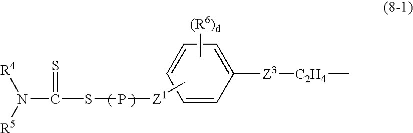
   wherein symbols and the bonding positions of the substituents in Formula (8-1) are defined as follows;
R⁴ to R⁶, Z¹, d, Z³ and the bonding positions of the substituents each are the same as these symbols and the bonding positions of the substituents in Formula (8) as described in the item 16; and
P is a vinyl based polymer.

In the following explanations, the compound represented by Formula (1) may be shown as the compound (1). The compounds represented by the other formulas may be shown as the abbreviations by the same method.

The silicon compound of the present invention is represented by Formula (1). 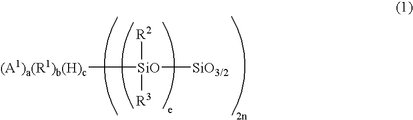
A¹ in the formula is a group having a polymerization-initiating ability to a monomer. The term a showing the number of this A¹ is an integer of 1 to 2n. That is, the compound (1) is a compound having at least one A¹. The compound (1) having 2n A¹s is preferred.

The examples of A¹ are a group having halogenated alkylphenyl, a group having an MgBr group and a group having a dithiocarbamate group.

The group having halogenated alkylphenyl generates a radical in the presence of a copper chloride/amine complex, and it is an initiator in the presence of silver perchlorate. The examples of halogenated alkylphenyl are chloromethylphenyl, bromomethylphenyl and iodomethylphenyl.

The MgBr group can be introduced in the following manner. First, a silsesquioxane derivative having a double bond such as a styryl group and a vinyl group is prepared. Next, a borane-dimethyl sulfide complex is used to carry out hydroboration of a double bond part in this derivative to prepare a silsesquioxane derivative having boron. Then, this silsesquioxane derivative having boron is reacted with pentane-1,5-diyl-di(magnesium bromide), whereby an MgBr group can be introduced. The silsesquioxane derivative of a Grignard type thus obtained can be used as an anionic polymerization initiator for styrene and methyl (meth)acrylate.

The most preferred examples of A¹ are a group having halogenated alkylphenyl and a group having a dithiocarbamate group. An atom transfer radical polymerization method is known as a polymerization method using halogenated alkylphenyl as a group for initiating radical polymerization. In this method, a metal complex comprising an 8th group, 9th group, 10th group or 11th group element in the periodic table as a central metal is used as a catalyst. In this atom transfer radical polymerization, it is known that halogenated alkylphenyl has an excellent polymerization-initiating ability. Further, it is well known as well that this polymerization is like living polymerization. That is, the silicon compound of the present invention having halogenated alkylphenyl has an excellent polymerization-initiating ability in the presence of a transition metal catalyst, and can continue to maintain a living polymerizability. Thus, it can initiate polymerization of all radically polymerizable monomers.

On the other hand, a photo-iniferter (photo initiator-transfer agent-terminator) polymerization method is known as a photopolymerization method using a dithiocarbamate group as a polymerization-initiating group. In this photo-iniferter polymerization, it is well known that a dithiocarbamate group is radically dissociated by virtue of light and that it has an excellent polymerization-initiating ability and sensitizing ability. It is well known as well that this photopolymerization is like living polymerization. Accordingly, the silicon compound of the present invention having a dithiocarbamate group can continue to maintain a living polymerizability as long as it is irradiated with light, and it has a photopolymerization-initiating ability to all radically polymerizable monomers.

Halogenated alkylphenyl has a strong electrophilicity, and therefore an amino group, a hydroxyl group and a mercapto group can be introduced into the silicon compound of the present invention having halogenated alkylphenyl by making use of various electrophilic reagents. That is, this silicon compound can efficiently be used as a useful intermediate. A dithiocarbamate group has a radiation resistance, a pharmacological activity such as a weeding effect, a complex-forming ability and a hydrophilicity in addition to the characteristics as a photopolymerization-initiating group, and therefore it is possible to efficiently use these characteristics.

The preferred group having halogenated alkylphenyl is a group represented by Formula (2).

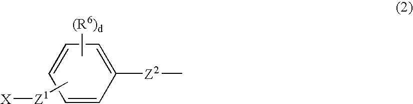

X in Formula (2) is halogen such as Cl, Br and I. Cl and Br are most preferred as an initiating group for atom transfer radical polymerization. Z¹ is alkylene having 1 to 3 carbon atoms. The examples of Z¹ are methylene, 1,2-ethylene, 1,1-ethylene, 1,3-trimethylene, ethylmethylene, 1-methy-1,2-ethylene and 2-methy-1,2-ethylene. The preferred example of Z¹ is methylene. Z² is alkylene having 2 to 10 carbon atoms. In this alkylene, one —CH₂— may be replaced by —O—. A bonding position of Z¹ to the benzene ring is a meta position or a para position to a bonding position of Z². R⁶ is alkyl having 1 to 3 carbon atoms. The examples of R⁶ are methyl, ethyl, propyl and isopropyl. Preferred R⁶ is methyl. The term d showing the number of R⁶ is 0, 1 or 2, and d is preferably 0. A bonding position of R⁶ to the benzene ring may be any position excluding the bonding positions of Z¹ and Z².

Various methods for bonding an organic group to Si can be applied. Representative methods for obtaining the derivative which is not hydrolyzed are a method in which a Grignard reagent is reacted with Si-halogen and a method in which a compound having an aliphatic unsaturated bond is reacted with Si—H. The latter is usually called the hydrosilylation reaction method. In the present invention, the hydrosilylation reaction method is rather liable to be applied in terms of availability of the raw materials. That is, a preferred method for introducing a functional group into a silsesquioxane derivative is a method in which an Si—H functional silsesquioxane derivative is combined with a compound having an unsaturated bond at a terminal by hydrosilylation reaction. Accordingly, the preferred example of Z² in Formula (2) is a group represented by Z³-C₂H₄—.

That is, the preferred example of Formula (2) is Formula (4): 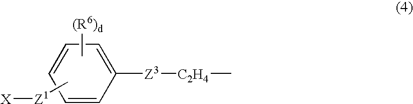
Z³ in this formula is a single bond or alkylene having 1 to 8 carbon atoms. In these alkylenes, one —CH₂— may be replaced by —O—. That is, the preferred examples of Z² in Formula (2) are —C₂H₄—, —C₃H₆—, —OC₂H₄—, —OC₃H₆—, —CH₂OC₂H₄—, —CH₂OC₃H₆—, —C₂H₄OC₂H₄— and —C₂H₄OC₃H₆—. However, the selected range of Z² shall not be restricted to them. The other symbols and the bonding positions of the substituents in Formula (4) each are the same as the symbols and the bonding positions of the substituents in Formula (2).

The preferred group having a dithiocarbamate group is a group represented by Formula (3):

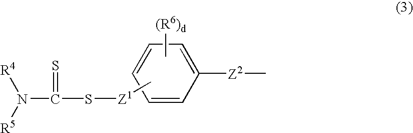

Z¹, Z², R⁶ and d in Formula (3) are defined in the same manner as in these symbols in Formula (2), and the bonding positions of Z¹ and R⁶ are defined as well in the same manner as in Formula (2). R⁴ and R⁵ are independently hydrogen, alkyl having 1 to 12 carbon atoms, an alicyclic group having 5 to 10 carbon atoms or an aromatic group having 6 to 10 carbon atoms. The preferred examples of R⁴ or R⁵ other than hydrogen are methyl, ethyl, propyl, isopropyl, butyl, isobutyl, pentyl, 2-mehtylbutyl, hexyl, 2-methylpentyl, heptyl, 2-mehtylhextyl, octyl, 2-mehtylheptyl, 2-ehtylhextyl, decyl, phenyl, cyclopentyl and cyclohexyl. Both of R⁴ and R⁵ may be one of these groups, or one of R⁴ and R⁵ may be one of these groups and the other may be hydrogen.

R⁴ and R⁵ may be combined with each other to form a ring together with N. In this case, the examples of a dithiocarbamate group are N-cyclotrimethylenedithiocarbamate, N-cyclotetramethylenedithiocarbamate, N-cyclopentamethylenedithiocarbamate, N-cyclohexamethylenedithiocarbamate, N-cycloheptamethylenedithiocarbamate and N-cyclooctamethylenedithiocarbamate. The preferred dithiocarbamate groups are N,N-dimethyldithiocarbamate, N,N-diethyldithiocarbamate, N-methyldithiocarbamate and N-ethyldithiocarbamate. N,N-diethyldithiocarbamate is most preferred.

Z² in Formula (3) is preferably a group represented by Z³-C₂H₄— as is the case with Formula (2). That is, the preferred example of Formula (3) is Formula (8):

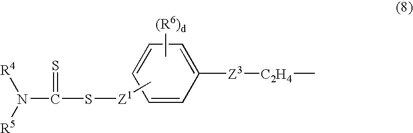

Z³ in this formula is defined in the same manner as in Z³ in Formula (4), and the other symbols and the bonding positions of the substituents each are the same as the symbols and the bonding positions of the substituents in Formula (3).

R¹ in Formula (1) is alkyl having 2 to 10 carbon atoms. In this alkyl, at least one hydrogen may be replaced by halogen, one —CH₂— may be replaced by —O—, and one hydrogen may be replaced by an aromatic group or an alicyclic group. In this case, preferred halogen is chlorine or fluorine, and the aromatic group or alicyclic group may have a substituent. Also when this R¹ is bonded to Si, it is carried out preferably by hydrosilylation reaction. Then, R¹ is represented by R⁷—C₂H₄, because the compound represented by Formula (7) is used:
R⁷—CH═CH₂ (7)
This R⁷ is hydrogen, chlorine or alkyl having 1 to 8 carbon atoms. In these alkyls, at least one hydrogen may be replaced by halogen, one —CH₂— may be replaced by —O—, and one hydrogen may be replaced by an aromatic group or an alicyclic group. In this case, preferred halogen is chlorine or fluorine, and the aromatic group or alicyclic group may have a substituent.

A part of the specific examples of such R¹ includes fluoroethyloxypropyl, difluoroethyloxypropyl, phenethyl, phenylpropyl, phenoxyethyl, phenoxypropyl, benzyloxyethyl, benzyloxypropyl, phenethyloxyethyl, phenethyloxypropyl, cyclopentyloxypropyl and cyclohexyloxypropyl. The term b showing the number of R¹ is an integer of 0 to (2n−1). That is, R¹ is a group which is introduced if necessary, and is not an essential group.

R² and R³ in Formula (1) are independently alkyl having 1 to 8 carbon atoms, phenyl or cyclohexyl. The examples of the alkyl are methyl, ethyl, propyl, isopropyl, butyl, isobutyl, pentyl, 2-mehtylbutyl, hexyl, 2-methylpentyl, heptyl, 2-mehtylhextyl, octyl, 2-mehtylheptyl and 2-ehtylhextyl. The most preferred alkyl is methyl. The term e is 0 or 1. When e is 1, the silicon compound of the present invention is a compound in which this diorganosiloxy is bonded to all Si constituting the skeleton of silsesquioxane. In this compound, A¹, R¹ and H are bonded to Si of diorganosiloxy.

The term c in Formula (1) is an integer of 0 to (2n−1). When the Si—H functional silsesquioxane derivative is used as the raw material, a part of Si—H groups can be allowed to remain by controlling a molar ratio in the reaction system. Hydrosilylation reaction goes on almost quantitatively, and therefore all Si—H can readily be reacted. The term n in Formula (1) is an integer of 2 to 30, preferably 3 to 5, and it is more preferably 4. And, the total of a, b and c is 2n.

Next, a part of the specific examples of the silicon compound of the present invention shall be shown in Tables 2 to 25 using codes shown in Table 1. These examples are based on the following Formula (13) and Formula (14). In these formulas, the following definitions are selected. That is, in Formula (1), both of R² and R³ are methyl, n is 4, and R¹ is R⁷—C₂H₄. In Formula (2) and Formula (3), Z¹ is —CH₂—, Z² is Z³—C₂H₄, and d is 0. X in Formula (2) is Cl, and both of R⁴ and R⁵ in Formula (3) are ethyl.

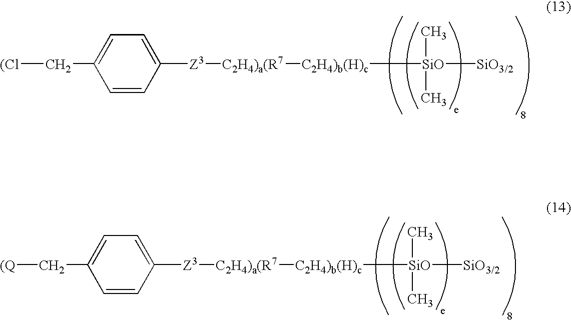

TABLE 1

| SYMBOL | FORMULA |
|---|---|
| CL | Cl— |
| Q | 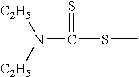 |
| T8 | 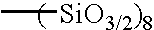 |
| (DT)8 | 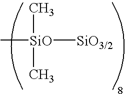 |
| — | SINGLE BOND |
| C1 | —CH₂— |
| C2 | —CH₂CH₂— |
| C3 | —CH₂CH₂CH₂— |
| B | 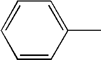 |
| Ph | 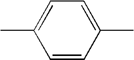 |
| ( )ₘ | ( )ₘ m:2˜8 |

TABLE 2

| No. | Z³ | a | R⁷ | b | c | e | Formula(13) |
|---|---|---|---|---|---|---|---|
| 1 | — | 1 | | 0 | 7 | 0 | (CL-C1-Ph—C2)(H)7-T8 |
| 2 | — | 2 | | 0 | 6 | 0 | (CL-C1-Ph—C2)2(H)6-T8 |
| 3 | — | 3 | | 0 | 5 | 0 | (CL-C1-Ph—C2)3(H)5-T8 |
| 4 | — | 4 | | 0 | 4 | 0 | (CL-C1-Ph—C2)4(H)4-T8 |
| 5 | — | 5 | | 0 | 3 | 0 | (CL-C1-Ph—C2)5(H)3-T8 |
| 6 | — | 6 | | 0 | 2 | 0 | (CL-C1-Ph—C2)6(H)2-T8 |
| 7 | — | 7 | | 0 | 1 | 0 | (CL-C1-Ph—C2)7(H)-T8 |
| 8 | — | 8 | | 0 | 0 | 0 | (CL-C1-Ph—C2)8-T8 |
| 9 | C1 | 1 | | 0 | 7 | 0 | (CL-C1-Ph—C3)(H)7-T8 |
| 10 | C1 | 2 | | 0 | 6 | 0 | (CL-C1-Ph—C3)2(H)6-T8 |
| 11 | C1 | 3 | | 0 | 5 | 0 | (CL-C1-Ph—C3)3(H)5-T8 |
| 12 | C1 | 4 | | 0 | 4 | 0 | (CL-C1-Ph—C3)4(H)4-T8 |
| 13 | C1 | 5 | | 0 | 3 | 0 | (CL-C1-Ph—C3)5(H)3-T8 |
| 14 | C1 | 6 | | 0 | 2 | 0 | (CL-C1-Ph—C3)6(H)2-T8 |
| 15 | C1 | 7 | | 0 | 1 | 0 | (CL-C1-Ph—C3)7(H)-T8 |
| 16 | C1 | 8 | | 0 | 0 | 0 | (CL-C1-Ph—C3)8-T8 |
| 17 | O | 1 | | 0 | 7 | 0 | (CL-C1-Ph—O—C2)(H)7-T8 |
| 18 | O | 2 | | 0 | 6 | 0 | (CL-C1-Ph—O—C2)2(H)6-T8 |
| 19 | O | 3 | | 0 | 5 | 0 | (CL-C1-Ph—O—C2)3(H)5-T8 |
| 20 | O | 4 | | 0 | 4 | 0 | (CL-C1-Ph—O—C2)4(H)4-T8 |
| 21 | O | 5 | | 0 | 3 | 0 | (CL-C1-Ph—O—C2)5(H)3-T8 |
| 22 | O | 6 | | 0 | 2 | 0 | (CL-C1-Ph—O—C2)6(H)2-T8 |
| 23 | O | 7 | | 0 | 1 | 0 | (CL-C1-Ph—O—C2)7(H)-T8 |
| 24 | O | 8 | | 0 | 0 | 0 | (CL-C1-Ph—O—C2)8-T8 |
| 25 | O—C1 | 1 | | 0 | 7 | 0 | (CL-C1-Ph—O—C3)(H)7-T8 |
| 26 | O—C1 | 2 | | 0 | 6 | 0 | (CL-C1-Ph—O—C3)2(H)6-T8 |
| 27 | O—C1 | 3 | | 0 | 5 | 0 | (CL-C1-Ph—O—C3)3(H)5-T8 |
| 28 | O—C1 | 4 | | 0 | 4 | 0 | (CL-C1-Ph—O—C3)4(H)4-T8 |
| 29 | O—C1 | 5 | | 0 | 3 | 0 | (CL-C1-Ph—O—C3)5(H)3-T8 |
| 30 | O—C1 | 6 | | 0 | 2 | 0 | (CL-C1-Ph—O—C3)6(H)2-T8 |
| 31 | O—C1 | 7 | | 0 | 1 | 0 | (CL-C1-Ph—O—C3)7(H)-T8 |
| 32 | O—C1 | 8 | | 0 | 0 | 0 | (CL-C1-Ph—O—C3)8-T8 |

TABLE 3

| No. | Z³ | a | R⁷ | b | c | e | Formula(13) |
|---|---|---|---|---|---|---|---|
| 1 | C1-O | 1 | | 0 | 7 | 0 | (CL-C1-Ph—C1-O—C2)(H)7-T8 |
| 2 | C1-O | 2 | | 0 | 6 | 0 | (CL-C1-Ph—C1-O—C2)2(H)6-T8 |
| 3 | C1-O | 3 | | 0 | 5 | 0 | (CL-C1-Ph—C1-O—C2)3(H)5-T8 |
| 4 | C1-O | 4 | | 0 | 4 | 0 | (CL-C1-Ph—C1-O—C2)4(H)4-T8 |
| 5 | C1-O | 5 | | 0 | 3 | 0 | (CL-C1-Ph—C1-O—C2)5(H)3-T8 |
| 6 | C1-O | 6 | | 0 | 2 | 0 | (CL-C1-Ph—C1-O—C2)6(H)2-T8 |
| 7 | C1-O | 7 | | 0 | 1 | 0 | (CL-C1-Ph—C1-O—C2)7(H)-T8 |
| 8 | C1-O | 8 | | 0 | 0 | 0 | (CL-C1-Ph—C1-O—C2)8-T8 |
| 9 | C1-O—C1 | 1 | | 0 | 7 | 0 | (CL-C1-Ph—C1-O—C3)(H)7-T8 |
| 10 | C1-O—C1 | 2 | | 0 | 6 | 0 | (CL-C1-Ph—C1-O—C3)2(H)6-T8 |
| 11 | C1-O—C1 | 3 | | 0 | 5 | 0 | (CL-C1-Ph—C1-O—C3)3(H)5-T8 |
| 12 | C1-O—C1 | 4 | | 0 | 4 | 0 | (CL-C1-Ph—C1-O—C3)4(H)4-T8 |
| 13 | C1-O—C1 | 5 | | 0 | 3 | 0 | (CL-C1-Ph—C1-O—C3)5(H)3-T8 |
| 14 | C1-O—C1 | 6 | | 0 | 2 | 0 | (CL-C1-Ph—C1-O—C3)6(H)2-T8 |
| 15 | C1-O—C1 | 7 | | 0 | 1 | 0 | (CL-C1-Ph—C1-O—C3)7(H)-T8 |
| 16 | C1-O—C1 | 8 | | 0 | 0 | 0 | (CL-C1-Ph—C1-O—C3)8-T8 |
| 17 | C2-O | 1 | | 0 | 7 | 0 | (CL-C1-Ph—C2-O—C2)(H)7-T8 |
| 18 | C2-O | 2 | | 0 | 6 | 0 | (CL-C1-Ph—C2-O—C2)2(H)6-T8 |
| 19 | C2-O | 3 | | 0 | 5 | 0 | (CL-C1-Ph—C2-O—C2)3(H)5-T8 |
| 20 | C2-O | 4 | | 0 | 4 | 0 | (CL-C1-Ph—C2-O—C2)4(H)4-T8 |
| 21 | C2-O | 5 | | 0 | 3 | 0 | (CL-C1-Ph—C2-O—C2)5(H)3-T8 |
| 22 | C2-O | 6 | | 0 | 2 | 0 | (CL-C1-Ph—C2-O—C2)6(H)2-T8 |
| 23 | C2-O | 7 | | 0 | 1 | 0 | (CL-C1-Ph—C2-O—C2)7(H)-T8 |
| 24 | C2-O | 8 | | 0 | 0 | 0 | (CL-C1-Ph—C2-O—C2)8-T8 |
| 25 | C2-O—C1 | 1 | | 0 | 7 | 0 | (CL-C1-Ph—C2-O—C3)(H)7-T8 |
| 26 | C2-O—C1 | 2 | | 0 | 6 | 0 | (CL-C1-Ph—C2-O—C3)2(H)6-T8 |
| 27 | C2-O—C1 | 3 | | 0 | 5 | 0 | (CL-C1-Ph—C2-O—C3)3(H)5-T8 |
| 28 | C2-O—C1 | 4 | | 0 | 4 | 0 | (CL-C1-Ph—C2-O—C3)4(H)4-T8 |
| 29 | C2-O—C1 | 5 | | 0 | 3 | 0 | (CL-C1-Ph—C2-O—C3)5(H)3-T8 |
| 30 | C2-O—C1 | 6 | | 0 | 2 | 0 | (CL-C1-Ph—C2-O—C3)6(H)2-T8 |
| 31 | C2-O—C1 | 7 | | 0 | 1 | 0 | (CL-C1-Ph—C2-O—C3)7(H)-T8 |
| 32 | C2-O—C1 | 8 | | 0 | 0 | 0 | (CL-C1-Ph—C2-O—C3)8-T8 |

TABLE 4

| No. | Z³ | a | R⁷ | b | c | e | Formula(13) |
|---|---|---|---|---|---|---|---|
| 1 | — | 1 | B | 7 | 0 | 0 | (CL-C1-Ph—C2)(B—C2)7-T8 |
| 2 | — | 2 | B | 6 | 0 | 0 | (CL-C1-Ph—C2)2(B—C2)6-T8 |
| 3 | — | 3 | B | 5 | 0 | 0 | (CL-C1-Ph—C2)3(B—C2)5-T8 |
| 4 | — | 4 | B | 4 | 0 | 0 | (CL-C1-Ph—C2)4(B—C2)4-T8 |
| 5 | — | 5 | B | 3 | 0 | 0 | (CL-C1-Ph—C2)5(B—C2)3-T8 |
| 6 | — | 6 | B | 2 | 0 | 0 | (CL-C1-Ph—C2)6(B—C2)2-T8 |
| 7 | — | 7 | B | 1 | 0 | 0 | (CL-C1-Ph—C2)7(B—C2)-T8 |
| 8 | C1 | 1 | B | 7 | 0 | 0 | (CL-C1-Ph—C3)(B—C2)7-T8 |
| 9 | C1 | 2 | B | 6 | 0 | 0 | (CL-C1-Ph—C3)2(B—C2)6-T8 |
| 10 | C1 | 3 | B | 5 | 0 | 0 | (CL-C1-Ph—C3)3(B—C2)5-T8 |
| 11 | C1 | 4 | B | 4 | 0 | 0 | (CL-C1-Ph—C3)4(B—C2)4-T8 |
| 12 | C1 | 5 | B | 3 | 0 | 0 | (CL-C1-Ph—C3)5(B—C2)3-T8 |
| 13 | C1 | 6 | B | 2 | 0 | 0 | (CL-C1-Ph—C3)6(B—C2)2-T8 |
| 14 | C1 | 7 | B | 1 | 0 | 0 | (CL-C1-Ph—C3)7(B—C2)-T8 |
| 15 | O | 1 | B | 7 | 0 | 0 | (CL-C1-Ph—O—C2)(B—C2)7-T8 |
| 16 | O | 2 | B | 6 | 0 | 0 | (CL-C1-Ph—O—C2)2(B—C2)6-T8 |
| 17 | O | 3 | B | 5 | 0 | 0 | (CL-C1-Ph—O—C2)3(B—C2)5-T8 |
| 18 | O | 4 | B | 4 | 0 | 0 | (CL-C1-Ph—O—C2)4(B—C2)4-T8 |
| 19 | O | 5 | B | 3 | 0 | 0 | (CL-C1-Ph—O—C2)5(B—C2)3-T8 |
| 20 | O | 6 | B | 2 | 0 | 0 | (CL-C1-Ph—O—C2)6(B—C2)2-T8 |
| 21 | O | 7 | B | 1 | 0 | 0 | (CL-C1-Ph—O—C2)7(B—C2)-T8 |
| 22 | O—C1 | 1 | B | 7 | 0 | 0 | (CL-C1-Ph—O—C3)(B—C2)7-T8 |
| 23 | O—C1 | 2 | B | 6 | 0 | 0 | (CL-C1-Ph—O—C3)2(B—C2)6-T8 |
| 24 | O—C1 | 3 | B | 5 | 0 | 0 | (CL-C1-Ph—O—C3)3(B—C2)5-T8 |
| 25 | O—C1 | 4 | B | 4 | 0 | 0 | (CL-C1-Ph—O—C3)4(B—C2)4-T8 |
| 26 | O—C1 | 5 | B | 3 | 0 | 0 | (CL-C1-Ph—O—C3)5(B—C2)3-T8 |
| 27 | O—C1 | 6 | B | 2 | 0 | 0 | (CL-C1-Ph—O—C3)6(B—C2)2-T8 |
| 28 | O—C1 | 7 | B | 1 | 0 | 0 | (CL-C1-Ph—O—C3)7(B—C2)-T8 |

TABLE 5

| No. | Z³ | a | R⁷ | b | c | e | Formula(13) |
|---|---|---|---|---|---|---|---|
| 1 | C1-O | 1 | B | 7 | 0 | 0 | (CL-C1-Ph—C1-O—C2)(B—C2)7-T8 |
| 2 | C1-O | 2 | B | 6 | 0 | 0 | (CL-C1-Ph—C1-O—C2)2(B—C2)6-T8 |
| 3 | C1-O | 3 | B | 5 | 0 | 0 | (CL-C1-Ph—C1-O—C2)3(B—C2)5-T8 |
| 4 | C1-O | 4 | B | 4 | 0 | 0 | (CL-C1-Ph—C1-O—C2)4(B—C2)4-T8 |
| 5 | C1-O | 5 | B | 3 | 0 | 0 | (CL-C1-Ph—C1-O—C2)5(B—C2)3-T8 |
| 6 | C1-O | 6 | B | 2 | 0 | 0 | (CL-C1-Ph—C1-O—C2)6(B—C2)2-T8 |
| 7 | C1-O | 7 | B | 1 | 0 | 0 | (CL-C1-Ph—C1-O—C2)7(B—C2)-T8 |
| 8 | C1-O—C1 | 1 | B | 7 | 0 | 0 | (CL-C1-Ph—C1-O—C3)(B—C2)7-T8 |
| 9 | C1-O—C1 | 2 | B | 6 | 0 | 0 | (CL-C1-Ph—C1-O—C3)2(B—C2)6-T8 |
| 10 | C1-O—C1 | 3 | B | 5 | 0 | 0 | (CL-C1-Ph—C1-O—C3)3(B—C2)5-T8 |
| 11 | C1-O—C1 | 4 | B | 4 | 0 | 0 | (CL-C1-Ph—C1-O—C3)4(B—C2)4-T8 |
| 12 | C1-O—C1 | 5 | B | 3 | 0 | 0 | (CL-C1-Ph—C1-O—C3)5(B—C2)3-T8 |
| 13 | C1-O—C1 | 6 | B | 2 | 0 | 0 | (CL-C1-Ph—C1-O—C3)6(B—C2)2-T8 |
| 14 | C1-O—C1 | 7 | B | 1 | 0 | 0 | (CL-C1-Ph—C1-O—C3)7(B—C2)-T8 |
| 15 | C2-O | 1 | B | 7 | 0 | 0 | (CL-C1-Ph—C2-O—C2)(B—C2)7-T8 |
| 16 | C2-O | 2 | B | 6 | 0 | 0 | (CL-C1-Ph—C2-O—C2)2(B—C2)6-T8 |
| 17 | C2-O | 3 | B | 5 | 0 | 0 | (CL-C1-Ph—C2-O—C2)3(B—C2)5-T8 |
| 18 | C2-O | 4 | B | 4 | 0 | 0 | (CL-C1-Ph—C2-O—C2)4(B—C2)4-T8 |
| 19 | C2-O | 5 | B | 3 | 0 | 0 | (CL-C1-Ph—C2-O—C2)5(B—C2)3-T8 |
| 20 | C2-O | 6 | B | 2 | 0 | 0 | (CL-C1-Ph—C2-O—C2)6(B—C2)2-T8 |
| 21 | C2-O | 7 | B | 1 | 0 | 0 | (CL-C1-Ph—C2-O—C2)7(B—C2)-T8 |
| 22 | C2-O—C1 | 1 | B | 7 | 0 | 0 | (CL-C1-Ph—C2-O—C3)(B—C2)7-T8 |
| 23 | C2-O—C1 | 2 | B | 6 | 0 | 0 | (CL-C1-Ph—C2-O—C3)2(B—C2)6-T8 |
| 24 | C2-O—C1 | 3 | B | 5 | 0 | 0 | (CL-C1-Ph—C2-O—C3)3(B—C2)5-T8 |
| 25 | C2-O—C1 | 4 | B | 4 | 0 | 0 | (CL-C1-Ph—C2-O—C3)4(B—C2)4-T8 |
| 26 | C2-O—C1 | 5 | B | 3 | 0 | 0 | (CL-C1-Ph—C2-O—C3)5(B—C2)3-T8 |
| 27 | C2-O—C1 | 6 | B | 2 | 0 | 0 | (CL-C1-Ph—C2-O—C3)6(B—C2)2-T8 |
| 28 | C2-O—C1 | 7 | B | 1 | 0 | 0 | (CL-C1-Ph—C2-O—C3)7(B—C2)-T8 |

TABLE 6

| No. | Z³ | a | R⁷ | b | c | e | Formula(13) |
|---|---|---|---|---|---|---|---|
| 1 | — | 1 | B—O | 7 | 0 | 0 | (CL-C1-Ph—C2)(B—C2)7-T8 |
| 2 | — | 2 | B—O | 6 | 0 | 0 | (CL-C1-Ph—C2)2(B—C2)6-T8 |
| 3 | — | 3 | B—O | 5 | 0 | 0 | (CL-C1-Ph—C2)3(B—C2)5-T8 |
| 4 | — | 4 | B—O | 4 | 0 | 0 | (CL-C1-Ph—C2)4(B—C2)4-T8 |
| 5 | — | 5 | B—O | 3 | 0 | 0 | (CL-C1-Ph—C2)5(B—C2)3-T8 |
| 6 | — | 6 | B—O | 2 | 0 | 0 | (CL-C1-Ph—C2)6(B—C2)2-T8 |
| 7 | — | 7 | B—O | 1 | 0 | 0 | (CL-C1-Ph—C2)7(B—C2)-T8 |
| 8 | C1 | 1 | B—O | 7 | 0 | 0 | (CL-C1-Ph—C3)(B—C2)7-T8 |
| 9 | C1 | 2 | B—O | 6 | 0 | 0 | (CL-C1-Ph—C3)2(B—C2)6-T8 |
| 10 | C1 | 3 | B—O | 5 | 0 | 0 | (CL-C1-Ph—C3)3(B—C2)5-T8 |
| 11 | C1 | 4 | B—O | 4 | 0 | 0 | (CL-C1-Ph—C3)4(B—C2)4-T8 |
| 12 | C1 | 5 | B—O | 3 | 0 | 0 | (CL-C1-Ph—C3)5(B—C2)3-T8 |
| 13 | C1 | 6 | B—O | 2 | 0 | 0 | (CL-C1-Ph—C3)6(B—C2)2-T8 |
| 14 | C1 | 7 | B—O | 1 | 0 | 0 | (CL-C1-Ph—C3)7(B—C2)-T8 |
| 15 | O | 1 | B—O | 7 | 0 | 0 | (CL-C1-Ph—O—C2)(B—C2)7-T8 |
| 16 | O | 2 | B—O | 6 | 0 | 0 | (CL-C1-Ph—O—C2)2(B—C2)6-T8 |
| 17 | O | 3 | B—O | 5 | 0 | 0 | (CL-C1-Ph—O—C2)3(B—C2)5-T8 |
| 18 | O | 4 | B—O | 4 | 0 | 0 | (CL-C1-Ph—O—C2)4(B—C2)4-T8 |
| 19 | O | 5 | B—O | 3 | 0 | 0 | (CL-C1-Ph—O—C2)5(B—C2)3-T8 |
| 20 | O | 6 | B—O | 2 | 0 | 0 | (CL-C1-Ph—O—C2)6(B—C2)2-T8 |
| 21 | O | 7 | B—O | 1 | 0 | 0 | (CL-C1-Ph—O—C2)7(B—C2)-T8 |
| 22 | O—C1 | 1 | B—O | 7 | 0 | 0 | (CL-C1-Ph—O—C3)(B—C2)7-T8 |
| 23 | O—C1 | 2 | B—O | 6 | 0 | 0 | (CL-C1-Ph—O—C3)2(B—C2)6-T8 |
| 24 | O—C1 | 3 | B—O | 5 | 0 | 0 | (CL-C1-Ph—O—C3)3(B—C2)5-T8 |
| 25 | O—C1 | 4 | B—O | 4 | 0 | 0 | (CL-C1-Ph—O—C3)4(B—C2)4-T8 |
| 26 | O—C1 | 5 | B—O | 3 | 0 | 0 | (CL-C1-Ph—O—C3)5(B—C2)3-T8 |
| 27 | O—C1 | 6 | B—O | 2 | 0 | 0 | (CL-C1-Ph—O—C3)6(B—C2)2-T8 |
| 28 | O—C1 | 7 | B—O | 1 | 0 | 0 | (CL-C1-Ph—O—C3)7(B—C2)-T8 |

TABLE 7

| No. | Z³ | a | R⁷ | b | c | e | Formula(13) |
|---|---|---|---|---|---|---|---|
| 1 | C1-O | 1 | B—O | 7 | 0 | 0 | (CL-C1-Ph—C1-O—C2)(B—C2)7-T8 |
| 2 | C1-O | 2 | B—O | 6 | 0 | 0 | (CL-C1-Ph—C1-O—C2)2(B—C2)6-T8 |
| 3 | C1-O | 3 | B—O | 5 | 0 | 0 | (CL-C1-Ph—C1-O—C2)3(B—C2)5-T8 |
| 4 | C1-O | 4 | B—O | 4 | 0 | 0 | (CL-C1-Ph—C1-O—C2)4(B—C2)4-T8 |
| 5 | C1-O | 5 | B—O | 3 | 0 | 0 | (CL-C1-Ph—C1-O—C2)5(B—C2)3-T8 |
| 6 | C1-O | 6 | B—O | 2 | 0 | 0 | (CL-C1-Ph—C1-O—C2)6(B—C2)2-T8 |
| 7 | C1-O | 7 | B—O | 1 | 0 | 0 | (CL-C1-Ph—C1-O—C2)7(B—C2)-T8 |
| 8 | C1-O—C1 | 1 | B—O | 7 | 0 | 0 | (CL-C1-Ph—C1-O—C3)(B—C2)7-T8 |
| 9 | C1-O—C1 | 2 | B—O | 6 | 0 | 0 | (CL-C1-Ph—C1-O—C3)2(B—C2)6-T8 |
| 10 | C1-O—C1 | 3 | B—O | 5 | 0 | 0 | (CL-C1-Ph—C1-O—C3)3(B—C2)5-T8 |
| 11 | C1-O—C1 | 4 | B—O | 4 | 0 | 0 | (CL-C1-Ph—C1-O—C3)4(B—C2)4-T8 |
| 12 | C1-O—C1 | 5 | B—O | 3 | 0 | 0 | (CL-C1-Ph—C1-O—C3)5(B—C2)3-T8 |
| 13 | C1-O—C1 | 6 | B—O | 2 | 0 | 0 | (CL-C1-Ph—C1-O—C3)6(B—C2)2-T8 |
| 14 | C1-O—C1 | 7 | B—O | 1 | 0 | 0 | (CL-C1-Ph—C1-O—C3)7(B—C2)-T8 |
| 15 | C2-O | 1 | B—O | 7 | 0 | 0 | (CL-C1-Ph—C2-O—C2)(B—C2)7-T8 |
| 16 | C2-O | 2 | B—O | 6 | 0 | 0 | (CL-C1-Ph—C2-O—C2)2(B—C2)6-T8 |
| 17 | C2-O | 3 | B—O | 5 | 0 | 0 | (CL-C1-Ph—C2-O—C2)3(B—C2)5-T8 |
| 18 | C2-O | 4 | B—O | 4 | 0 | 0 | (CL-C1-Ph—C2-O—C2)4(B—C2)4-T8 |
| 19 | C2-O | 5 | B—O | 3 | 0 | 0 | (CL-C1-Ph—C2-O—C2)5(B—C2)3-T8 |
| 20 | C2-O | 6 | B—O | 2 | 0 | 0 | (CL-C1-Ph—C2-O—C2)6(B—C2)2-T8 |
| 21 | C2-O | 7 | B—O | 1 | 0 | 0 | (CL-C1-Ph—C2-O—C2)7(B—C2)-T8 |
| 22 | C2-O—C1 | 1 | B—O | 7 | 0 | 0 | (CL-C1-Ph—C2-O—C3)(B—C2)7-T8 |
| 23 | C2-O—C1 | 2 | B—O | 6 | 0 | 0 | (CL-C1-Ph—C2-O—C3)2(B—C2)6-T8 |
| 24 | C2-O—C1 | 3 | B—O | 5 | 0 | 0 | (CL-C1-Ph—C2-O—C3)3(B—C2)5-T8 |
| 25 | C2-O—C1 | 4 | B—O | 4 | 0 | 0 | (CL-C1-Ph—C2-O—C3)4(B—C2)4-T8 |
| 26 | C2-O—C1 | 5 | B—O | 3 | 0 | 0 | (CL-C1-Ph—C2-O—C3)5(B—C2)3-T8 |
| 27 | C2-O—C1 | 6 | B—O | 2 | 0 | 0 | (CL-C1-Ph—C2-O—C3)6(B—C2)2-T8 |
| 28 | C2-O—C1 | 7 | B—O | 1 | 0 | 0 | (CL-C1-Ph—C2-O—C3)7(B—C2)-T8 |

TABLE 8

| No. | Z³ | a | R⁷ | b | c | e | Formula(13) |
|---|---|---|---|---|---|---|---|
| 1 | — | 1 | | 0 | 7 | 1 | (CL-C1-Ph—C2)(H)7-(DT)8 |
| 2 | — | 2 | | 0 | 6 | 1 | (CL-C1-Ph—C2)2(H)6-(DT)8 |
| 3 | — | 3 | | 0 | 5 | 1 | (CL-C1-Ph—C2)3(H)5-(DT)8 |
| 4 | — | 4 | | 0 | 4 | 1 | (CL-C1-Ph—C2)4(H)4-(DT)8 |
| 5 | — | 5 | | 0 | 3 | 1 | (CL-C1-Ph—C2)5(H)3-(DT)8 |
| 6 | — | 6 | | 0 | 2 | 1 | (CL-C1-Ph—C2)6(H)2-(DT)8 |
| 7 | — | 7 | | 0 | 1 | 1 | (CL-C1-Ph—C2)7(H)-(DT)8 |
| 8 | — | 8 | | 0 | 0 | 1 | (CL-C1-Ph—C2)8-(DT)8 |
| 9 | C1 | 1 | | 0 | 7 | 1 | (CL-C1-Ph—C3)(H)7-(DT)8 |
| 10 | C1 | 2 | | 0 | 6 | 1 | (CL-C1-Ph—C3)2(H)6-(DT)8 |
| 11 | C1 | 3 | | 0 | 5 | 1 | (CL-C1-Ph—C3)3(H)5-(DT)8 |
| 12 | C1 | 4 | | 0 | 4 | 1 | (CL-C1-Ph—C3)4(H)4-(DT)8 |
| 13 | C1 | 5 | | 0 | 3 | 1 | (CL-C1-Ph—C3)5(H)3-(DT)8 |
| 14 | C1 | 6 | | 0 | 2 | 1 | (CL-C1-Ph—C3)6(H)2-(DT)8 |
| 15 | C1 | 7 | | 0 | 1 | 1 | (CL-C1-Ph—C3)7(H)-(DT)8 |
| 16 | C1 | 8 | | 0 | 0 | 1 | (CL-C1-Ph—C3)8-(DT)8 |
| 17 | O | 1 | | 0 | 7 | 1 | (CL-C1-Ph—O—C2)(H)7-(DT)8 |
| 18 | O | 2 | | 0 | 6 | 1 | (CL-C1-Ph—O—C2)2(H)6-(DT)8 |
| 19 | O | 3 | | 0 | 5 | 1 | (CL-C1-Ph—O—C2)3(H)5-(DT)8 |
| 20 | O | 4 | | 0 | 4 | 1 | (CL-C1-Ph—O—C2)4(H)4-(DT)8 |
| 21 | O | 5 | | 0 | 3 | 1 | (CL-C1-Ph—O—C2)5(H)3-(DT)8 |
| 22 | O | 6 | | 0 | 2 | 1 | (CL-C1-Ph—O—C2)6(H)2-(DT)8 |
| 23 | O | 7 | | 0 | 1 | 1 | (CL-C1-Ph—O—C2)7(H)-(DT)8 |
| 24 | O | 8 | | 0 | 0 | 1 | (CL-C1-Ph—O—C2)8-(DT)8 |
| 25 | O—C1 | 1 | | 0 | 7 | 1 | (CL-C1-Ph—O—C3)(H)7-(DT)8 |
| 26 | O—C1 | 2 | | 0 | 6 | 1 | (CL-C1-Ph—O—C3)2(H)6-(DT)8 |
| 27 | O—C1 | 3 | | 0 | 5 | 1 | (CL-C1-Ph—O—C3)3(H)5-(DT)8 |
| 28 | O—C1 | 4 | | 0 | 4 | 1 | (CL-C1-Ph—O—C3)4(H)4-(DT)8 |
| 29 | O—C1 | 5 | | 0 | 3 | 1 | (CL-C1-Ph—O—C3)5(H)3-(DT)8 |
| 30 | O—C1 | 6 | | 0 | 2 | 1 | (CL-C1-Ph—O—C3)6(H)2-(DT)8 |
| 31 | O—C1 | 7 | | 0 | 1 | 1 | (CL-C1-Ph—O—C3)7(H)-(DT)8 |
| 32 | O—C1 | 8 | | 0 | 0 | 1 | (CL-C1-Ph—O—C3)8-(DT)8 |

TABLE 9

| No. | Z³ | a | R⁷ | b | c | e | Formula(13) |
|---|---|---|---|---|---|---|---|
| 1 | C1-O | 1 | | 0 | 7 | 1 | (CL-C1-Ph—C1-O—C2)(H)7-(DT)8 |
| 2 | C1-O | 2 | | 0 | 6 | 1 | (CL-C1-Ph—C1-O—C2)2(H)6-(DT)8 |
| 3 | C1-O | 3 | | 0 | 5 | 1 | (CL-C1-Ph—C1-O—C2)3(H)5-(DT)8 |
| 4 | C1-O | 4 | | 0 | 4 | 1 | (CL-C1-Ph—C1-O—C2)4(H)4-(DT)8 |
| 5 | C1-O | 5 | | 0 | 3 | 1 | (CL-C1-Ph—C1-O—C2)5(H)3-(DT)8 |
| 6 | C1-O | 6 | | 0 | 2 | 1 | (CL-C1-Ph—C1-O—C2)6(H)2-(DT)8 |
| 7 | C1-O | 7 | | 0 | 1 | 1 | (CL-C1-Ph—C1-O—C2)7(H)-(DT)8 |
| 8 | C1-O | 8 | | 0 | 0 | 1 | (CL-C1-Ph—C1-O—C2)8-(DT)8 |
| 9 | C1-O—C1 | 1 | | 0 | 7 | 1 | (CL-C1-Ph—C1-O—C3)(H)7-(DT)8 |
| 10 | C1-O—C1 | 2 | | 0 | 6 | 1 | (CL-C1-Ph—C1-O—C3)2(H)6-(DT)8 |
| 11 | C1-O—C1 | 3 | | 0 | 5 | 1 | (CL-C1-Ph—C1-O—C3)3(H)5-(DT)8 |
| 12 | C1-O—C1 | 4 | | 0 | 4 | 1 | (CL-C1-Ph—C1-O—C3)4(H)4-(DT)8 |
| 13 | C1-O—C1 | 5 | | 0 | 3 | 1 | (CL-C1-Ph—C1-O—C3)5(H)3-(DT)8 |
| 14 | C1-O—C1 | 6 | | 0 | 2 | 1 | (CL-C1-Ph—C1-O—C3)6(H)2-(DT)8 |
| 15 | C1-O—C1 | 7 | | 0 | 1 | 1 | (CL-C1-Ph—C1-O—C3)7(H)-(DT)8 |
| 16 | C1-O—C1 | 8 | | 0 | 0 | 1 | (CL-C1-Ph—C1-O—C3)8-(DT)8 |
| 17 | C2-O | 1 | | 0 | 7 | 1 | (CL-C1-Ph—C2-O—C2)(H)7-(DT)8 |
| 18 | C2-O | 2 | | 0 | 6 | 1 | (CL-C1-Ph—C2-O—C2)2(H)6-(DT)8 |
| 19 | C2-O | 3 | | 0 | 5 | 1 | (CL-C1-Ph—C2-O—C2)3(H)5-(DT)8 |
| 20 | C2-O | 4 | | 0 | 4 | 1 | (CL-C1-Ph—C2-O—C2)4(H)4-(DT)8 |
| 21 | C2-O | 5 | | 0 | 3 | 1 | (CL-C1-Ph—C2-O—C2)5(H)3-(DT)8 |
| 22 | C2-O | 6 | | 0 | 2 | 1 | (CL-C1-Ph—C2-O—C2)6(H)2-(DT)8 |
| 23 | C2-O | 7 | | 0 | 1 | 1 | (CL-C1-Ph—C2-O—C2)7(H)-(DT)8 |
| 24 | C2-O | 8 | | 0 | 0 | 1 | (CL-C1-Ph—C2-O—C2)8-(DT)8 |
| 25 | C2-O—C1 | 1 | | 0 | 7 | 1 | (CL-C1-Ph—C2-O—C3)(H)7-(DT)8 |
| 26 | C2-O—C1 | 2 | | 0 | 6 | 1 | (CL-C1-Ph—C2-O—C3)2(H)6-(DT)8 |
| 27 | C2-O—C1 | 3 | | 0 | 5 | 1 | (CL-C1-Ph—C2-O—C3)3(H)5-(DT)8 |
| 28 | C2-O—C1 | 4 | | 0 | 4 | 1 | (CL-C1-Ph—C2-O—C3)4(H)4-(DT)8 |
| 29 | C2-O—C1 | 5 | | 0 | 3 | 1 | (CL-C1-Ph—C2-O—C3)5(H)3-(DT)8 |
| 30 | C2-O—C1 | 6 | | 0 | 2 | 1 | (CL-C1-Ph—C2-O—C3)6(H)2-(DT)8 |
| 31 | C2-O—C1 | 7 | | 0 | 1 | 1 | (CL-C1-Ph—C2-O—C3)7(H)-(DT)8 |
| 32 | C2-O—C1 | 8 | | 0 | 0 | 1 | (CL-C1-Ph—C2-O—C3)8-(DT)8 |

TABLE 10

| No. | Z³ | a | R⁷ | b | c | e | Formula(13) |
|---|---|---|---|---|---|---|---|
| 1 | — | 1 | B | 7 | 0 | 1 | (CL-C1-Ph—C2)(B—C2)7-(DT)8 |
| 2 | — | 2 | B | 6 | 0 | 1 | (CL-C1-Ph—C2)2(B—C2)6-(DT)8 |
| 3 | — | 3 | B | 5 | 0 | 1 | (CL-C1-Ph—C2)3(B—C2)5-(DT)8 |
| 4 | — | 4 | B | 4 | 0 | 1 | (CL-C1-Ph—C2)4(B—C2)4-(DT)8 |
| 5 | — | 5 | B | 3 | 0 | 1 | (CL-C1-Ph—C2)5(B—C2)3-(DT)8 |
| 6 | — | 6 | B | 2 | 0 | 1 | (CL-C1-Ph—C2)6(B—C2)2-(DT)8 |
| 7 | — | 7 | B | 1 | 0 | 1 | (CL-C1-Ph—C2)7(B—C2)-(DT)8 |
| 8 | C1 | 1 | B | 7 | 0 | 1 | (CL-C1-Ph—C3)(B—C2)7-(DT)8 |
| 9 | C1 | 2 | B | 6 | 0 | 1 | (CL-C1-Ph—C3)2(B—C2)6-(DT)8 |
| 10 | C1 | 3 | B | 5 | 0 | 1 | (CL-C1-Ph—C3)3(B—C2)5-(DT)8 |
| 11 | C1 | 4 | B | 4 | 0 | 1 | (CL-C1-Ph—C3)4(B—C2)4-(DT)8 |
| 12 | C1 | 5 | B | 3 | 0 | 1 | (CL-C1-Ph—C3)5(B—C2)3-(DT)8 |
| 13 | C1 | 6 | B | 2 | 0 | 1 | (CL-C1-Ph—C3)6(B—C2)2-(DT)8 |
| 14 | C1 | 7 | B | 1 | 0 | 1 | (CL-C1-Ph—C3)7(B—C2)-(DT)8 |
| 15 | O | 1 | B | 7 | 0 | 1 | (CL-C1-Ph—O—C2)(B—C2)7-(DT)8 |
| 16 | O | 2 | B | 6 | 0 | 1 | (CL-C1-Ph—O—C2)2(B—C2)6-(DT)8 |
| 17 | O | 3 | B | 5 | 0 | 1 | (CL-C1-Ph—O—C2)3(B—C2)5-(DT)8 |
| 18 | O | 4 | B | 4 | 0 | 1 | (CL-C1-Ph—O—C2)4(B—C2)4-(DT)8 |
| 19 | O | 5 | B | 3 | 0 | 1 | (CL-C1-Ph—O—C2)5(B—C2)3-(DT)8 |
| 20 | O | 6 | B | 2 | 0 | 1 | (CL-C1-Ph—O—C2)6(B—C2)2-(DT)8 |
| 21 | O | 7 | B | 1 | 0 | 1 | (CL-C1-Ph—O—C2)7(B—C2)-(DT)8 |
| 22 | O—C1 | 1 | B | 7 | 0 | 1 | (CL-C1-Ph—O—C3)(B—C2)7-(DT)8 |
| 23 | O—C1 | 2 | B | 6 | 0 | 1 | (CL-C1-Ph—O—C3)2(B—C2)6-(DT)8 |
| 24 | O—C1 | 3 | B | 5 | 0 | 1 | (CL-C1-Ph—O—C3)3(B—C2)5-(DT)8 |
| 25 | O—C1 | 4 | B | 4 | 0 | 1 | (CL-C1-Ph—O—C3)4(B—C2)4-(DT)8 |
| 26 | O—C1 | 5 | B | 3 | 0 | 1 | (CL-C1-Ph—O—C3)5(B—C2)3-(DT)8 |
| 27 | O—C1 | 6 | B | 2 | 0 | 1 | (CL-C1-Ph—O—C3)6(B—C2)2-(DT)8 |
| 28 | O—C1 | 7 | B | 1 | 0 | 1 | (CL-C1-Ph—O—C3)7(B—C2)-(DT)8 |

TABLE 11

| No. | Z³ | a | R⁷ | b | c | e | Formula(13) |
|---|---|---|---|---|---|---|---|
| 1 | C1-O | 1 | B | 7 | 0 | 1 | (CL-C1-Ph—C1-O—C2)(B—C2)7-(DT)8 |
| 2 | C1-O | 2 | B | 6 | 0 | 1 | (CL-C1-Ph—C1-O—C2)2(B—C2)6-(DT)8 |
| 3 | C1-O | 3 | B | 5 | 0 | 1 | (CL-C1-Ph—C1-O—C2)3(B—C2)5-(DT)8 |
| 4 | C1-O | 4 | B | 4 | 0 | 1 | (CL-C1-Ph—C1-O—C2)4(B—C2)4-(DT)8 |
| 5 | C1-O | 5 | B | 3 | 0 | 1 | (CL-C1-Ph—C1-O—C2)5(B—C2)3-(DT)8 |
| 6 | C1-O | 6 | B | 2 | 0 | 1 | (CL-C1-Ph—C1-O—C2)6(B—C2)2-(DT)8 |
| 7 | C1-O | 7 | B | 1 | 0 | 1 | (CL-C1-Ph—C1-O—C2)7(B—C2)-(DT)8 |
| 8 | C1-O—C1 | 1 | B | 7 | 0 | 1 | (CL-C1-Ph—C1-O—C3)(B—C2)7-(DT)8 |
| 9 | C1-O—C1 | 2 | B | 6 | 0 | 1 | (CL-C1-Ph—C1-O—C3)2(B—C2)6-(DT)8 |
| 10 | C1-O—C1 | 3 | B | 5 | 0 | 1 | (CL-C1-Ph—C1-O—C3)3(B—C2)5-(DT)8 |
| 11 | C1-O—C1 | 4 | B | 4 | 0 | 1 | (CL-C1-Ph—C1-O—C3)4(B—C2)4-(DT)8 |
| 12 | C1-O—C1 | 5 | B | 3 | 0 | 1 | (CL-C1-Ph—C1-O—C3)5(B—C2)3-(DT)8 |
| 13 | C1-O—C1 | 6 | B | 2 | 0 | 1 | (CL-C1-Ph—C1-O—C3)6(B—C2)2-(DT)8 |
| 14 | C1-O—C1 | 7 | B | 1 | 0 | 1 | (CL-C1-Ph—C1-O—C3)7(B—C2)-(DT)8 |
| 15 | C2-O | 1 | B | 7 | 0 | 1 | (CL-C1-Ph—C2-O—C2)(B—C2)7-(DT)8 |
| 16 | C2-O | 2 | B | 6 | 0 | 1 | (CL-C1-Ph—C2-O—C2)2(B—C2)6-(DT)8 |
| 17 | C2-O | 3 | B | 5 | 0 | 1 | (CL-C1-Ph—C2-O—C2)3(B—C2)5-(DT)8 |
| 18 | C2-O | 4 | B | 4 | 0 | 1 | (CL-C1-Ph—C2-O—C2)4(B—C2)4-(DT)8 |
| 19 | C2-O | 5 | B | 3 | 0 | 1 | (CL-C1-Ph—C2-O—C2)5(B—C2)3-(DT)8 |
| 20 | C2-O | 6 | B | 2 | 0 | 1 | (CL-C1-Ph—C2-O—C2)6(B—C2)2-(DT)8 |
| 21 | C2-O | 7 | B | 1 | 0 | 1 | (CL-C1-Ph—C2-O—C2)7(B—C2)-(DT)8 |
| 22 | C2-O—C1 | 1 | B | 7 | 0 | 1 | (CL-C1-Ph—C2-O—C3)(B—C2)7-(DT)8 |
| 23 | C2-O—C1 | 2 | B | 6 | 0 | 1 | (CL-C1-Ph—C2-O—C3)2(B—C2)6-(DT)8 |
| 24 | C2-O—C1 | 3 | B | 5 | 0 | 1 | (CL-C1-Ph—C2-O—C3)3(B—C2)5-(DT)8 |
| 25 | C2-O—C1 | 4 | B | 4 | 0 | 1 | (CL-C1-Ph—C2-O—C3)4(B—C2)4-(DT)8 |
| 26 | C2-O—C1 | 5 | B | 3 | 0 | 1 | (CL-C1-Ph—C2-O—C3)5(B—C2)3-(DT)8 |
| 27 | C2-O—C1 | 6 | B | 2 | 0 | 1 | (CL-C1-Ph—C2-O—C3)6(B—C2)2-(DT)8 |
| 28 | C2-O—C1 | 7 | B | 1 | 0 | 1 | (CL-C1-Ph—C2-O—C3)7(B—C2)-(DT)8 |

TABLE 12

| No. | Z³ | a | R⁷ | b | c | e | Formula(13) |
|---|---|---|---|---|---|---|---|
| 1 | — | 1 | B—O | 7 | 0 | 1 | (CL-C1-Ph—C2)(B—C2)7-(DT)8 |
| 2 | — | 2 | B—O | 6 | 0 | 1 | (CL-C1-Ph—C2)2(B—C2)6-(DT)8 |
| 3 | — | 3 | B—O | 5 | 0 | 1 | (CL-C1-Ph—C2)3(B—C2)5-(DT)8 |
| 4 | — | 4 | B—O | 4 | 0 | 1 | (CL-C1-Ph—C2)4(B—C2)4-(DT)8 |
| 5 | — | 5 | B—O | 3 | 0 | 1 | (CL-C1-Ph—C2)5(B—C2)3-(DT)8 |
| 6 | — | 6 | B—O | 2 | 0 | 1 | (CL-C1-Ph—C2)6(B—C2)2-(DT)8 |
| 7 | — | 7 | B—O | 1 | 0 | 1 | (CL-C1-Ph—C2)7(B—C2)-(DT)8 |
| 8 | C1 | 1 | B—O | 7 | 0 | 1 | (CL-C1-Ph—C3)(B—C2)7-(DT)8 |
| 9 | C1 | 2 | B—O | 6 | 0 | 1 | (CL-C1-Ph—C3)2(B—C2)6-(DT)8 |
| 10 | C1 | 3 | B—O | 5 | 0 | 1 | (CL-C1-Ph—C3)3(B—C2)5-(DT)8 |
| 11 | C1 | 4 | B—O | 4 | 0 | 1 | (CL-C1-Ph—C3)4(B—C2)4-(DT)8 |
| 12 | C1 | 5 | B—O | 3 | 0 | 1 | (CL-C1-Ph—C3)5(B—C2)3-(DT)8 |
| 13 | C1 | 6 | B—O | 2 | 0 | 1 | (CL-C1-Ph—C3)6(B—C2)2-(DT)8 |
| 14 | C1 | 7 | B—O | 1 | 0 | 1 | (CL-C1-Ph—C3)7(B—C2)-(DT)8 |
| 15 | O | 1 | B—O | 7 | 0 | 1 | (CL-C1-Ph—O—C2)(B—C2)7-(DT)8 |
| 16 | O | 2 | B—O | 6 | 0 | 1 | (CL-C1-Ph—O—C2)2(B—C2)6-(DT)8 |
| 17 | O | 3 | B—O | 5 | 0 | 1 | (CL-C1-Ph—O—C2)3(B—C2)5-(DT)8 |
| 18 | O | 4 | B—O | 4 | 0 | 1 | (CL-C1-Ph—O—C2)4(B—C2)4-(DT)8 |
| 19 | O | 5 | B—O | 3 | 0 | 1 | (CL-C1-Ph—O—C2)5(B—C2)3-(DT)8 |
| 20 | O | 6 | B—O | 2 | 0 | 1 | (CL-C1-Ph—O—C2)6(B—C2)2-(DT)8 |
| 21 | O | 7 | B—O | 1 | 0 | 1 | (CL-C1-Ph—O—C2)7(B—C2)-(DT)8 |
| 22 | O—C1 | 1 | B—O | 7 | 0 | 1 | (CL-C1-Ph—O—C3)(B—C2)7-(DT)8 |
| 23 | O—C1 | 2 | B—O | 6 | 0 | 1 | (CL-C1-Ph—O—C3)2(B—C2)6-(DT)8 |
| 24 | O—C1 | 3 | B—O | 5 | 0 | 1 | (CL-C1-Ph—O—C3)3(B—C2)5-(DT)8 |
| 25 | O—C1 | 4 | B—O | 4 | 0 | 1 | (CL-C1-Ph—O—C3)4(B—C2)4-(DT)8 |
| 26 | O—C1 | 5 | B—O | 3 | 0 | 1 | (CL-C1-Ph—O—C3)5(B—C2)3-(DT)8 |
| 27 | O—C1 | 6 | B—O | 2 | 0 | 1 | (CL-C1-Ph—O—C3)6(B—C2)2-(DT)8 |
| 28 | O—C1 | 7 | B—O | 1 | 0 | 1 | (CL-C1-Ph—O—C3)7(B—C2)-(DT)8 |

TABLE 13

| No. | Z³ | a | R⁷ | b | c | e | Formula(13) |
|---|---|---|---|---|---|---|---|
| 1 | C1-O | 1 | B—O | 7 | 0 | 1 | (CL-C1-Ph—C1-O—C2)(B—C2)7-(DT)8 |
| 2 | C1-O | 2 | B—O | 6 | 0 | 1 | (CL-C1-Ph—C1-O—C2)2(B—C2)6-(DT)8 |
| 3 | C1-O | 3 | B—O | 5 | 0 | 1 | (CL-C1-Ph—C1-O—C2)3(B—C2)5-(DT)8 |
| 4 | C1-O | 4 | B—O | 4 | 0 | 1 | (CL-C1-Ph—C1-O—C2)4(B—C2)4-(DT)8 |
| 5 | C1-O | 5 | B—O | 3 | 0 | 1 | (CL-C1-Ph—C1-O—C2)5(B—C2)3-(DT)8 |
| 6 | C1-O | 6 | B—O | 2 | 0 | 1 | (CL-C1-Ph—C1-O—C2)6(B—C2)2-(DT)8 |
| 7 | C1-O | 7 | B—O | 1 | 0 | 1 | (CL-C1-Ph—C1-O—C2)7(B—C2)-(DT)8 |
| 8 | C1-O—C1 | 1 | B—O | 7 | 0 | 1 | (CL-C1-Ph—C1-O—C3)(B—C2)7-(DT)8 |
| 9 | C1-O—C1 | 2 | B—O | 6 | 0 | 1 | (CL-C1-Ph—C1-O—C3)2(B—C2)6-(DT)8 |
| 10 | C1-O—C1 | 3 | B—O | 5 | 0 | 1 | (CL-C1-Ph—C1-O—C3)3(B—C2)5-(DT)8 |
| 11 | C1-O—C1 | 4 | B—O | 4 | 0 | 1 | (CL-C1-Ph—C1-O—C3)4(B—C2)4-(DT)8 |
| 12 | C1-O—C1 | 5 | B—O | 3 | 0 | 1 | (CL-C1-Ph—C1-O—C3)5(B—C2)3-(DT)8 |
| 13 | C1-O—C1 | 6 | B—O | 2 | 0 | 1 | (CL-C1-Ph—C1-O—C3)6(B—C2)2-(DT)8 |
| 14 | C1-O—C1 | 7 | B—O | 1 | 0 | 1 | (CL-C1-Ph—C1-O—C3)7(B—C2)-(DT)8 |
| 15 | C2-O | 1 | B—O | 7 | 0 | 1 | (CL-C1-Ph—C2-O—C2)(B—C2)7-(DT)8 |
| 16 | C2-O | 2 | B—O | 6 | 0 | 1 | (CL-C1-Ph—C2-O—C2)2(B—C2)6-(DT)8 |
| 17 | C2-O | 3 | B—O | 5 | 0 | 1 | (CL-C1-Ph—C2-O—C2)3(B—C2)5-(DT)8 |
| 18 | C2-O | 4 | B—O | 4 | 0 | 1 | (CL-C1-Ph—C2-O—C2)4(B—C2)4-(DT)8 |
| 19 | C2-O | 5 | B—O | 3 | 0 | 1 | (CL-C1-Ph—C2-O—C2)5(B—C2)3-(DT)8 |
| 20 | C2-O | 6 | B—O | 2 | 0 | 1 | (CL-C1-Ph—C2-O—C2)6(B—C2)2-(DT)8 |
| 21 | C2-O | 7 | B—O | 1 | 0 | 1 | (CL-C1-Ph—C2-O—C2)7(B—C2)-(DT)8 |
| 22 | C2-O—C1 | 1 | B—O | 7 | 0 | 1 | (CL-C1-Ph—C2-O—C3)(B—C2)7-(DT)8 |
| 23 | C2-O—C1 | 2 | B—O | 6 | 0 | 1 | (CL-C1-Ph—C2-O—C3)2(B—C2)6-(DT)8 |
| 24 | C2-O—C1 | 3 | B—O | 5 | 0 | 1 | (CL-C1-Ph—C2-O—C3)3(B—C2)5-(DT)8 |
| 25 | C2-O—C1 | 4 | B—O | 4 | 0 | 1 | (CL-C1-Ph—C2-O—C3)4(B—C2)4-(DT)8 |
| 26 | C2-O—C1 | 5 | B—O | 3 | 0 | 1 | (CL-C1-Ph—C2-O—C3)5(B—C2)3-(DT)8 |
| 27 | C2-O—C1 | 6 | B—O | 2 | 0 | 1 | (CL-C1-Ph—C2-O—C3)6(B—C2)2-(DT)8 |
| 28 | C2-O—C1 | 7 | B—O | 1 | 0 | 1 | (CL-C1-Ph—C2-O—C3)7(B—C2)-(DT)8 |

TABLE 14

| No. | Z³ | a | R⁷ | b | c | e | Formula(14) |
|---|---|---|---|---|---|---|---|
| 1 | — | 1 | | 0 | 7 | 0 | (Q-C1-Ph—C2)(H)7-T8 |
| 2 | — | 2 | | 0 | 6 | 0 | (Q-C1-Ph—C2)2(H)6-T8 |
| 3 | — | 3 | | 0 | 5 | 0 | (Q-C1-Ph—C2)3(H)5-T8 |
| 4 | — | 4 | | 0 | 4 | 0 | (Q-C1-Ph—C2)4(H)4-T8 |
| 5 | — | 5 | | 0 | 3 | 0 | (Q-C1-Ph—C2)5(H)3-T8 |
| 6 | — | 6 | | 0 | 2 | 0 | (Q-C1-Ph—C2)6(H)2-T8 |
| 7 | — | 7 | | 0 | 1 | 0 | (Q-C1-Ph—C2)7(H)-T8 |
| 8 | — | 8 | | 0 | 0 | 0 | (Q-C1-Ph—C2)8-T8 |
| 9 | C1 | 1 | | 0 | 7 | 0 | (Q-C1-Ph—C3)(H)7-T8 |
| 10 | C1 | 2 | | 0 | 6 | 0 | (Q-C1-Ph—C3)2(H)6-T8 |
| 11 | C1 | 3 | | 0 | 5 | 0 | (Q-C1-Ph—C3)3(H)5-T8 |
| 12 | C1 | 4 | | 0 | 4 | 0 | (Q-C1-Ph—C3)4(H)4-T8 |
| 13 | C1 | 5 | | 0 | 3 | 0 | (Q-C1-Ph—C3)5(H)3-T8 |
| 14 | C1 | 6 | | 0 | 2 | 0 | (Q-C1-Ph—C3)6(H)2-T8 |
| 15 | C1 | 7 | | 0 | 1 | 0 | (Q-C1-Ph—C3)7(H)-T8 |
| 16 | C1 | 8 | | 0 | 0 | 0 | (Q-C1-Ph—C3)8-T8 |
| 17 | O | 1 | | 0 | 7 | 0 | (Q-C1-Ph—O—C2)(H)7-T8 |
| 18 | O | 2 | | 0 | 6 | 0 | (Q-C1-Ph—O—C2)2(H)6-T8 |
| 19 | O | 3 | | 0 | 5 | 0 | (Q-C1-Ph—O—C2)3(H)5-T8 |
| 20 | O | 4 | | 0 | 4 | 0 | (Q-C1-Ph—O—C2)4(H)4-T8 |
| 21 | O | 5 | | 0 | 3 | 0 | (Q-C1-Ph—O—C2)5(H)3-T8 |
| 22 | O | 6 | | 0 | 2 | 0 | (Q-C1-Ph—O—C2)6(H)2-T8 |
| 23 | O | 7 | | 0 | 1 | 0 | (Q-C1-Ph—O—C2)7(H)-T8 |
| 24 | O | 8 | | 0 | 0 | 0 | (Q-C1-Ph—O—C2)8-T8 |
| 25 | O—C1 | 1 | | 0 | 7 | 0 | (Q-C1-Ph—O—C3)(H)7-T8 |
| 26 | O—C1 | 2 | | 0 | 6 | 0 | (Q-C1-Ph—O—C3)2(H)6-T8 |
| 27 | O—C1 | 3 | | 0 | 5 | 0 | (Q-C1-Ph—O—C3)3(H)5-T8 |
| 28 | O—C1 | 4 | | 0 | 4 | 0 | (Q-C1-Ph—O—C3)4(H)4-T8 |
| 29 | O—C1 | 5 | | 0 | 3 | 0 | (Q-C1-Ph—O—C3)5(H)3-T8 |
| 30 | O—C1 | 6 | | 0 | 2 | 0 | (Q-C1-Ph—O—C3)6(H)2-T8 |
| 31 | O—C1 | 7 | | 0 | 1 | 0 | (Q-C1-Ph—O—C3)7(H)-T8 |
| 32 | O—C1 | 8 | | 0 | 0 | 0 | (Q-C1-Ph—O—C3)8-T8 |

TABLE 15

| No. | Z³ | a | R⁷ | b | c | e | Formula(14) |
|---|---|---|---|---|---|---|---|
| 1 | C1-O | 1 | | 0 | 7 | 0 | (Q-C1-Ph—C1-O—C2)(H)7-T8 |
| 2 | C1-O | 2 | | 0 | 6 | 0 | (Q-C1-Ph—C1-O—C2)2(H)6-T8 |
| 3 | C1-O | 3 | | 0 | 5 | 0 | (Q-C1-Ph—C1-O—C2)3(H)5-T8 |
| 4 | C1-O | 4 | | 0 | 4 | 0 | (Q-C1-Ph—C1-O—C2)4(H)4-T8 |
| 5 | C1-O | 5 | | 0 | 3 | 0 | (Q-C1-Ph—C1-O—C2)5(H)3-T8 |
| 6 | C1-O | 6 | | 0 | 2 | 0 | (Q-C1-Ph—C1-O—C2)6(H)2-T8 |
| 7 | C1-O | 7 | | 0 | 1 | 0 | (Q-C1-Ph—C1-O—C2)7(H)-T8 |
| 8 | C1-O | 8 | | 0 | 0 | 0 | (Q-C1-Ph—C1-O—C2)8-T8 |
| 9 | C1-O—C1 | 1 | | 0 | 7 | 0 | (Q-C1-Ph—C1-O—C3)(H)7-T8 |
| 10 | C1-O—C1 | 2 | | 0 | 6 | 0 | (Q-C1-Ph—C1-O—C3)2(H)6-T8 |
| 11 | C1-O—C1 | 3 | | 0 | 5 | 0 | (Q-C1-Ph—C1-O—C3)3(H)5-T8 |
| 12 | C1-O—C1 | 4 | | 0 | 4 | 0 | (Q-C1-Ph—C1-O—C3)4(H)4-T8 |
| 13 | C1-O—C1 | 5 | | 0 | 3 | 0 | (Q-C1-Ph—C1-O—C3)5(H)3-T8 |
| 14 | C1-O—C1 | 6 | | 0 | 2 | 0 | (Q-C1-Ph—C1-O—C3)6(H)2-T8 |
| 15 | C1-O—C1 | 7 | | 0 | 1 | 0 | (Q-C1-Ph—C1-O—C3)7(H)-T8 |
| 16 | C1-O—C1 | 8 | | 0 | 0 | 0 | (Q-C1-Ph—C1-O—C3)8-T8 |
| 17 | C2-O | 1 | | 0 | 7 | 0 | (Q-C1-Ph—C2-O—C2)(H)7-T8 |
| 18 | C2-O | 2 | | 0 | 6 | 0 | (Q-C1-Ph—C2-O—C2)2(H)6-T8 |
| 19 | C2-O | 3 | | 0 | 5 | 0 | (Q-C1-Ph—C2-O—C2)3(H)5-T8 |
| 20 | C2-O | 4 | | 0 | 4 | 0 | (Q-C1-Ph—C2-O—C2)4(H)4-T8 |
| 21 | C2-O | 5 | | 0 | 3 | 0 | (Q-C1-Ph—C2-O—C2)5(H)3-T8 |
| 22 | C2-O | 6 | | 0 | 2 | 0 | (Q-C1-Ph—C2-O—C2)6(H)2-T8 |
| 23 | C2-O | 7 | | 0 | 1 | 0 | (Q-C1-Ph—C2-O—C2)7(H)-T8 |
| 24 | C2-O | 8 | | 0 | 0 | 0 | (Q-C1-Ph—C2-O—C2)8-T8 |
| 25 | C2-O—C1 | 1 | | 0 | 7 | 0 | (Q-C1-Ph—C2-O—C3)(H)7-T8 |
| 26 | C2-O—C1 | 2 | | 0 | 6 | 0 | (Q-C1-Ph—C2-O—C3)2(H)6-T8 |
| 27 | C2-O—C1 | 3 | | 0 | 5 | 0 | (Q-C1-Ph—C2-O—C3)3(H)5-T8 |
| 28 | C2-O—C1 | 4 | | 0 | 4 | 0 | (Q-C1-Ph—C2-O—C3)4(H)4-T8 |
| 29 | C2-O—C1 | 5 | | 0 | 3 | 0 | (Q-C1-Ph—C2-O—C3)5(H)3-T8 |
| 30 | C2-O—C1 | 6 | | 0 | 2 | 0 | (Q-C1-Ph—C2-O—C3)6(H)2-T8 |
| 31 | C2-O—C1 | 7 | | 0 | 1 | 0 | (Q-C1-Ph—C2-O—C3)7(H)-T8 |
| 32 | C2-O—C1 | 8 | | 0 | 0 | 0 | (Q-C1-Ph—C2-O—C3)8-T8 |

TABLE 16

| No. | Z³ | a | R⁷ | b | c | e | Formula(14) |
|---|---|---|---|---|---|---|---|
| 1 | — | 1 | B | 7 | 0 | 0 | (Q-C1-Ph—C2)(B—C2)7-T8 |
| 2 | — | 2 | B | 6 | 0 | 0 | (Q-C1-Ph—C2)2(B—C2)6-T8 |
| 3 | — | 3 | B | 5 | 0 | 0 | (Q-C1-Ph—C2)3(B—C2)5-T8 |
| 4 | — | 4 | B | 4 | 0 | 0 | (Q-C1-Ph—C2)4(B—C2)4-T8 |
| 5 | — | 5 | B | 3 | 0 | 0 | (Q-C1-Ph—C2)5(B—C2)3-T8 |
| 6 | — | 6 | B | 2 | 0 | 0 | (Q-C1-Ph—C2)6(B—C2)2-T8 |
| 7 | — | 7 | B | 1 | 0 | 0 | (Q-C1-Ph—C2)7(B—C2)-T8 |
| 8 | C1 | 1 | B | 7 | 0 | 0 | (Q-C1-Ph—C3)(B—C2)7-T8 |
| 9 | C1 | 2 | B | 6 | 0 | 0 | (Q-C1-Ph—C3)2(B—C2)6-T8 |
| 10 | C1 | 3 | B | 5 | 0 | 0 | (Q-C1-Ph—C3)3(B—C2)5-T8 |
| 11 | C1 | 4 | B | 4 | 0 | 0 | (Q-C1-Ph—C3)4(B—C2)4-T8 |
| 12 | C1 | 5 | B | 3 | 0 | 0 | (Q-C1-Ph—C3)5(B—C2)3-T8 |
| 13 | C1 | 6 | B | 2 | 0 | 0 | (Q-C1-Ph—C3)6(B—C2)2-T8 |
| 14 | C1 | 7 | B | 1 | 0 | 0 | (Q-C1-Ph—C3)7(B—C2)-T8 |
| 15 | O | 1 | B | 7 | 0 | 0 | (Q-C1-Ph—O—C2)(B—C2)7-T8 |
| 16 | O | 2 | B | 6 | 0 | 0 | (Q-C1-Ph—O—C2)2(B—C2)6-T8 |
| 17 | O | 3 | B | 5 | 0 | 0 | (Q-C1-Ph—O—C2)3(B—C2)5-T8 |
| 18 | O | 4 | B | 4 | 0 | 0 | (Q-C1-Ph—O—C2)4(B—C2)4-T8 |
| 19 | O | 5 | B | 3 | 0 | 0 | (Q-C1-Ph—O—C2)5(B—C2)3-T8 |
| 20 | O | 6 | B | 2 | 0 | 0 | (Q-C1-Ph—O—C2)6(B—C2)2-T8 |
| 21 | O | 7 | B | 1 | 0 | 0 | (Q-C1-Ph—O—C2)7(B—C2)-T8 |
| 22 | O—C1 | 1 | B | 7 | 0 | 0 | (Q-C1-Ph—O—C3)(B—C2)7-T8 |
| 23 | O—C1 | 2 | B | 6 | 0 | 0 | (Q-C1-Ph—O—C3)2(B—C2)6-T8 |
| 24 | O—C1 | 3 | B | 5 | 0 | 0 | (Q-C1-Ph—O—C3)3(B—C2)5-T8 |
| 25 | O—C1 | 4 | B | 4 | 0 | 0 | (Q-C1-Ph—O—C3)4(B—C2)4-T8 |
| 26 | O—C1 | 5 | B | 3 | 0 | 0 | (Q-C1-Ph—O—C3)5(B—C2)3-T8 |
| 27 | O—C1 | 6 | B | 2 | 0 | 0 | (Q-C1-Ph—O—C3)6(B—C2)2-T8 |
| 28 | O—C1 | 7 | B | 1 | 0 | 0 | (Q-C1-Ph—O—C3)7(B—C2)-T8 |

TABLE 17

| No. | Z³ | a | R⁷ | b | c | e | Formula(14) |
|---|---|---|---|---|---|---|---|
| 1 | C1-O | 1 | B | 7 | 0 | 0 | (Q-C1-Ph—C1-O—C2)(B—C2)7-T8 |
| 2 | C1-O | 2 | B | 6 | 0 | 0 | (Q-C1-Ph—C1-O—C2)2(B—C2)6-T8 |
| 3 | C1-O | 3 | B | 5 | 0 | 0 | (Q-C1-Ph—C1-O—C2)3(B—C2)5-T8 |
| 4 | C1-O | 4 | B | 4 | 0 | 0 | (Q-C1-Ph—C1-O—C2)4(B—C2)4-T8 |
| 5 | C1-O | 5 | B | 3 | 0 | 0 | (Q-C1-Ph—C1-O—C2)5(B—C2)3-T8 |
| 6 | C1-O | 6 | B | 2 | 0 | 0 | (Q-C1-Ph—C1-O—C2)6(B—C2)2-T8 |
| 7 | C1-O | 7 | B | 1 | 0 | 0 | (Q-C1-Ph—C1-O—C2)7(B—C2)-T8 |
| 8 | C1-O—C1 | 1 | B | 7 | 0 | 0 | (Q-C1-Ph—C1-O—C3)(B—C2)7-T8 |
| 9 | C1-O—C1 | 2 | B | 6 | 0 | 0 | (Q-C1-Ph—C1-O—C3)2(B—C2)6-T8 |
| 10 | C1-O—C1 | 3 | B | 5 | 0 | 0 | (Q-C1-Ph—C1-O—C3)3(B—C2)5-T8 |
| 11 | C1-O—C1 | 4 | B | 4 | 0 | 0 | (Q-C1-Ph—C1-O—C3)4(B—C2)4-T8 |
| 12 | C1-O—C1 | 5 | B | 3 | 0 | 0 | (Q-C1-Ph—C1-O—C3)5(B—C2)3-T8 |
| 13 | C1-O—C1 | 6 | B | 2 | 0 | 0 | (Q-C1-Ph—C1-O—C3)6(B—C2)2-T8 |
| 14 | C1-O—C1 | 7 | B | 1 | 0 | 0 | (Q-C1-Ph—C1-O—C3)7(B—C2)-T8 |
| 15 | C2-O | 1 | B | 7 | 0 | 0 | (Q-C1-Ph—C2-O—C2)(B—C2)7-T8 |
| 16 | C2-O | 2 | B | 6 | 0 | 0 | (Q-C1-Ph—C2-O—C2)2(B—C2)6-T8 |
| 17 | C2-O | 3 | B | 5 | 0 | 0 | (Q-C1-Ph—C2-O—C2)3(B—C2)5-T8 |
| 18 | C2-O | 4 | B | 4 | 0 | 0 | (Q-C1-Ph—C2-O—C2)4(B—C2)4-T8 |
| 19 | C2-O | 5 | B | 3 | 0 | 0 | (Q-C1-Ph—C2-O—C2)5(B—C2)3-T8 |
| 20 | C2-O | 6 | B | 2 | 0 | 0 | (Q-C1-Ph—C2-O—C2)6(B—C2)2-T8 |
| 21 | C2-O | 7 | B | 1 | 0 | 0 | (Q-C1-Ph—C2-O—C2)7(B—C2)-T8 |
| 22 | C2-O—C1 | 1 | B | 7 | 0 | 0 | (Q-C1-Ph—C2-O—C3)(B—C2)7-T8 |
| 23 | C2-O—C1 | 2 | B | 6 | 0 | 0 | (Q-C1-Ph—C2-O—C3)2(B—C2)6-T8 |
| 24 | C2-O—C1 | 3 | B | 5 | 0 | 0 | (Q-C1-Ph—C2-O—C3)3(B—C2)5-T8 |
| 25 | C2-O—C1 | 4 | B | 4 | 0 | 0 | (Q-C1-Ph—C2-O—C3)4(B—C2)4-T8 |
| 26 | C2-O—C1 | 5 | B | 3 | 0 | 0 | (Q-C1-Ph—C2-O—C3)5(B—C2)3-T8 |
| 27 | C2-O—C1 | 6 | B | 2 | 0 | 0 | (Q-C1-Ph—C2-O—C3)6(B—C2)2-T8 |
| 28 | C2-O—C1 | 7 | B | 1 | 0 | 0 | (Q-C1-Ph—C2-O—C3)7(B—C2)-T8 |

TABLE 18

| No. | Z³ | a | R⁷ | b | c | e | Formula(14) |
|---|---|---|---|---|---|---|---|
| 1 | — | 1 | B—O | 7 | 0 | 0 | (Q-C1-Ph—C2)(B—C2)7-T8 |
| 2 | — | 2 | B—O | 6 | 0 | 0 | (Q-C1-Ph—C2)2(B—C2)6-T8 |
| 3 | — | 3 | B—O | 5 | 0 | 0 | (Q-C1-Ph—C2)3(B—C2)5-T8 |
| 4 | — | 4 | B—O | 4 | 0 | 0 | (Q-C1-Ph—C2)4(B—C2)4-T8 |
| 5 | — | 5 | B—O | 3 | 0 | 0 | (Q-C1-Ph—C2)5(B—C2)3-T8 |
| 6 | — | 6 | B—O | 2 | 0 | 0 | (Q-C1-Ph—C2)6(B—C2)2-T8 |
| 7 | — | 7 | B—O | 1 | 0 | 0 | (Q-C1-Ph—C2)7(B—C2)-T8 |
| 8 | C1 | 1 | B—O | 7 | 0 | 0 | (Q-C1-Ph—C3)(B—C2)7-T8 |
| 9 | C1 | 2 | B—O | 6 | 0 | 0 | (Q-C1-Ph—C3)2(B—C2)6-T8 |
| 10 | C1 | 3 | B—O | 5 | 0 | 0 | (Q-C1-Ph—C3)3(B—C2)5-T8 |
| 11 | C1 | 4 | B—O | 4 | 0 | 0 | (Q-C1-Ph—C3)4(B—C2)4-T8 |
| 12 | C1 | 5 | B—O | 3 | 0 | 0 | (Q-C1-Ph—C3)5(B—C2)3-T8 |
| 13 | C1 | 6 | B—O | 2 | 0 | 0 | (Q-C1-Ph—C3)6(B—C2)2-T8 |
| 14 | C1 | 7 | B—O | 1 | 0 | 0 | (Q-C1-Ph—C3)7(B—C2)-T8 |
| 15 | O | 1 | B—O | 7 | 0 | 0 | (Q-C1-Ph—O—C2)(B—C2)7-T8 |
| 16 | O | 2 | B—O | 6 | 0 | 0 | (Q-C1-Ph—O—C2)2(B—C2)6-T8 |
| 17 | O | 3 | B—O | 5 | 0 | 0 | (Q-C1-Ph—O—C2)3(B—C2)5-T8 |
| 18 | O | 4 | B—O | 4 | 0 | 0 | (Q-C1-Ph—O—C2)4(B—C2)4-T8 |
| 19 | O | 5 | B—O | 3 | 0 | 0 | (Q-C1-Ph—O—C2)5(B—C2)3-T8 |
| 20 | O | 6 | B—O | 2 | 0 | 0 | (Q-C1-Ph—O—C2)6(B—C2)2-T8 |
| 21 | O | 7 | B—O | 1 | 0 | 0 | (Q-C1-Ph—O—C2)7(B—C2)-T8 |
| 22 | O—C1 | 1 | B—O | 7 | 0 | 0 | (Q-C1-Ph—O—C3)(B—C2)7-T8 |
| 23 | O—C1 | 2 | B—O | 6 | 0 | 0 | (Q-C1-Ph—O—C3)2(B—C2)6-T8 |
| 24 | O—C1 | 3 | B—O | 5 | 0 | 0 | (Q-C1-Ph—O—C3)3(B—C2)5-T8 |
| 25 | O—C1 | 4 | B—O | 4 | 0 | 0 | (Q-C1-Ph—O—C3)4(B—C2)4-T8 |
| 26 | O—C1 | 5 | B—O | 3 | 0 | 0 | (Q-C1-Ph—O—C3)5(B—C2)3-T8 |
| 27 | O—C1 | 6 | B—O | 2 | 0 | 0 | (Q-C1-Ph—O—C3)6(B—C2)2-T8 |
| 28 | O—C1 | 7 | B—O | 1 | 0 | 0 | (Q-C1-Ph—O—C3)7(B—C2)-T8 |

TABLE 19

| No. | Z³ | a | R⁷ | b | c | e | Formula(14) |
|---|---|---|---|---|---|---|---|
| 1 | C1-O | 1 | B—O | 7 | 0 | 0 | (Q-C1-Ph—C1-O—C2)(B—C2)7-T8 |
| 2 | C1-O | 2 | B—O | 6 | 0 | 0 | (Q-C1-Ph—C1-O—C2)2(B—C2)6-T8 |
| 3 | C1-O | 3 | B—O | 5 | 0 | 0 | (Q-C1-Ph—C1-O—C2)3(B—C2)5-T8 |
| 4 | C1-O | 4 | B—O | 4 | 0 | 0 | (Q-C1-Ph—C1-O—C2)4(B—C2)4-T8 |
| 5 | C1-O | 5 | B—O | 3 | 0 | 0 | (Q-C1-Ph—C1-O—C2)5(B—C2)3-T8 |
| 6 | C1-O | 6 | B—O | 2 | 0 | 0 | (Q-C1-Ph—C1-O—C2)6(B—C2)2-T8 |
| 7 | C1-O | 7 | B—O | 1 | 0 | 0 | (Q-C1-Ph—C1-O—C2)7(B—C2)-T8 |
| 8 | C1-O—C1 | 1 | B—O | 7 | 0 | 0 | (Q-C1-Ph—C1-O—C3)(B—C2)7-T8 |
| 9 | C1-O—C1 | 2 | B—O | 6 | 0 | 0 | (Q-C1-Ph—C1-O—C3)2(B—C2)6-T8 |
| 10 | C1-O—C1 | 3 | B—O | 5 | 0 | 0 | (Q-C1-Ph—C1-O—C3)3(B—C2)5-T8 |
| 11 | C1-O—C1 | 4 | B—O | 4 | 0 | 0 | (Q-C1-Ph—C1-O—C3)4(B—C2)4-T8 |
| 12 | C1-O—C1 | 5 | B—O | 3 | 0 | 0 | (Q-C1-Ph—C1-O—C3)5(B—C2)3-T8 |
| 13 | C1-O—C1 | 6 | B—O | 2 | 0 | 0 | (Q-C1-Ph—C1-O—C3)6(B—C2)2-T8 |
| 14 | C1-O—C1 | 7 | B—O | 1 | 0 | 0 | (Q-C1-Ph—C1-O—C3)7(B—C2)-T8 |
| 15 | C2-O | 1 | B—O | 7 | 0 | 0 | (Q-C1-Ph—C2-O—C2)(B—C2)7-T8 |
| 16 | C2-O | 2 | B—O | 6 | 0 | 0 | (Q-C1-Ph—C2-O—C2)2(B—C2)6-T8 |
| 17 | C2-O | 3 | B—O | 5 | 0 | 0 | (Q-C1-Ph—C2-O—C2)3(B—C2)5-T8 |
| 18 | C2-O | 4 | B—O | 4 | 0 | 0 | (Q-C1-Ph—C2-O—C2)4(B—C2)4-T8 |
| 19 | C2-O | 5 | B—O | 3 | 0 | 0 | (Q-C1-Ph—C2-O—C2)5(B—C2)3-T8 |
| 20 | C2-O | 6 | B—O | 2 | 0 | 0 | (Q-C1-Ph—C2-O—C2)6(B—C2)2-T8 |
| 21 | C2-O | 7 | B—O | 1 | 0 | 0 | (Q-C1-Ph—C2-O—C2)7(B—C2)-T8 |
| 22 | C2-O—C1 | 1 | B—O | 7 | 0 | 0 | (Q-C1-Ph—C2-O—C3)(B—C2)7-T8 |
| 23 | C2-O—C1 | 2 | B—O | 6 | 0 | 0 | (Q-C1-Ph—C2-O—C3)2(B—C2)6-T8 |
| 24 | C2-O—C1 | 3 | B—O | 5 | 0 | 0 | (Q-C1-Ph—C2-O—C3)3(B—C2)5-T8 |
| 25 | C2-O—C1 | 4 | B—O | 4 | 0 | 0 | (Q-C1-Ph—C2-O—C3)4(B—C2)4-T8 |
| 26 | C2-O—C1 | 5 | B—O | 3 | 0 | 0 | (Q-C1-Ph—C2-O—C3)5(B—C2)3-T8 |
| 27 | C2-O—C1 | 6 | B—O | 2 | 0 | 0 | (Q-C1-Ph—C2-O—C3)6(B—C2)2-T8 |
| 28 | C2-O—C1 | 7 | B—O | 1 | 0 | 0 | (Q-C1-Ph—C2-O—C3)7(B—C2)-T8 |

TABLE 20

| No. | Z³ | a | R⁷ | b | c | e | Formula(14) |
|---|---|---|---|---|---|---|---|
| 1 | — | 1 | | 0 | 7 | 1 | (Q-C1-Ph—C2)(H)7-(DT)8 |
| 2 | — | 2 | | 0 | 6 | 1 | (Q-C1-Ph—C2)2(H)6-(DT)8 |
| 3 | — | 3 | | 0 | 5 | 1 | (Q-C1-Ph—C2)3(H)5-(DT)8 |
| 4 | — | 4 | | 0 | 4 | 1 | (Q-C1-Ph—C2)4(H)4-(DT)8 |
| 5 | — | 5 | | 0 | 3 | 1 | (Q-C1-Ph—C2)5(H)3-(DT)8 |
| 6 | — | 6 | | 0 | 2 | 1 | (Q-C1-Ph—C2)6(H)2-(DT)8 |
| 7 | — | 7 | | 0 | 1 | 1 | (Q-C1-Ph—C2)7(H)-(DT)8 |
| 8 | — | 8 | | 0 | 0 | 1 | (Q-C1-Ph—C2)8-(DT)8 |
| 9 | C1 | 1 | | 0 | 7 | 1 | (Q-C1-Ph—C3)(H)7-(DT)8 |
| 10 | C1 | 2 | | 0 | 6 | 1 | (Q-C1-Ph—C3)2(H)6-(DT)8 |
| 11 | C1 | 3 | | 0 | 5 | 1 | (Q-C1-Ph—C3)3(H)5-(DT)8 |
| 12 | C1 | 4 | | 0 | 4 | 1 | (Q-C1-Ph—C3)4(H)4-(DT)8 |
| 13 | C1 | 5 | | 0 | 3 | 1 | (Q-C1-Ph—C3)5(H)3-(DT)8 |
| 14 | C1 | 6 | | 0 | 2 | 1 | (Q-C1-Ph—C3)6(H)2-(DT)8 |
| 15 | C1 | 7 | | 0 | 1 | 1 | (Q-C1-Ph—C3)7(H)-(DT)8 |
| 16 | C1 | 8 | | 0 | 0 | 1 | (Q-C1-Ph—C3)8-(DT)8 |
| 17 | O | 1 | | 0 | 7 | 1 | (Q-C1-Ph—O—C2)(H)7-(DT)8 |
| 18 | O | 2 | | 0 | 6 | 1 | (Q-C1-Ph—O—C2)2(H)6-(DT)8 |
| 19 | O | 3 | | 0 | 5 | 1 | (Q-C1-Ph—O—C2)3(H)5-(DT)8 |
| 20 | O | 4 | | 0 | 4 | 1 | (Q-C1-Ph—O—C2)4(H)4-(DT)8 |
| 21 | O | 5 | | 0 | 3 | 1 | (Q-C1-Ph—O—C2)5(H)3-(DT)8 |
| 22 | O | 6 | | 0 | 2 | 1 | (Q-C1-Ph—O—C2)6(H)2-(DT)8 |
| 23 | O | 7 | | 0 | 1 | 1 | (Q-C1-Ph—O—C2)7(H)-(DT)8 |
| 24 | O | 8 | | 0 | 0 | 1 | (Q-C1-Ph—O—C2)8-(DT)8 |
| 25 | O—C1 | 1 | | 0 | 7 | 1 | (Q-C1-Ph—O—C3)(H)7-(DT)8 |
| 26 | O—C1 | 2 | | 0 | 6 | 1 | (Q-C1-Ph—O—C3)2(H)6-(DT)8 |
| 27 | O—C1 | 3 | | 0 | 5 | 1 | (Q-C1-Ph—O—C3)3(H)5-(DT)8 |
| 28 | O—C1 | 4 | | 0 | 4 | 1 | (Q-C1-Ph—O—C3)4(H)4-(DT)8 |
| 29 | O—C1 | 5 | | 0 | 3 | 1 | (Q-C1-Ph—O—C3)5(H)3-(DT)8 |
| 30 | O—C1 | 6 | | 0 | 2 | 1 | (Q-C1-Ph—O—C3)6(H)2-(DT)8 |
| 31 | O—C1 | 7 | | 0 | 1 | 1 | (Q-C1-Ph—O—C3)7(H)-(DT)8 |
| 32 | O—C1 | 8 | | 0 | 0 | 1 | (Q-C1-Ph—O—C3)8-(DT)8 |

TABLE 21

| No. | Z³ | a | R⁷ | b | c | e | Formula(4) |
|---|---|---|---|---|---|---|---|
| 1 | C1-O | 1 | | 0 | 7 | 1 | (Q-C1-Ph—C1-O—C2)(H)7-(DT)8 |
| 2 | C1-O | 2 | | 0 | 6 | 1 | (Q-C1-Ph—C1-O—C2)2(H)6-(DT)8 |
| 3 | C1-O | 3 | | 0 | 5 | 1 | (Q-C1-Ph—C1-O—C2)3(H)5-(DT)8 |
| 4 | C1-O | 4 | | 0 | 4 | 1 | (Q-C1-Ph—C1-O—C2)4(H)4-(DT)8 |
| 5 | C1-O | 5 | | 0 | 3 | 1 | (Q-C1-Ph—C1-O—C2)5(H)3-(DT)8 |
| 6 | C1-O | 6 | | 0 | 2 | 1 | (Q-C1-Ph—C1-O—C2)6(H)2-(DT)8 |
| 7 | C1-O | 7 | | 0 | 1 | 1 | (Q-C1-Ph—C1-O—C2)7(H)-(DT)8 |
| 8 | C1-O | 8 | | 0 | 0 | 1 | (Q-C1-Ph—C1-O—C2)8-(DT)8 |
| 9 | C1-O—C1 | 1 | | 0 | 7 | 1 | (Q-C1-Ph—C1-O—C3)(H)7-(DT)8 |
| 10 | C1-O—C1 | 2 | | 0 | 6 | 1 | (Q-C1-Ph—C1-O—C3)2(H)6-(DT)8 |
| 11 | C1-O—C1 | 3 | | 0 | 5 | 1 | (Q-C1-Ph—C1-O—C3)3(H)5-(DT)8 |
| 12 | C1-O—C1 | 4 | | 0 | 4 | 1 | (Q-C1-Ph—C1-O—C3)4(H)4-(DT)8 |
| 13 | C1-O—C1 | 5 | | 0 | 3 | 1 | (Q-C1-Ph—C1-O—C3)5(H)3-(DT)8 |
| 14 | C1-O—C1 | 6 | | 0 | 2 | 1 | (Q-C1-Ph—C1-O—C3)6(H)2-(DT)8 |
| 15 | C1-O—C1 | 7 | | 0 | 1 | 1 | (Q-C1-Ph—C1-O—C3)7(H)-(DT)8 |
| 16 | C1-O—C1 | 8 | | 0 | 0 | 1 | (Q-C1-Ph—C1-O—C3)8-(DT)8 |
| 17 | C2-O | 1 | | 0 | 7 | 1 | (Q-C1-Ph—C2-O—C2)(H)7-(DT)8 |
| 18 | C2-O | 2 | | 0 | 6 | 1 | (Q-C1-Ph—C2-O—C2)2(H)6-(DT)8 |
| 19 | C2-O | 3 | | 0 | 5 | 1 | (Q-C1-Ph—C2-O—C2)3(H)5-(DT)8 |
| 20 | C2-O | 4 | | 0 | 4 | 1 | (Q-C1-Ph—C2-O—C2)4(H)4-(DT)8 |
| 21 | C2-O | 5 | | 0 | 3 | 1 | (Q-C1-Ph—C2-O—C2)5(H)3-(DT)8 |
| 22 | C2-O | 6 | | 0 | 2 | 1 | (Q-C1-Ph—C2-O—C2)6(H)2-(DT)8 |
| 23 | C2-O | 7 | | 0 | 1 | 1 | (Q-C1-Ph—C2-O—C2)7(H)-(DT)8 |
| 24 | C2-O | 8 | | 0 | 0 | 1 | (Q-C1-Ph—C2-O—C2)8-(DT)8 |
| 25 | C2-O—C1 | 1 | | 0 | 7 | 1 | (Q-C1-Ph—C2-O—C3)(H)7-(DT)8 |
| 26 | C2-O—C1 | 2 | | 0 | 6 | 1 | (Q-C1-Ph—C2-O—C3)2(H)6-(DT)8 |
| 27 | C2-O—C1 | 3 | | 0 | 5 | 1 | (Q-C1-Ph—C2-O—C3)3(H)5-(DT)8 |
| 28 | C2-O—C1 | 4 | | 0 | 4 | 1 | (Q-C1-Ph—C2-O—C3)4(H)4-(DT)8 |
| 29 | C2-O—C1 | 5 | | 0 | 3 | 1 | (Q-C1-Ph—C2-O—C3)5(H)3-(DT)8 |
| 30 | C2-O—C1 | 6 | | 0 | 2 | 1 | (Q-C1-Ph—C2-O—C3)6(H)2-(DT)8 |
| 31 | C2-O—C1 | 7 | | 0 | 1 | 1 | (Q-C1-Ph—C2-O—C3)7(H)-(DT)8 |
| 32 | C2-O—C1 | 8 | | 0 | 0 | 1 | (Q-C1-Ph—C2-O—C3)8-(DT)8 |

TABLE 22

| No. | Z³ | a | R⁷ | b | c | e | Formula(14) |
|---|---|---|---|---|---|---|---|
| 1 | — | 1 | B | 7 | 0 | 1 | (Q-C1-Ph—C2)(B—C2)7-(DT)8 |
| 2 | — | 2 | B | 6 | 0 | 1 | (Q-C1-Ph—C2)2(B—C2)6-(DT)8 |
| 3 | — | 3 | B | 5 | 0 | 1 | (Q-C1-Ph—C2)3(B—C2)5-(DT)8 |
| 4 | — | 4 | B | 4 | 0 | 1 | (Q-C1-Ph—C2)4(B—C2)4-(DT)8 |
| 5 | — | 5 | B | 3 | 0 | 1 | (Q-C1-Ph—C2)5(B—C2)3-(DT)8 |
| 6 | — | 6 | B | 2 | 0 | 1 | (Q-C1-Ph—C2)6(B—C2)2-(DT)8 |
| 7 | — | 7 | B | 1 | 0 | 1 | (Q-C1-Ph—C2)7(B—C2)-(DT)8 |
| 8 | C1 | 1 | B | 7 | 0 | 1 | (Q-C1-Ph—C3)(B—C2)7-(DT)8 |
| 9 | C1 | 2 | B | 6 | 0 | 1 | (Q-C1-Ph—C3)2(B—C2)6-(DT)8 |
| 10 | C1 | 3 | B | 5 | 0 | 1 | (Q-C1-Ph—C3)3(B—C2)5-(DT)8 |
| 11 | C1 | 4 | B | 4 | 0 | 1 | (Q-C1-Ph—C3)4(B—C2)4-(DT)8 |
| 12 | C1 | 5 | B | 3 | 0 | 1 | (Q-C1-Ph—C3)5(B—C2)3-(DT)8 |
| 13 | C1 | 6 | B | 2 | 0 | 1 | (Q-C1-Ph—C3)6(B—C2)2-(DT)8 |
| 14 | C1 | 7 | B | 1 | 0 | 1 | (Q-C1-Ph—C3)7(B—C2)-(DT)8 |
| 15 | O | 1 | B | 7 | 0 | 1 | (Q-C1-Ph-O—C2)(B—C2)7-(DT)8 |
| 16 | O | 2 | B | 6 | 0 | 1 | (Q-C1-Ph-O—C2)2(B—C2)6-(DT)8 |
| 17 | O | 3 | B | 5 | 0 | 1 | (Q-C1-Ph-O—C2)3(B—C2)5-(DT)8 |
| 18 | O | 4 | B | 4 | 0 | 1 | (Q-C1-Ph-O—C2)4(B—C2)4-(DT)8 |
| 19 | O | 5 | B | 3 | 0 | 1 | (Q-C1-Ph-O—C2)5(B—C2)3-(DT)8 |
| 20 | O | 6 | B | 2 | 0 | 1 | (Q-C1-Ph-O—C2)6(B—C2)2-(DT)8 |
| 21 | O | 7 | B | 1 | 0 | 1 | (Q-C1-Ph-O—C2)7(B—C2)-(DT)8 |
| 22 | O—C1 | 1 | B | 7 | 0 | 1 | (Q-C1-Ph-O—C3)(B—C2)7-(DT)8 |
| 23 | O—C1 | 2 | B | 6 | 0 | 1 | (Q-C1-Ph-O—C3)2(B—C2)6-(DT)8 |
| 24 | O—C1 | 3 | B | 5 | 0 | 1 | (Q-C1-Ph-O—C3)3(B—C2)5-(DT)8 |
| 25 | O—C1 | 4 | B | 4 | 0 | 1 | (Q-C1-Ph-O—C3)4(B—C2)4-(DT)8 |
| 26 | O—C1 | 5 | B | 3 | 0 | 1 | (Q-C1-Ph-O—C3)5(B—C2)3-(DT)8 |
| 27 | O—C1 | 6 | B | 2 | 0 | 1 | (Q-C1-Ph-O—C3)6(B—C2)2-(DT)8 |
| 28 | O—C1 | 7 | B | 1 | 0 | 1 | (Q-C1-Ph-O—C3)7(B—C2)-(DT)8 |

TABLE 23

| NO. | Z³ | a | R⁷ | b | c | e | Formula(14) |
|---|---|---|---|---|---|---|---|
| 1 | C1-O | 1 | B | 7 | 0 | 1 | (Q-C1-Ph—C1-O—C2)(B—C2)7-(DT)8 |
| 2 | C1-O | 2 | B | 6 | 0 | 1 | (Q-C1-Ph—C1-O—C2)2(B—C2)6-(DT)8 |
| 3 | C1-O | 3 | B | 5 | 0 | 1 | (Q-C1-Ph—C1-O—C2)3(B—C2)5-(DT)8 |
| 4 | C1-O | 4 | B | 4 | 0 | 1 | (Q-C1-Ph—C1-O—C2)4(B—C2)4-(DT)8 |
| 5 | C1-O | 5 | B | 3 | 0 | 1 | (Q-C1-Ph—C1-O—C2)5(B—C2)3-(DT)8 |
| 6 | C1-O | 6 | B | 2 | 0 | 1 | (Q-C1-Ph—C1-O—C2)6(B—C2)2-(DT)8 |
| 7 | C1-O | 7 | B | 1 | 0 | 1 | (Q-C1-Ph—C1-O—C2)7(B—C2)-(DT)8 |
| 8 | C1-O—C1 | 1 | B | 7 | 0 | 1 | (Q-C1-Ph—C1-O—C3)(B—C2)7-(DT)8 |
| 9 | C1-O—C1 | 2 | B | 6 | 0 | 1 | (Q-C1-Ph—C1-O—C3)2(B—C2)6-(DT)8 |
| 10 | C1-O—C1 | 3 | B | 5 | 0 | 1 | (Q-C1-Ph—C1-O—C3)3(B—C2)5-(DT)8 |
| 11 | C1-O—C1 | 4 | B | 4 | 0 | 1 | (Q-C1-Ph—C1-O—C3)4(B—C2)4-(DT)8 |
| 12 | C1-O—C1 | 5 | B | 3 | 0 | 1 | (Q-C1-Ph—C1-O—C3)5(B—C2)3-(DT)8 |
| 13 | C1-O—C1 | 6 | B | 2 | 0 | 1 | (Q-C1-Ph—C1-O—C3)6(B—C2)2-(DT)8 |
| 14 | C1-O—C1 | 7 | B | 1 | 0 | 1 | (Q-C1-Ph—C1-O—C3)7(B—C2)-(DT)8 |
| 15 | C2-O | 1 | B | 7 | 0 | 1 | (Q-C1-Ph—C2-O—C2)(B—C2)7-(DT)8 |
| 16 | C2-O | 2 | B | 6 | 0 | 1 | (Q-C1-Ph—C2-O—C2)2(B—C2)6-(DT)8 |
| 17 | C2-O | 3 | B | 5 | 0 | 1 | (Q-C1-Ph—C2-O—C2)3(B—C2)5-(DT)8 |
| 18 | C2-O | 4 | B | 4 | 0 | 1 | (Q-C1-Ph—C2-O—C2)4(B—C2)4-(DT)8 |
| 19 | C2-O | 5 | B | 3 | 0 | 1 | (Q-C1-Ph—C2-O—C2)5(B—C2)3-(DT)8 |
| 20 | C2-O | 6 | B | 2 | 0 | 1 | (Q-C1-Ph—C2-O—C2)6(B—C2)2-(DT)8 |
| 21 | C2-O | 7 | B | 1 | 0 | 1 | (Q-C1-Ph—C2-O—C2)7(B—C2)-(DT)8 |
| 22 | C2-O—C1 | 1 | B | 7 | 0 | 1 | (Q-C1-Ph—C2-O—C3)(B—C2)7-(DT)8 |
| 23 | C2-O—C1 | 2 | B | 6 | 0 | 1 | (Q-C1-Ph—C2-O—C3)2(B—C2)6-(DT)8 |
| 24 | C2-O—C1 | 3 | B | 5 | 0 | 1 | (Q-C1-Ph—C2-O—C3)3(B—C2)5-(DT)8 |
| 25 | C2-O—C1 | 4 | B | 4 | 0 | 1 | (Q-C1-Ph—C2-O—C3)4(B—C2)4-(DT)8 |
| 26 | C2-O—C1 | 5 | B | 3 | 0 | 1 | (Q-C1-Ph—C2-O—C3)5(B—C2)3-(DT)8 |
| 27 | C2-O—C1 | 6 | B | 2 | 0 | 1 | (Q-C1-Ph—C2-O—C3)6(B—C2)2-(DT)8 |
| 28 | C2-O—C1 | 7 | B | 1 | 0 | 1 | (Q-C1-Ph—C2-O—C3)7(B—C2)-(DT)8 |

TABLE 24

| NO. | Z³ | a | R⁷ | b | c | e | Formula(14) |
|---|---|---|---|---|---|---|---|
| 1 | — | 1 | B—O | 7 | 0 | 1 | (Q-C1-Ph—C2)(B—C2)7-(DT)8 |
| 2 | — | 2 | B—O | 6 | 0 | 1 | (Q-C1-Ph—C2)2(B—C2)6-(DT)8 |
| 3 | — | 3 | B—O | 5 | 0 | 1 | (Q-C1-Ph—C2)3(B—C2)5-(DT)8 |
| 4 | — | 4 | B—O | 4 | 0 | 1 | (Q-C1-Ph—C2)4(B—C2)4-(DT)8 |
| 5 | — | 5 | B—O | 3 | 0 | 1 | (Q-C1-Ph—C2)5(B—C2)3-(DT)8 |
| 6 | — | 6 | B—O | 2 | 0 | 1 | (Q-C1-Ph—C2)6(B—C2)2-(DT)8 |
| 7 | — | 7 | B—O | 1 | 0 | 1 | (Q-C1-Ph—C2)7(B—C2)-(DT)8 |
| 8 | C1 | 1 | B—O | 7 | 0 | 1 | (Q-C1-Ph—C3)(B—C2)7-(DT)8 |
| 9 | C1 | 2 | B—O | 6 | 0 | 1 | (Q-C1-Ph—C3)2(B—C2)6-(DT)8 |
| 10 | C1 | 3 | B—O | 5 | 0 | 1 | (Q-C1-Ph—C3)3(B—C2)5-(DT)8 |
| 11 | C1 | 4 | B—O | 4 | 0 | 1 | (Q-C1-Ph—C3)4(B—C2)4-(DT)8 |
| 12 | C1 | 5 | B—O | 3 | 0 | 1 | (Q-C1-Ph—C3)5(B—C2)3-(DT)8 |
| 13 | C1 | 6 | B—O | 2 | 0 | 1 | (Q-C1-Ph—C3)6(B—C2)2-(DT)8 |
| 14 | C1 | 7 | B—O | 1 | 0 | 1 | (Q-C1-Ph—C3)7(B—C2)-(DT)8 |
| 15 | O | 1 | B—O | 7 | 0 | 1 | (Q-C1-Ph-O—C2)(B—C2)7-(DT)8 |
| 16 | O | 2 | B—O | 6 | 0 | 1 | (Q-C1-Ph-O—C2)2(B—C2)6-(DT)8 |
| 17 | O | 3 | B—O | 5 | 0 | 1 | (Q-C1-Ph-O—C2)3(B—C2)5-(DT)8 |
| 18 | O | 4 | B—O | 4 | 0 | 1 | (Q-C1-Ph-O—C2)4(B—C2)4-(DT)8 |
| 19 | O | 5 | B—O | 3 | 0 | 1 | (Q-C1-Ph-O—C2)5(B—C2)3-(DT)8 |
| 20 | O | 6 | B—O | 2 | 0 | 1 | (Q-C1-Ph-O—C2)6(B—C2)2-(DT)8 |
| 21 | O | 7 | B—O | 1 | 0 | 1 | (Q-C1-Ph-O—C2)7(B—C2)-(DT)8 |
| 22 | O—C1 | 1 | B—O | 7 | 0 | 1 | (Q-C1-Ph-O—C3)(B—C2)7-(DT)8 |
| 23 | O—C1 | 2 | B—O | 6 | 0 | 1 | (Q-C1-Ph-O—C3)2(B—C2)6-(DT)8 |
| 24 | O—C1 | 3 | B—O | 5 | 0 | 1 | (Q-C1-Ph-O—C3)3(B—C2)5-(DT)8 |
| 25 | O—C1 | 4 | B—O | 4 | 0 | 1 | (Q-C1-Ph-O—C3)4(B—C2)4-(DT)8 |
| 26 | O—C1 | 5 | B—O | 3 | 0 | 1 | (Q-C1-Ph-O—C3)5(B—C2)3-(DT)8 |
| 27 | O—C1 | 6 | B—O | 2 | 0 | 1 | (Q-C1-Ph-O—C3)6(B—C2)2-(DT)8 |
| 28 | O—C1 | 7 | B—O | 1 | 0 | 1 | (Q-C1-Ph-O—C3)7(B—C2)-(DT)8 |

TABLE 25

| No. | Z³ | a | R⁷ | b | c | e | Formula(14) |
|---|---|---|---|---|---|---|---|
| 1 | C1-O | 1 | B—O | 7 | 0 | 1 | (Q-C1-Ph—C1-O—C2)(B—C2)7-(DT)8 |
| 2 | C1-O | 2 | B—O | 6 | 0 | 1 | (Q-C1-Ph—C1-O—C2)2(B—C2)6-(DT)8 |
| 3 | C1-O | 3 | B—O | 5 | 0 | 1 | (Q-C1-Ph—C1-O—C2)3(B—C2)5-(DT)8 |
| 4 | C1-O | 4 | B—O | 4 | 0 | 1 | (Q-C1-Ph—C1-O—C2)4(B—C2)4-(DT)8 |
| 5 | C1-O | 5 | B—O | 3 | 0 | 1 | (Q-C1-Ph—C1-O—C2)5(B—C2)3-(DT)8 |
| 6 | C1-O | 6 | B—O | 2 | 0 | 1 | (Q-C1-Ph—C1-O—C2)6(B—C2)2-(DT)8 |
| 7 | C1-O | 7 | B—O | 1 | 0 | 1 | (Q-C1-Ph—C1-O—C2)7(B—C2)-(DT)8 |
| 8 | C1-O—C1 | 1 | B—O | 7 | 0 | 1 | (Q-C1-Ph—C1-O—C3)(B—C2)7-(DT)8 |
| 9 | C1-O—C1 | 2 | B—O | 6 | 0 | 1 | (Q-C1-Ph—C1-O—C3)2(B—C2)6-(DT)8 |
| 10 | C1-O—C1 | 3 | B—O | 5 | 0 | 1 | (Q-C1-Ph—C1-O—C3)3(B—C2)5-(DT)8 |
| 11 | C1-O—C1 | 4 | B—O | 4 | 0 | 1 | (Q-C1-Ph—C1-O—C3)4(B—C2)4-(DT)8 |
| 12 | C1-O—C1 | 5 | B—O | 3 | 0 | 1 | (Q-C1-Ph—C1-O—C3)5(B—C2)3-(DT)8 |
| 13 | C1-O—C1 | 6 | B—O | 2 | 0 | 1 | (Q-C1-Ph—C1-O—C3)6(B—C2)2-(DT)8 |
| 14 | C1-O—C1 | 7 | B—O | 1 | 0 | 1 | (Q-C1-Ph—C1-O—C3)7(B—C2)-(DT)8 |
| 15 | C2-O | 1 | B—O | 7 | 0 | 1 | (Q-C1-Ph—C2-O—C2)(B—C2)7-(DT)8 |
| 16 | C2-O | 2 | B—O | 6 | 0 | 1 | (Q-C1-Ph—C2-O—C2)2(B—C2)6-(DT)8 |
| 17 | C2-O | 3 | B—O | 5 | 0 | 1 | (Q-C1-Ph—C2-O—C2)3(B—C2)5-(DT)8 |
| 18 | C2-O | 4 | B—O | 4 | 0 | 1 | (Q-C1-Ph—C2-O—C2)4(B—C2)4-(DT)8 |
| 19 | C2-O | 5 | B—O | 3 | 0 | 1 | (Q-C1-Ph—C2-O—C2)5(B—C2)3-(DT)8 |
| 20 | C2-O | 6 | B—O | 2 | 0 | 1 | (Q-C1-Ph—C2-O—C2)6(B—C2)2-(DT)8 |
| 21 | C2-O | 7 | B—O | 1 | 0 | 1 | (Q-C1-Ph—C2-O—C2)7(B—C2)-(DT)8 |
| 22 | C2-O—C1 | 1 | B—O | 7 | 0 | 1 | (Q-C1-Ph—C2-O—C3)(B—C2)7-(DT)8 |
| 23 | C2-O—C1 | 2 | B—O | 6 | 0 | 1 | (Q-C1-Ph—C2-O—C3)2(B—C2)6-(DT)8 |
| 24 | C2-O—C1 | 3 | B—O | 5 | 0 | 1 | (Q-C1-Ph—C2-O—C3)3(B—C2)5-(DT)8 |
| 25 | C2-O—C1 | 4 | B—O | 4 | 0 | 1 | (Q-C1-Ph—C2-O—C3)4(B—C2)4-(DT)8 |
| 26 | C2-O—C1 | 5 | B—O | 3 | 0 | 1 | (Q-C1-Ph—C2-O—C3)5(B—C2)3-(DT)8 |
| 27 | C2-O—C1 | 6 | B—O | 2 | 0 | 1 | (Q-C1-Ph—C2-O—C3)6(B—C2)2-(DT)8 |
| 28 | C2-O—C1 | 7 | B—O | 1 | 0 | 1 | (Q-C1-Ph—C2-O—C3)7(B—C2)-(DT)8 |

The examples described above are the preferred examples of the silicon compound of the present invention. In Formula (13) or Formula (14), preferred as well is the compound in which the bonding position of —CH₂— to thebenzene ring is a meta position to Z². Among the examples described above, the compound in which the term a is 8 is more preferred. Further, the compound in which Z³ is a single bond is most preferred. However, these examples shall not restrict the range of the silicon compound of the present invention. For example, a compound in which R⁷ described above is a fluorine-containing group is preferably selected as well depending on the objects. Further, when e is 1, a method, in which a Grignard reagent is used, is adopted as a method for bonding a functional group to Si in a diorganosiloxy group. In this case, it is possible as well to obtain a compound in which Z² in Formula (2) or Formula (3) is a group other than Z³-C₂H₄.

Next, a production process for the silicon compound of the present invention shall be explained in details. The preferred raw material for the silicon compound of the present invention is Si—H functional cage type silsesquioxane represented by Formula (15). A derivative in which a diorganosiloxy group is bonded to the respective Si atoms constituting this Si—H functional cage type silsesquioxane is the preferred raw material as well.
(H—SiO_{3/2})₂ₙ (15)
The term n in Formula (15) is defined in the same manner as in n in Formula (1).

The silsesquioxane represented by Formula (15) is obtained in the form of a mixture of cage type silsesquioxanes represented by H₈Si₈O₁₂ and H₁₀Si₁₀O₁₅ respectively by a process described in, for example, Inorganic Chemistry, 30, 2707-(1991). Each of H₈Si₈O₁₂ and H₁₀Si₁₀O₁₅ can readily be isolated from the mixture thereof by extraction using hexane. Either can be used as the raw material for the silicon compound of the present invention. However, the silsesquioxane represented by H₈Si₈O₁₂ is readily isolated at a high purity, and therefore most preferred.

Present are a lot of documents regarding synthetic processes for a derivative in which a diorganosiloxy group is bonded to respective Si atoms constituting cage type silsesquioxane. For example, capable of being adopted is a process in which tetraethoxysilane is reacted with tetramethylammonium hydroxide in methanol to thereby synthesize octakis(tetramethylammonium)octasilsesquioxane and in which the compound thus obtained is then reacted with a diorganosilane derivative having an Si—Cl group under nitrogen atmosphere. Accordingly, if Si—H functional diorganochlorosilane is used as this diorganosilane derivative, a compound represented by Formula (16) is obtained. In addition thereto, it is possible as well, though a method for reacting has to be schemed, to introduce an Si—Cl functional diorganosiloxy group by using diorganodichlorosilane as the diorganosilane derivative having an Si—Cl group. However, considering that hydrosilylation can be used as a means for introducing a functional group into silsesquioxane and that a part of the compounds therefor is available in the form of a commercial product, a compound represented by Formula (16) is preferred: 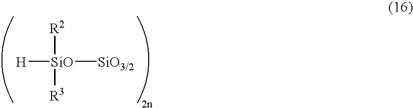
Symbols in Formula (16) are defined in the same manner as in these symbols in Formula (1).

That is, in producing the silicon compound of the present invention, it is preferred to use the compound (5) as the raw material and make use of hydrosilylation reaction. The compound having halogenated alkylphenyl can be produced only by hydrosilylation reaction. That is, it is the reaction of the compound (5) with the compound (6) in the presence of a transition metal catalyst. 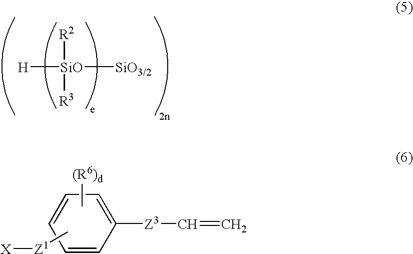
Symbols in Formula (5) each are the same as these symbols in Formula (1). Symbols and bonding positions of substituents in Formula (6) each are the same as the symbols and the bonding positions of the substituents in Formula (2).

The examples of the transition metal catalyst used are platinum, iridium, ruthenium, palladium, molybdenum, iron, cobalt, nickel and manganese. Among them, a platinum catalyst is more preferred. These catalysts can be used in the form of a homogeneous catalyst prepared by dissolving the components in a solvent and a solid catalyst prepared by carrying the components on carbon or silica. Further, they may be used in the form in which phosphine, amine and potassium acetate are allowed to coexist. A preferred use amount of the transition metal catalyst is 1×10⁻⁶ to 1×10⁻² mole in terms of a transition metal catalyst atom to one mole of Si—H group contained in the compound (5).

A use amount of the compound (6) is preferably 1 to 5 times in terms of an equivalent ratio to Si—H groups contained in the compound (5), if it is reacted with all the Si—H groups. Hydrosilylation reaction proceeds almost quantitatively, and therefore it is not meaningful so much to raise this equivalent ratio. However, the effect of shortening the reaction time can be expected, and therefore an adverse effect brought about by using a large amount of the compound (6) is only a cost efficiency. On the other hand, when a part of the Si—H groups is allowed to remain as they are unreacted, the equivalent ratio described above may be smaller than 1.

Then, the compound (7) is reacted, if necessary, with the unreacted Si—H groups contained in the product. When the compound (7) is reacted, the compound (7) may be added after finishing the reaction of the compound (5) with the compound (6) to further continue the hydrosilylation reaction, or after isolating a product obtained by reacting the compound (5) with the compound (6), the hydrosilylation reaction of this product with the compound (7) may be carried out. The compound (7) may be reacted in advance, and then the compound (5) may be reacted with the unreacted Si—H groups. The compound (5) and the compound (7) may be reacted at the same time. A compound represented by Formula (1-1) is obtained in the manner described above.
R⁷—CH═CH₂ (7)

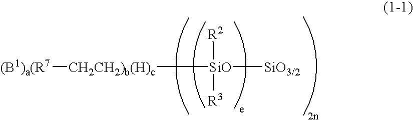

In these formulas, B¹ is a group represented by Formula (4) described above, and the other symbols mean what have been described above.

The preferred reacting temperature in the hydrosilylation reaction is not higher than a boiling point of the solvent used. The compound (6) is a compound having a polymerizable unsaturated bond. The preferred reacting temperature for preventing this compound from being spontaneously polymerized during the hydrosilylation reaction falls in a range of 20 to 80° C. A polymerization inhibitor such as a phenol derivative, a phenothiazine derivative or an N-nitrosophenylamine salt derivative may be used for the purpose of inhibiting this polymerization reaction. The most preferred polymerization inhibitor is 4-tert-butylpyrocatechol. A preferred use amount thereof is 1 to 100,000 ppm in terms of weight based on the reaction liquid. The use amount thereof falls in more preferred range of 100 to 20,000 ppm.

An organic solvent used for this hydrosilylation reaction shall not specifically be restricted as long as it readily dissolves the raw materials without reacting with them. The preferred organic solvent includes aliphatic hydrocarbons such as hexane and heptane, aromatic hydrocarbons such as toluene and xylene and cyclic ethers such as tetrahydrofuran and dioxane. Considering a solubility of the compound (6), toluene is most preferred. Alcohols such as 2-propanol may be added for the purpose of controlling an activity of the catalyst.

If a distillation method is applied in order to remove the unreacted raw material compounds and the solvent (hereinafter referred to as ┌impurities┘ in a lump), the liquid is maintained under a high temperature condition for long time, and therefore spontaneous polymerization of the unreacted compounds having a double bond is likely to be induced. Accordingly, a refining method carried out by reprecipitation operation is preferably used in order to efficiently remove impurities without damaging a purity of the compound (1-1). This refining method is carried out in the following manner. First, the reaction liquid is dissolved in a solvent dissolving both of the compound (1-1) and the impurities. In this case, a preferred concentration of the compound (1-1) is, roughly speaking, 1 to 15% by weight. Next, such solvent as not dissolving the compound (1-1) but dissolving the impurities, a so-called precipitant is added to precipitate only the compound (1-1). A preferred use amount of the precipitant is 20 to 50 times based on the weight of the solvent used for dissolving both of the compound (1-1) and the impurities. This use range is a rough standard, and as is the case with the foregoing concentration rage of the compound (1-1), a definite ground for restricting the use amounts in these ranges is not necessarily present.

The preferred solvent used for dissolving the compound (1-1) is a solvent having a large dissolving power and a relatively low boiling point. The preferred precipitant is a solvent which is compatible with the solvent for dissolving the compound (1-1) and does not dissolve the compound (1-1) at all and which dissolves only the impurities and has a relatively low boiling point. The example of the preferred precipitant is alcohols. The particularly preferred precipitant is methanol. A repeating frequency of the reprecipitation operation is advisably increased in order to raise the refining degree.

A column chromatography is preferred for further refining the compound (1-1) after removing the polymerizable unreacted products. A preferred adsorbent used in this case is silica gel and the like. A preferred developing solvent is hexane, cyclohexane, toluene, chloroform, ethyl acetate and acetone. More preferred developing solvent is a mixed solvent of ethyl acetate and hexane. A mixing ratio of the solvents shall not specifically be restricted, and it may be controlled so that a transfer rate (Rf value) of the specified substance into the developing solvent falls in a range of 0.1 to 0.7.

The silicon compound represented by Formula (1-2) can be obtained by reacting the compound (1-1) obtained at the hydrosilylation reaction step described above with a dithiocarbamic acid metal salt represented by Formula (9). 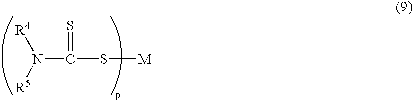
In Formula (9), R⁴ and R⁵ each are the same as these symbols in Formula (3), M is a metal element of the 1st or the 2nd group in the periodic table, and p is the same value as an atomic value of M. That is, Li, Na, K, Cu, Mg, Ca and Zn can be given as the specific examples of M, and among them, Na and K are preferred. 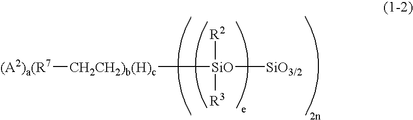
A² in this formula is a group represented by Formula (8), and the other symbols each are the same as these symbols in Formula (1-1).

The reaction of the compound (1-1) with the compound (9) is a quantitative nucleophilic displacement reaction, and side reactions do not take place. However, a preferred use amount of dithiocarbamate is 1 to 5 times in terms of an equivalent ratio based on a halogen content in the compound (1-1). More use of this salt makes it possible to shorten the reaction time. The reaction is usually carried out in an inert gas atmosphere such as nitrogen in a dried organic solvent which is inert to the raw materials. The examples of the organic solvent are lower alcohols such as methanol, cyclic ethers such as tetrahydrofuran and dioxane, and aromatic hydrocarbons such as toluene and xylene. The preferred examples of the organic solvent are tetrahydrofuran and methanol. The reacting temperature is 120° C. or lower, preferably 100° C. or lower considering the possibility that dithiocarbamate is thermally decomposed. The reacting time shall not specifically be restricted, and the targeted silicon compound can be obtained usually in 1 to 10 hours. Further, capable of being used, if necessary, for the reaction is a phase transfer catalyst such as benzyltrimethylammonium chloride, tetramethylammonium chloride, tetrabutylammonium bromide, trioctylammonium chloride, dioctylmethylammonium chloride, triethylamine or dimethylaniline.

The compound (1-2) contained in the reaction mixture is refined by a refining method carried out by the reprecipitation operation described above and/or a column chromatography. The reaction of the dithiocarbamate with the compound (1-1) and refining of the compound (1-2) have to be carried out under a fluorescent lump in which a UV ray is cut and in a draft in which a UV-cut film is applied. The compound (1-2) has dithiocarbamate which is a photosensitive group, and therefore it has to be stored in a light-shielded vessel charged with inert gas such as nitrogen and argon in a cold and dark place under non-aqueous environment.

The compound (1-2) can be obtained as well by a process in which the reacting step of a thiocarbamic acid metal salt with a halogenated alkyl group is carried out in advance. This production process is a process in which the compound (6) described above is first reacted with the compound (9) to prepare a compound represented by Formula (10): 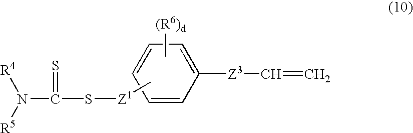
Symbols and bonding positions of substituents in Formula (10) each are the same as these symbols and the bonding positions of the substituents in Formula (8).

This reaction itself is fundamentally the same as the reaction of the compound (1-1) described above with the compound (9), and it can be carried out in the same manner as in the case of the above reaction. However, the same caution as in the reaction of the compound (5) with the compound (6) in the production process described above is required in terms of handling the compound having a polymerizable group. That is, the reaction temperature has to be controlled to a considerably low temperature of 20 to 80° C., and a polymerization inhibitor has to be used. Further, a UV ray has to be cut as much as possible not only in the reaction and the refining step but also in storing the product. Next, the compound (10) obtained in the step described above is combined with the compound (5) by hydrosilylation reaction in the presence of the transition metal catalyst to prepare the compound (1-2). This reaction can be carried out by reacting with the compound (7) at the same time or successively as is the case with the foregoing reaction of the compound (5) with the compound (6). However, the polymerizable compound (10) is used, and therefore strict measures for polymerization inhibition and cutting of a UV ray are required.

Next, a vinyl type monomer to which the compound (1) can be applied as a polymerization inhibitor shall be explained. This vinyl type monomer is a monomer having a polymerizable double bond. It may be a multifunctional monomer having two or more double bonds. The examples of a (meth)acrylic acid base monomer out of the monofunctional monomers having one polymerizable double bond are meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluyl (meth)acrylate, benzyl (meth)acrylate, 2-methoxyethyl (meth)acrylate, 3-methoxypropyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-(meth)acryloyloxyethylisocyanate, 2-aminoethyl (meth)acrylate, 2-(2-bromopropionyloxy)ethyl (meth)acrylate, 2-(2-bromoisobutylyloxy)ethyl (meth) acrylate, γ-(methacryloyloxypropyl)-trimethoxysilane, 3-(3,5,7,9,11,13,15-heptaethylpentacyclo[9.5.1.1^{3,9}.1^{5,15}.1^{7,13}]-octasiloxane-1-yl)propyl (meth)acrylate, 3-(3,5,7,9,11,13,15-heptaisobutyl-pentacyclo[9.5.1.1^{3.9}.1^{5,15}.1^{7,13}]octasiloxane-1-yl)propyl (meth)acrylate, 3-(3,5,7,9,11,13,15-heptaisooctylpentacyclo-[9.5.1.1^{3,9}.1^{5,15}.1^{7,13}9 -octasiloxane-1-yl)propyl (meth)acrylate, 3-(3,5,7,9,11,13,15-heptacyclopentylpentacyclo-[9.5.1.1^{3,9}.1^{5,15}.1^{7,13}]octasiloxane-1-yl)propyl (meth)acrylate, 3-(3,5,7,9,11,13,15-heptaphenylpentacyclo[9.5.1.1^{3,9}.1^{5,15}.1^{7,13}]-octasiloxane-1-yl)propyl (meth)acrylate, 3-[(3,5,7,9,11,13,15-heptaethylpentacyclo-[9.5.1.1^{3,9}.1^{5,15}.1^{7,13}]octasiloxane-1-yloxy)dimethylsilyl]propyl (meth)acrylate, 3-[(3,5,7,9,11,13,15-heptaisobutylpentacyclo-[9.5.1. 1^{3,9}.1^{5,15}.1^{7,13}]octasiloxane-1-yloxy)dimethylsilyl]propyl (meth)acrylate, 3-[(3,5,7,9,11,13,15-heptaisooctylpentacyclo-[9.5.1.1^{3,9}01^{5,15}01^{7,13}]octasiloxane-1-yloxy)dimethylsilyl]propyl (meth)acrylate, 3-[(3,5,7,9,11,13,15-heptacyclopentylpentacyclo-[9.5. 1.1^{3,9}.1^{5,15}.1^{7,13}]octasiloxane-1-yloxy)dimethylsilyl]propyl (meth)acrylate, 3-[(3,5,7,9,11,13,15-heptaphenylpentacyclo-[9.5.1. 1^{3,9}01^{5,15}01^{7,13}]octasiloxane-1-yloxy)dimethylsilyl]propyl (meth)acrylate, ethylene oxide adducts of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, trifluoromethyl (meth)acrylate, diperfluoromethylethyl (meth)acrylate, 2-perfluoromethyl-2-perfluoroethylethyl (meth)acrylate, 2-perfluorohexylethyl (meth)acrylate, 2-perfluorodecylethyl (meth)acrylate and 2-perfluorohexadecylethyl (meth)acrylate.

The examples of a styrene base monomer are styrene, vinyltoluene, α-methylstyrene, p-chlorostyrene, m-chlorostyrene, o-aminostyrene, p-styrenechlorosulfonic acid, styrenesulfonic acid and salts thereof, vinylphenylmethyl dithiocarbamate, 2-(2-bromopropionyloxy)styrene, 2-(2-bromoisobutyryloxy)styrene, 1-(4-vinylphenyl)-3,5,7,9,11,13,15-heptaethylpentacyclo-[9.5.1.1^{3,9}.1^{5,15}.1^{7,13}]octasiloxane, 1-(4-vinylphenyl)-3,5,7,9,11,13,15-heptaisobutylpentacyclo-[9.5.1.1^{3,9}.1^{5,15}.1^{7,13}]octasiloxane, 1-(4-vinylphenyl)-3,5,7,9,11,13,15-heptaisooctylpentacyclo-[9.5.1.1^{3,9}.1^{5,15}.1^{7, 13}]octasiloxane, 1-(4-vinylphenyl)-3,5,7,9,11,13,15-heptacyclopentylpentacyclo-[9.5.1.1^{3,9}.1^{5,15}.1^{7,13}]octasiloxane, 1-(4-vinylphenyl)-3,5,7,9,11,13,15-heptaphenylpentacyclo-[9.5.1.1^{3,9}.1^{5,15}.1^{7,13}]octasiloxane, 3-(3,5,7,9,11,13,15-heptaethylpentacyclo-[9.5.1.1^{3,9}.1^{5,15}.1^{7,13}]octasiloxane-1-yl)ethylstyrene, 3-(3,5,7,9,11,13,15-heptaisobutylpentacyclo-[9.5.1.1^{3,9}.1^{5,15}.1^{7,13}]octasiloxane-1-yl)ethylstyrene, 3-(3,5,7,9,11,13,15-heptaisooctylpentacyclo-[9.5.1.1^{3,9}.1^{5,15}.1^{7,13}]octasiloxane-1-yl)ethylstyrene, 3-(3,5,7,9,11,13,15-heptacyclopentylpentacyclo-[9.5.1.1^{3,9}.1^{5,15}.1^{7,13}]octasiloxane-1-yl)ethylstyrene, 3-(3,5,7,9,11,13,15-heptaphenylpentacyclo-[9.5.1.1^{3,9}.1^{5,15}.1^{7,13}]octasiloxane-1-yl)ethylstyrene, 3-[(3,5,7,9,11,13,15-heptaethylpentacyclo-[9.5.1. 1^{3,9}.1^{5,15}.1^{7,13}]octasiloxane-1-yloxy)dimethylsilyl]ethylstyrene, 3-[(3,5,7,9,11,13,15-heptaisobutylpentacyclo-[9.5.1.1^{3,9}.1^{5,15}.1^{7,13}]octasiloxane-1-yloxy)dimethylsilyl]ethylstyrene, 3-[(3,5,7,9,11,13,15-heptaisooctylpentacyclo-[9.5.1. 1^{3,9}.1^{5,15}.1^{7,13}]octasiloxane-1-yloxy)dimethylsilyl]ethylstyrene, 3-[(3,5,7,9,11,13,15-heptacyclopentylpentacyclo-[9.5. 1.1^{3,9}.1^{5,15}.1^{7,13}]octasiloxane-1-yloxy)dimethylsilyl]ethylstyrene and 3-[(3,5,7,9,11,13,15-heptaphenylpentacyclo-[9.5.1.1^{3,9}.1^{5,15}.1^{7,13}]octasiloxane-1-yloxy)dimethylsilyl]ethylstyrene.

The examples of the other monofunctional monomers are fluorine-containing vinyl monomers (perfluoroethylene, perfluoropropylene, vinylidene fluoride and the like), silicon-containing vinyl monomers (vinyltrimethoxysilane, vinyltriethoxysilane and the like), maleic anhydride, maleic acid, monoalkyl esters and dialkyl esters of maleic acid, fumaric acid, monoalkyl esters and dialkyl esters of fumaric acid, maleimide base monomers (maleimide, methylmaleimide, ethylmaleimide, propylmaleimide, butylmaleimide, hexylmaleimide, octylmaleimide, dodecylmaleimide, stearylmaleimide, phenylmaleimide and cyclohexylmaleimide), nitrile group-containing vinyl type monomers (acrylonitrile, methacrylonitrile and the like), amide group-containing vinyl type monomers (acrylamide, methacrylamide and the like), vinyl ester type monomers (vinyl acetate, vinyl propionate, vinyl pivalate, vinyl benzoate, vinyl cinnamate and the like), alkenyl group-containing monomers (ethylene, propylene and the like), conjugated diene base monomers (butadiene, isoprene and the like), halogenated vinyl (vinyl chloride and the like), halogenated vinylidene (vinylidene chloride and the like), halogenated allyl (allyl chloride and the like), allyl alcohol, vinylpyrrolidone, vinylpyridine, N-vinylcarbazole, methyl vinyl ketone and vinylisocyanate. Further, given as well are macromonomers which have one polymerizable double bond in a molecule and in which a principal chain is constituted from styrene, (meth)acrylate and siloxane.

The examples of monomers having two polymerizable double bonds in a molecule are di(meth)acrylate base monomers such as 1,3-butanediol di(meth)acrylate, 1,4-butanediol di(meth)acrylate, 1,6-hexanediol di(meth)acrylate, polyethylene glycol di(meth)acrylate, diethylene glycol di(meth)acrylate, neopentyl glycol di(meth)acrylate, triethylene glycol di(meth)acrylate, tripropylene glycol di(meth)acrylate, hydroxypivalic acid ester neopentyl glycol di(meth)acrylate, trimethylolpropane di(meth)acrylate, bis[(meth)acryloyloxyethoxy] bisphenol A, bis[(meth)acryloyloxyethoxy] tetrabromobisphenol A, bis[(meth)acryloxypolyethoxy] bisphenol A, 1,3-bis(hydroxyethyl)-5,5-dimethylhydantoin, 3-methylpentanediol di(meth)acrylate, di(meth)acrylates of hydroxypivalic acid ester neopentyl glycol derivatives, and in addition thereto, divinylbenzene. Further, given as well are macromonomers which have two polymerizable double bonds in a molecule and in which a principal chain is constituted from siloxane.

The examples of multifunctional monomers having three or more polymerizable double bonds in a molecule are trimethylolpropane tri(meth)acrylate, pentaerythritol tri(meth)acrylate, pentaerythritol tetra(meth)acrylate, dipentaerythritol monohydroxypenta(meth)acrylate, tris(2-hydroxyethylisocyanate)=tri(meth)acrylate, tris(diethylene glycol)trimelate=tri(meth)acrylate, 3,7,14-tris[(((meth)acryloyloxypropyl)-dimethylsiloxy)]-1,3,5,7,9,11,14-heptaethyltricyclo-[7.3.3.1^{5,11}]heptasiloxane, 3,7,14-tris[(((meth)acryloyloxypropyl)dimethylsiloxy)]-1,3,5,7,9,11,14-heptaisobutyltricyclo[7.3.3.1^{5,11}]-heptasiloxane, 3,7,14-tris[(((meth)acryloyloxypropyl)dimethylsiloxy)]-1,3,5,7,9,11,14-heptaisooctyltricyclo[7.3.3.1^{5,11}]heptasiloxane, 3,7,14-tris[(((meth)acryloyloxypropyl)-dimethylsiloxy)]-1,3,5,7,9,11,14-heptacyclopentyltricyclo[7.3.3.1^{5,11}]heptasiloxane, 3,7,14-tris[(((meth)acryloyloxypropyl)-dimethylsiloxy)]-1,3,5,7,9,11,14-heptaphenyltricyclo[7.3.3.1^{5,11}]heptasiloxane, octakis(3-(meth)acryloyloxypropyldimethylsiloxy)-octasilsesquioxane and octakis(3-(meth)acryloyloxypropyl)octasilsesquioxane. Further, given are macromonomers which have two or more polymerizable double bonds in a molecule and in which a principal chain is constituted from styrene, (meth)acrylate and siloxane.

These monomers may be used alone or a plurality thereof may be copolymerized. When copolymerized, they may be random-copolymerized or block-copolymerized. Any of anionic polymerization, cationic polymerization and radical polymerization can be adopted as a method for polymerizing these vinyl type monomers. “(Meth)acrylic acid” described above is a general term of acrylic acid and methacrylic acid, “(meth)acrylate” is a general term of acrylate and methacrylate, and “(meth)acryloyloxy” is a general term of acryloyloxy and methacryloyloxy.

Next, a method for subjecting a vinyl type monomer to atom transfer radical polymerization using the silicon compound having a halogenated alkylphenyl group represented by Formula (2) as an initiator and a transition metal complex as a catalyst shall be explained. The atom transfer radical polymerization in the present invention is one of living radical polymerizations, and it is a method for radically polymerizing a vinyl type monomer with an organic halide or a halogenated sulfonyl compound being used as an initiator. This method is disclosed in J. Am. Chem. Soc., 1995, 117, Macromolecules, 1995, 28, 7901 and Science, 1996, 272, 866.

A so-called reverse atom transfer radical polymerization method is included as well in the atom transfer radical polymerization method used in the present invention. The reverse atom transfer radical polymerization method is a method in which a general radical initiator such as peroxide is allowed to work on a high oxidation state observed when a normal atom transfer radical polymerization catalyst produces radical, for example, Cu (II) observed when Cu (I) is used as a catalyst and in which as a result thereof, the same equilibrium state as in atom transfer radical polymerization is produced (Macromolecules 1999, 32, 2872).

The preferred example of a transition metal complex used as a polymerizing catalyst is a metal complex in which the 7th, 8th, 9th, 10th or 11th group element in the periodic table is used as center metal. More preferred catalyst is a complex of zero-valent cupper, monovalent cupper, divalent ruthenium, divalent iron or divalent nickel. Among them, a complex of cupper is preferred. The examples of a monovalent cupper compound are cuprous chloride, cuprous bromide, cuprous iodide, cuprous cyanide, cuprous oxide and cuprous perchlorate. When using the copper compounds, 2,2′-bipyridine or derivatives thereof, 1,10-phenanthroline or derivatives thereof, polyamine (tetramethylethylenediamine, pentamethyldiethylenetriamine, hexamethyltris(2-aminoethyl)amine and the like) or polycyclic alkaloid such as sparteine is added as a ligand in order to enhance the catalyst activity. Further, a triphenylphosphine complex (RuCl₂(PPh₃)₃) of divalent ruthenium chloride is also suited as the catalyst. When the ruthenium compound is used as the catalyst, aluminum alkoxides are added as an activating agent. Further, a bistriphenylphosphine complex (FeCl₂(PPh₃)₂) of divalent iron, a bistriphenylphosphine complex (NiCl₂(PPh₃)₂) of divalent nickel and a bistributylphosphine complex (NiBr₂(PBu₃)₂) of divalent nickel are also suited as the catalyst.

A solvent may be used for the polymerization reaction. The examples of the solvent used are hydrocarbon base solvents (benzene, toluene and the like), ether base solvents (diethyl ether, tetrahydrofuran, diphenyl ether, anisole, dimethoxybenzene and the like), halogenated hydrocarbon base solvents (methylene chloride, chloroform, chlorobenzene and the like), ketone base solvents (acetone, methyl ethyl ketone, methyl isobutyl ketone and the like), alcohol base solvents (methanol, ethanol, propanol, isopropanol, n-butyl alcohol, tert-butyl alcohol and the like), nitrile base solvents (acetonitrile, propionitrile, benzonitrile and the like), ester base solvents (ethyl acetate, butyl acetate and the like), carbonate base solvents (ethylene carbonate, propylene carbonate and the like) and amide base solvents (N,N-dimethylformamide, N,N-dimethylacetamide and the like). They may be used alone or in combination two or more kinds thereof. The polymerization can be carried out as well in an emulsion system or a system in which a supercritical fluid CO₂ is used as a medium. The solvent which can be used shall not be restricted to these examples.

The atom transfer radical polymerization can be carried out under reduced pressure, atmospheric pressure or applied pressure according to the kind of the vinyl type monomer and the kind of the solvent. An organic metal complex used in combination is likely to be deactivated when brought into contact with oxygen, and it shall be difficult to carry out living radical polymerization in such case. Accordingly, it is important to carry out the polymerization usually under inert gas environment of nitrogen or argon, for example, under flowing of inert gas. Further, dissolved oxygen in the polymerization system has to be removed in advance under reduced pressure, and therefore it shall be possible to commence a polymerization step as it is under reduced pressure after finishing the step of removing dissolved oxygen.

A polymerization form of the atom transfer radical polymerization shall not specifically be restricted, and a conventional process, for example, bulk polymerization, solution polymerization, suspension polymerization, emulsion polymerization or bulk-suspension polymerization can be adopted. The polymerization temperature falls in a range of 0 to 200° C., and the preferred polymerization temperature falls in a range of a room temperature to 150° C.

Next, controlling of the structure of the compound (11) shall be explained. This compound is produced by the atom transfer radical polymerization method with the compound (1-1) being used as the initiator and the transition metal complex being used as the catalyst. 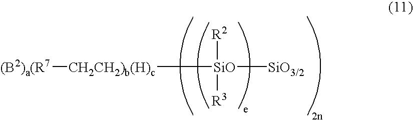
B² in this formula is a group represented by the following Formula (4-1), and the other symbols each are the same as these symbols in Formula (1-1). 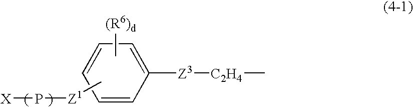
P in this formula is a vinyl polymer, and the other symbols and the bonding positions of the substituents each are the same as these symbols and the bonding positions in Formula (4).

Suitable selection of the kind of the vinyl type monomer used makes it possible to control the structure of the compound (11) produced. For example, if the monomer is homopolymerized, silsesquioxane to which the homopolymer has been bonded is obtained. If the plural monomers are added at the same time and polymerized, silsesquioxane to which the random copolymer has been bonded is obtained. If used is a method in which the monomers are successively added, for example, a method in which the second monomer is added after finishing the polymerization of the first monomer to complete the polymerization, silsesquioxane to which the block copolymer has been bonded is obtained. Repeating of this polymerization by stages using plural monomers makes it possible to obtain silsesquioxane to which the multiblock copolymer has been bonded. A silicon compound can positively be introduced by jointly using, for example, trialkoxysilane, polydimethylsiloxane and silsesquioxane each having a (meth)acryl group and a styryl group as a polymerizable functional group. After copolymerized with a vinyl type monomer having an initiating group which does not take part in the atom transfer radical polymerization, for example, vinylphenylmethyl dithiocarbamate, the vinyl type monomer is further polymerized in the other polymerizing mode (for example, photo initiator-transfer agent-terminator polymerization) with the resulting polymer being used as an initiator, whereby a graft copolymer can be formed. A cross-linked polymer having a three-dimensional network structure can be prepared as well by allowing, if necessary, a multifunctional monomer to coexist.

A refining method of the compound (11) shall be explained. The transition metal complex which is the polymerizing catalyst remains in the compound (11), and therefore problems such as coloring of the polymer, influence on the physical properties and environmental safety are caused in a certain case. Accordingly, this catalyst residue has to be removed in finishing the polymerization reaction. The catalyst residue can be removed by adsorbing treatment using activated carbon. An inorganic adsorbent such as an acid, basic or chelate type ion exchange resin, zeolite, silica gel and alumina can be used as the other adsorbent. The inorganic adsorbent has a character of a solid acid, a solid base or neutrality, and the particle has a porous structure, so that it has a very high adsorbing ability. It is also one of the characteristics of the inorganic adsorbent that it can be used in a wide temperature range extending from a low temperature to a high temperature. The representative examples of the inorganic adsorbent are silicon dioxide, magnesium oxide, silica gel, silica•alumina, aluminum silicate, activated alumina, clay base adsorbents such as acid clay and activated clay, zeolite base adsorbents (hydrous aluminosilicate minerals such as sodium aluminum silicate), dosonites compounds and hydrotalcites compounds.

Zeolite includes a natural product and a synthetic product, and both can be used. The kinds such as a crystal form, an amorphous form, a noncrystal form, a glass form, a synthetic product and a natural product are known for silicon dioxide, and any kind can be used in the present invention as long as it has a powder form. Silicon dioxide includes silicic acid formed from a clay mineral obtained by subjecting activated clay to acid treatment and synthetic silicic acid such as Carplex BS304, Carplex BS304F, Carplex #67 and Carplex #80 (all manufactured by Shionogi Seiyaku Co., Ltd.), but it shall not be restricted to them. Aluminum silicate is obtained by substituting a part of silicon in silicic acid with aluminum, and pumice, fly ash, kaoline, bentonite, activated clay and diatomaceous earth are known. Among them, synthetic aluminum silicate has a large specific surface area and a high adsorbing ability. Synthetic aluminum silicate includes Kyoward 700 series (manufactured by Kyowa Chemical Co., Ltd.), but it shall not be restricted thereto. The hydrotalcites compound is composed of hydrate hydroxides and carbonates of aluminum and magnesium. The synthetic product includes Kyoward 500 series and Kyoward 1000 series (all manufactured by Kyowa Chemical Co., Ltd.), but it shall not be restricted thereto.

The acid adsorbent and the basic adsorbent are preferably used in combination with activated carbon. The examples of the acid adsorbent are acid clay, activated clay and aluminum silicate. The examples of the basic adsorbent are activated alumina, the zeolite base adsorbents and the hydrotalcites compounds each described above. These adsorbents may be used alone or in a mixture of two or more kinds thereof. The compound (11) produced by the atom transfer radical polymerization can be refined by bringing into contact with activated alumina. A commercial product available from Aldrich Co., Ltd. can be used as activated alumina. When adsorbing treatment is carried out by using activated alumina in combination with the other adsorbent, the adsorbents can be mixed and brought into contact with the compound, and they may be brought into contact at the separate steps respectively. When brought into contact with the adsorbent, the reaction liquid may be used as it is or may be diluted with a solvent. Usual solvents may be used as the diluent solvent. A temperature for treating with the adsorbent shall not specifically be restricted, and it is usually 0 to 200° C., preferably room temperature to 180° C. A use amount of the absorbent falls in a range of 0.1 to 500% by weight based on the weight of the compound (11). Considering the economical efficiency and the operability, more preferred range is 0.5 to 10% by weight.

A batch system method in which stirring-mixing and solid-liquid separation are carried out by batch operation can be used for solid-liquid contact of the absorbent and the polymer liquid. In addition thereto, capable of being used is a method of a continuous system such as a fixed layer system in which the polymer liquid is passed through a vessel charged with the adsorbent, a moving layer system in which the liquid is passed through a moving layer of the adsorbent and a fluidized layer system in which the adsorbent is fluidized by a solvent to carry out adsorption. Further, mixing and dispersing operation carried out by stirring can be combined, if necessary, with operation for elevating the dispersing efficiency, such as shaking of the vessel and use of a supersonic wave. After the polymer liquid is brought into contact with the absorbent, the absorbent is removed by filtering, centrifugal separation and settling separation, and washing treatment is carried out if necessary to obtain the refined polymer liquid. Treatment by the absorbent is carried out for the compound (11) which is the final product, and it may be carried out for an intermediate product used for producing this polymer. For example, in the respective polymerizing steps of the block copolymer obtained by the atom transfer radical polymerization, this polymer can be isolated and subjected to adsorbing treatment. The compound (11) subjected to treatment by the adsorbent may be deposited in a poor solvent or separated by distilling off volatile components such as the solvent under reduced pressure.

The analytical methods of a molecular weight and a molecular weight distribution of the compound (11) produced shall be explained. Usually, a molecular weight of a vinyl based polymer can be measured by gel permeation chromatography (GPC) . However, the compound (11) belongs to a vinyl based polymer in which silsesquioxane is a starting point, that is, a branched high polymer compound. Accordingly, if the structure of the compound (11) is maintained, it is difficult to use a calibration curve using a linear polymer such as polystyrene and poly(methyl methacrylate) as a standard sample in determining a molecular weight thereof. However, the compound (11) comprises silsesquioxane in a central part thereof, and therefore it can readily be decomposed under an acid condition or a basic condition. Accordingly, it is advisable to cut off a vinyl based polymer which is a branched chain from silsesquioxane and then measure the molecular weight thereof. Hydrofluoric acid is preferably used for decomposing the compound (11) if decomposed under an acid condition, and potassium hydroxide is preferably used for decomposing it if decomposed under a basic condition. The compound (11) can be decomposed in either of a homogeneous system and an emulsion system, and it is preferably decomposed in a homogeneous system. That is, the compound (11) can be decomposed in a mixed system of an organic solvent (tetrahydrofuran, acetonitrile and the like) which can dissolve the compound (11) and hydrofluoric acid. The compound (11) can readily be decomposed as well in a system of a toluene-potassium hydroxide aqueous solution by using a phase transfer catalyst in combination. The vinyl based polymer cut off by these methods is measured by GPC, whereby a molecular weight of the vinyl based polymer contained in the compound (11) , a so-called a molecular weight of the graft chain can be determined. It is possible as well to determine a molecular weight of the compound (11) itself by using a universal calibration curve obtained from the viscosity and the GPC data. A molecular weight of the compound (11) itself can be determined by a light scattering method.

A preferred molecular weight of the grafted chain falls in a range of 500 to 1,000,000 in terms of a number average molecular weight. More preferred range is 1,000 to 100,000. However, the upper limit value and the lower limit value of this range do not necessarily have a specific meaning. A molecular weight distribution of the grafted chain falls preferably in a range of 1.01 to 2.0 in terms of a dispersion degree.

The molecular weight of the grafted chain can be controlled by a proportion of the vinyl type monomer to a halogenated alkylphenyl group which is an initiator group. That is, the molecular weight of the grafted chain can be predicted from a mole ratio of the vinyl type monomer/halogenated alkylphenyl group and a consumption rate of the monomer by means of the following calculation equation:
Mn=(consumption rate (mole %) of monomer/100)×MW_{M}×(mole ratio of vinyl type monomer/halogenated alkylphenyl group)+MW_{I}
In this calculation equation, Mn is a number average molecular weight, MW_{M} is a molecular weight of the monomer, and MWI is a molecular weight of the halogenated alkylphenyl group.

When obtaining a polymer having the number average molecular weight range described above, a mole ratio of the vinyl type monomer/the halogenated alkylphenyl group can be selected from a range of about 2/1 to about 40000/1, preferably about 10/1 to about 5000/1. This molecular weight can be controlled as well by changing the polymerizing time.

Next, a method for photopolymerizing the vinyl type monomer with the compound having the dithiocarbamate group represented by Formula (3) being used as the initiator, a so-called photo-iniferter polymerizing method shall be explained. It is well known that in this photo-iniferter polymerization, the dithiocarbamate group is radically dissociated by light and has an excellent polymerization-initiating ability and a sensitizing ability. It is well known as well that photopolymerization in this case is radical polymerization and that it is like living polymerization. These informations are disclosed in, for example, Polymer Bulletin, 11 (1984), 135- and Macromolecules, 19 (1986), 287-. Accordingly, the silicon compound of the present invention having a dithiocarbamate group can continue to maintain a polymerization-initiating ability as long as irradiated with light, and it has a photopolymerization-initiating ability to all radically polymerizable monomers.

It is known as well that a dithiocarbamate group has the respective functions of a photopolymerization initiator, a chain transfer agent and a photopolymerization terminator all together in photopolymerization, and a reaction mechanism thereof has already become clear. The silicon compound of the present invention having a dithiocarbamate group is dissociated into a radical on an alkylphenyl group bonded to the silicon compound and a dithiocarbamate radical by irradiating with light. Then, the radical on the alkylphenyl group takes part in initiation of the reaction, and the dithiocarbamate radical takes part in termination of the reaction. When irradiation with light is stopped or the monomer is exhausted, the dithiocarbamate radical is added to the growing end as a terminator to form again a dithiocarbamate group. Accordingly, the polymer thus formed can also be used as a polymer photoinitiator having a photopolymerization-initiating ability. The silicon compound of the present invention having a dithiocarbamate group can initiate photopolymerization of a vinyl type monomer coexisting therewith by being decomposd by irradiating with a UV ray having a wavelength of 250 to 500 nm, preferably 300 to 400 nm having energy required for radically dissociating the dithiocarbamate group.

The form of carrying out the polymerization reaction can suitably be selected from bulk polymerization, solution polymerization, suspension polymerization, emulsion polymerization and bulk-suspension polymerization. A solvent used when producing by solution polymerization is preferably a solvent which has a small chain transfer constant and which can dissolve the vinyl type monomer and the polymer thereof. The examples of such preferred solvent are benzene, toluene, xylene, ethylbenzene, acetone, methyl ethyl ketone, methyl isobutyl ketone, ethyl acetate, methyl cellosolve, ethyl cellosolve, dimethylformamide, isopropyl alcohol, butanol, hexane and heptane. A solvent having no characteristic absorption in a UV ray area of 250 to 500 nm is rather preferred. The polymerizing temperature falls in a range of 0 to 200° C., preferably a room temperature to 150° C., but it shall not specifically be restricted.

The photo initiator-transfer agent-terminator polymerization can be carried out under reduced pressure, atmospheric pressure or applied pressure according to the kind of the vinyl type monomer and the kind of the solvent. It is important to carry out the polymerization usually under inert gas environment of nitrogen or argon, for example, under flowing of inert gas. Dissolved oxygen in the polymerization system has to be removed in advance under reduced pressure, and therefore it shall be possible to commence a polymerization step as it is under reduced pressure after finishing the step of removing dissolved oxygen.

Next, controlling of the structure of the compound (12) shall be explained. This compound is produced with the compound (1-2) being used as an initiator by a photopolymerization method. 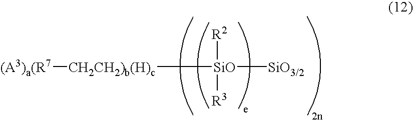
A³ in this formula is a group represented by the following Formula (8-1), and the other symbols each are the same as these symbols in Formula (1-2): 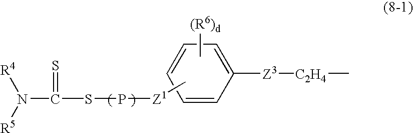
P in this formula is a vinyl polymer, and the other symbols and the bonding positions of the substituents each are the same as these symbols and the bonding positions in Formula (8).

The structure of the compound (12) can be controlled by the same method as in obtaining the compound (11) by the atom transfer radical polymerization method. After copolymerized with a vinyl type monomer having an initiating group which does not take part in the photo initiator-transfer agent-terminator polymerization, the vinyl type monomer is further polymerized in the other polymerizing mode (for example, atom transfer radical polymerization method) with the resulting polymer being used as an initiator, whereby a graft copolymer can be formed. The examples of the vinyl type monomer having an initiating group which does not take part in the photo initiator-transfer agent- terminator polymerization are 2-(2-bromopropionyloxy)ethyl (meth)acrylate, 2-(2-bromoisobutyryloxy)ethyl (meth)acrylate, p-chloromethylstyrene, 2-(2-bromopropionyloxy)styrene and 2-(2-bromoisobutyryloxy)styrene.

After finishing the photo initiator-transfer agent-terminator polymerization, the end dithiocarbamate group thereof is treated, whereby the compound (12) can be deactivated against a UV ray. The examples of a deactivating method are a method in which the compound (12) is treated in an acid solution or a basic solution, a method in which the compound (12) is treated at a high temperature of 250° C. or higher for several minutes, a method in which the compound (12) is irradiated with an electromagnetic ray of high energy having a wavelength of 220 nm or less, a method in which a monomer having a UV ray-absorbing group is added and then photopolymerized and a method in which a UV ray-absorbing agent is merely added. The end dithiocarbamate group can be substituted by adding a reagent having a large chain transfer constant (thiol derivatives, thiuram, xanthates and nitroxides) while irradiating the compound (12) obtained with a UV ray.

A method for isolating and refining the compound (12) shall be explained. This compound is isolated and refined by efficiently removing the unreacted vinyl type monomer. Various methods are available, and a refining method by the reprecipitating operation described above is preferred. This method makes it possible to precipitate only the compound (12) in a poor solvent and readily separate the polymer from the unreacted monomer by filtering operation. The polymer may be isolated by distilling off volatile components such as the solvent and the unreacted monomer under a condition of reduced pressure.

A preferred solvent for dissolving the compound (12) is a solvent having a large dissolving power and a relatively low boiling point. A preferred precipitant is a solvent which is compatible with the solvent for the compound (12) and does not dissolve at all the compound (12) and which dissolves only impurities or the unreacted monomer and has a relatively low boiling point. The examples of the preferred precipitant are lower alcohols and aliphatic hydrocarbons. The particularly preferred precipitant is methanol or hexane. It is advisable to increase the repeating frequency of the reprecipitating operation in order to further raise the refining degree.

A molecular weight and a molecular weight distribution of the compound (12) can be analyzed by the same method as explained in the compound (11). The vinyl based polymer bonded to silsesquioxane, a so-called grafted chain has a number average molecular weight falling in a range of 500 to 1,000,000. More preferred range is 1,000 to 100,000. However, the upper limit value and the lower limit value of this range do not necessarily have a specific meaning. A molecular weight distribution of the grafted chain falls preferably in a range of 1.01 to 3.0 in terms of a dispersion degree. It is possible as well to determine a molecular weight of the compound (12) itself by using a universal calibration curve obtained from the viscosity and the GPC data. A molecular weight of the compound (12) itself can be determined by a light scattering method. A molecular weight of the grafted chain in the compound (12) can be controlled in the same manner as in the compound (11). In this case, the target to be considered is changed merely from a halogenated alkylphenyl group in the compound (1-1) to a dithiocarbamate group in the compound (1-2).

### BEST EMBODIMENT FOR CARRYING OUT THE INVENTION

The present invention shall be explained below in details with reference to examples, but the present invention shall not be restricted to these examples.

### EXAMPLE 1

A 500 ml glass flask equipped with a stirrer, a reflux- condenser, a thermometer and a dropping funnel was charged with anhydrous ferric chloride (III) (29.5 g), methanol (19.0 g), 12N hydrochloric acid (14.2 g), toluene (26.2 g) and hexane (134.3 g). A mixture of trichlorosilane (15.8 g) and hexane (50.2 g) was slowly dropwise added thereto through the dropping funnel at a rate of 13.2 g/h at a room temperature while stirring in a nitrogen gas atmosphere. After finishing dropwise adding, the solution was stirred at a room temperature for 45 minutes, and then an upper organic layer was recovered. Then, calcium chloride (5.30 g) and potassium carbonate (7.66 g) were added to the organic layer and stirred for a night. The salts were removed by filtering, and the resulting filtrate was concentrated by means of a rotary evaporator, whereby a solid component (hereinafter referred to as a product 1) deposited at the first step was recovered by filtering. The filtrate was further concentrated and then cooled in a refrigerator to recover a solid component (hereinafter referred to as a product 2) deposited at the second step. Then, the solvent was removed at a room temperature in 3 hours under a reduced pressure of 1.3×10² Pa to obtain the target product 1 (0.83 g, yield: 13.6%) and the product 2 (0.38 g, yield: 6.2%).

¹H-NMR of the product 1 and the product 2 thus obtained was measured to result in confirming only a resonance line δ=4.23 ppm, ¹J_{SiH}=340 Hz, (TMS standard: δ=0.0 ppm)) based on an Si—H group of cage type silsesquioxane represented by H₈Si₈O₁₂ in the product 1. Further, a resonance line (δ=4.27 ppm, ¹J_{SiH}=334 Hz, (TMS standard: δ=0.0 ppm)) based on an Si—H group showing the presence of cage type silsesquioxane represented by H₁₀Si₁₀O₁₅ in addition to a resonance line based on the Si—H group described above was confirmed in the product 2. Further, ²⁹Si-NMR of the product 1 and the product 2 was measured to result in confirming only a resonance line (δ=−84.9 ppm, ¹J_{SiH}=340 Hz, (TMS standard: δ=0.0 ppm)) based on a T³ structure (structure in which three oxygens (O) are bonded to one trifunctional Si) of H₈Si₈O₁₂ in the product 1. Further, a resonance line (δ=−86.6 ppm, ¹J_{SiH}=335 Hz, (TMS standard: δ=0.0 ppm)) based on a T³ structure showing the presence of H₁₀Si₁₀O₁₅ in addition to a resonance line based on the T³ structure describe above was confirmed in the product 2. IR of the product 1 was measured to result in observing absorption (ν=2270 cm⁻¹) based on Si—H and absorption (ν=1000 to 1300 cm⁻¹) based on an Si—O—Si skeleton. It was found from the results described above that the product 1 obtained in the present example is a purified product of H₈Si₈O₁₂ and that the product 2 is a mixture of H₈Si₈O₁₂ and H₁₀Si₁₀O₁₅.

### EXAMPLE 2

A 500 ml glass flask equipped with a stirrer, a reflux condenser, a thermometer and a dropping funnel was charged with H₈Si₈O₁₂ (product 1) (0.4 g), chloromethylstyrene (2.5 g), TBC (4.5 mg) and toluene (8.0 g). The flask was heated up to 60° C. on an oil bath while stirring in a nitrogen atmosphere. Then, 53 μl of a platinum catalyst (Carsted catalyst: platinum-divinyltetramethyldisiloxane complex xylene solution, Pt content: 3% by weight) was introduced thereinto by means of a syringe to carry out hydrosilylation reaction. The reaction was traced by means of IR to result in confirming disappearance of absorption (ν=2270 cm⁻¹) based on Si—H after 3 hours passed, and it was regarded as a reaction end point. A 200 ml glass beaker was charged with 150 g of methanol, and the reaction liquid described above was slowly dropwise added thereto while stirring and then left standing still for a night. Thereafter, the solvent was removed by decantation, and the precipitate thus obtained was washed twice with methanol. This precipitate was dissolved again in tetrahydrofuran to subject the solution to pressure filtration, and then the solvent was removed by means of a rotary evaporator. The precipitate thus obtained was refined and separated by means of a column chromatography to obtain a translucent viscous liquid (0.78 g, yield: 49%). It was confirmed from the results of IR and NMR shown below that this compound was octakis((chloromethyl)phenylethyl)-octasilsesquioxane having a cage type structure.

IR: ν=1170-1000 (Si—O—Si), 710 (CH₂—Cl) cm⁻¹

¹H-NMR (CDCl₃, TMS standard: δ=0.0 ppm): δ=7.0 to 7.4 (—C₆H₄—), 4.4 to 4.7 (—C₆H₄—[CH₂]—Cl) , 2.5 to 2.8 (—Si—CH₂—[CH₂]—C₆H₄—), 2.3 to 2.5 (—Si—[CH]—CH₃—C₆H₄—), 1.4 to 1.5 (—Si—CH—[CH₃]—C₆H₄—), 0.8 to 1.1 (—Si—[CH₂]—CH₂C₆H₄—) ppm

### EXAMPLE 3

A 100 ml glass flask equipped with a stirrer, a product sampling tube and a thermometer was charged with octakis-((chloromethyl)phenylethyl)-octasilsesquioxane (0.42 g) obtained in Example 2, sodium N,N-diethyldithiocarbamate trihydrate (0.54 g) and tetrahydrofuran (30 ml) under a dry nitrogen gas atmosphere, and they were reacted while stirring. The reaction proceeded while generating heat, and sodium chloride was precipitated. The reaction was traced by means of IR to result in confirming disappearance of absorption (ν=710 (CH₂—Cl) cm⁻¹) based on a chloromethyl group after 5 hours passed. After finishing the reaction, an excess amount of water was added to the reaction liquid, and the organic layer was extracted with toluene. Then, the organic layer was separated and recovered, and the solvent was removed by means of a rotary evaporator. The recovered substance thus obtained was dissolved again in tetrahydrofuran to subject the solution to pressure filtration, and then the solvent was removed by means of a rotary evaporator to obtain a pale yellow viscous liquid (0.59 g, yield: 89.4%). This viscous liquid was refined by means of a column chromatography. As a result of measuring GPC before and after the reaction, a GPC peak based on octakis((chloromethyl)phenylethyl)-octasilsesquioxane was clearly shifted to a higher molecular weight side. All GPC peaks showed single peaks respectively before and after the reaction, and no change was observed on the molecular weight distribution. It was confirmed from the results of IR and NMR shown below that this compound was octakis((N,N-diethyldithiocarbamoylmethyl)phenylethyl)-octasilsesquioxane having a cage type structure.

IR: ν=930 (C—S), 1200 (C—S), 1300 ([C—N]—C═S), 1480 ([N—C]═S) cm⁻¹

¹H-NMR (CDCl₃): δ=7.0 to 7.4 (—C₆H₄—), 4.3 to 4.6 (—C₆H₄—[CH₂]—S), 3.9 to 4.1, 3.6 to 3.8 (—N([CH₂]CH₃)₂), 2.6 to 2.8 (—Si—CH₂—[CH₂]—C₆H₄—), 2.2 to 2.4 (—Si—[CH]—CH₃—C₆H₄—), 1.3 to 1.5 (—Si—CH—[CH₃]—C₆H₄—), 1.1 to 1.3 (—Si—CH₂—N(CH₂[CH₃])₂), 0.8 to 1.1 (—Si—[CH₂]—CH₂—C₆H₄—) ppm

### EXAMPLE 4

A 100 ml glass flask equipped with a stirrer, a reflux condenser, a thermometer and a dropping funnel was charged with octakis(dimethylsiloxy)-octasilsesquioxane ((H—(CH₃)₂SiO)₈Si₈O₁₂) (3.0 g: 0.0236 g equivalent in terms of Si—H), chloromethylstyrene (4.4 g: 0.288 mole), 4-tert-butylpyrocatechol (10 mg) and toluene (7.5 g). The flask was heated up to 60° C. on an oil bath while stirring under a nitrogen atmosphere. Then, the platinum catalyst (25.6 μl) described above was added thereto through a syringe to carry out hydrosilylation reaction. The reaction was traced by means of IR to result in confirming disappearance of absorption (ν=2270 cm⁻¹) based on Si—H after 9 hours passed, and it was regarded as a reaction end point. A 1000 ml glass beaker was charged with 450 g of methanol, and the reaction liquid described above was slowly dropwise added thereto while stirring and then left standing still for a night. Thereafter, the solvent was removed by decantation, and the precipitate was washed twice with methanol. The precipitate was recovered and then dissolved again in tetrahydrofuran to subject the solution to pressure filtration, and then the solvent was removed by means of a rotary evaporator to obtain 6.1 g of a translucent viscous liquid (yield: 92%) . The viscous liquid thus obtained was refined and separated by means of a column chromatography to obtain the target product. It was confirmed from the results of IR and NMR shown below that this compound was octakis(((chloromethyl)phenylethyl)-dimethylsiloxy)octasilsesquioxane having a cage type structure.

IR: ν=1267, 710 (C—Cl), 1170-1000 (Si—O—Si) cm⁻¹

¹H-NMR (CDCl₃, CDCl₃ standard: δ=7.3 ppm): δ=7.0 to 7.4 (—C₆H₄—), 4.4 to 4.7 (—C₆H₄—[CH₂]—Cl), 2.5 to 2.8 (—Si—CH₂—[CH₂]—C₆H₄—) , 2.2 to 2.4 (—Si—[CH]—CH₃—C₆H₄—) , 1.3 to 1.5 (—Si—CH—[CH₃]—C₆H₄—) , 0.9 to 1.0 (—Si—[CH₂]—CH₂—C₆H₄—), 0.0 to 0.3 ((—Si—[CH₃])₂—) ppm

### EXAMPLE 5

A 100 ml glass flask equipped with a stirrer, a product sampling tube and a thermometer was charged with octakis(((chloromethyl)phenylethyl)dimethylsiloxy)-octasilsesquioxane (2.0 g) obtained in Example 4, sodium N,N-diethyldithiocarbamate•trihydrate (1.86 g) and tetrahydrofuran (50 ml) under a dry nitrogen gas atmosphere, and they were reacted while stirring. The reaction proceeded while generating heat, and sodium chloride was precipitated. The reaction was traced by means of IR to result in confirming disappearance of absorption (ν=710 (CH₂—Cl)cm⁻¹) based on a chloromethyl group after 5 hours passed. After finishing the reaction, an excess amount of water was added to the reaction liquid, and the organic layer was extracted with diethyl ether. Then, the organic layer was separated and recovered, and the solvent was removed by means of a rotary evaporator. The recovered substance thus obtained was dissolved again in tetrahydrofuran to subject the solution to pressure filtration, and then the solvent was removed by means of a rotary evaporator to obtain a pale yellow viscous liquid (2.52 g, yield: 90%) . This viscous liquid was refined by means of a column chromatography. As a result of measuring GPC before and after the reaction, a GPC peak based on octakis(((chloromethyl)phenylethyl)dimethylsiloxy)-octasilsesquioxane was clearly shifted to a higher molecular weight side. All GPC peaks showed single peaks respectively before and after the reaction, and no change was observed on the molecular weight distribution.

It was confirmed from the results of IR and NMR shown below that this compound was octakis(((N,N-diethyldithiocarbamoylmethyl)phenylethyl)dimethylsiloxy)-octasilsesquioxane having a cage type structure.

IR: ν=930 (C—S), 1200 (C—S), 1300 ([C—N]—C═S), 1480 ([N—C]═S) cm⁻¹

¹H-NMR (CDCl₃): δ=7.0 to 7.4 (—C₆H₄—), 4.4 to 4.6 (—C₆H₄—[CH₂]—S), 3.9 to 4.1, 3.6 to 3.8 (—N([CH₂]CH₃)₂), 2.6 to 2.8 (—Si—CH₂—[CH₂]—C₆H₄—), 2.2 to 2.3 (—Si—[CH]—CH₃—C₆H₄—), 1.3 to 1.4 (—Si—CH—[CH₃]—C₆H₄—), 1.1 to 1.3 (—Si—CH₂—N(CH₂[CH₃])₂), 0.8 to 1.1 (—Si—[CH₂]—CH₂—C₆H₄—), 0.0 to 0.3 ((—Si—[CH₃])₂—) ppm

### EXAMPLE 6

<Preparation of Polymerizing Solution (A)>

A 200 ml Schrenk tube equipped with a stirrer was charged with the silicon compound. (0.2 g) obtained in Example 3, methyl methacrylate (15.1 ml), toluene (32.7 ml) and decane (2.5 ml) under a dry nitrogen gas atmosphere in a draft in which a UV ray was cut, and the solution was sufficiently stirred at a room temperature to prepare a polymerizing solution (A).

<Polymerization>

The polymerizing solution (A) (3 ml) was sampled by means of a glass-made syringe under a dry nitrogen gas atmosphere and introduced into a 4 ml glass ampul, and then it was subjected to freeze vacuum deaeration (pressure: 1×10⁻² Pa) by means of a high vacuum device equipped with a diffusion pump and sealed in a vacuum state by means of a hand burner. The sealed ampul was set in a rotary photopolymerizing apparatus (400 W extra-high pressure mercury lamp: UVL-400HA, manufactured by Riko Kagaku Sangyo Co., Ltd.), and photopolymerization was carried out to obtain a pale yellow viscous polymer solution. The polymerization conditions thereof were a light source distance: 150 mm, a UV ray illuminance (wavelength: 365 nm): 4.7 mW/cm², a rotating speed: 10 rpm and polymerizing time: 30 minutes. This polymer solution was subjected to reprecipitation refining with hexane (100 ml), and then the precipitate was recovered by suction filtration. The precipitate was dried at 80° C. for 3 hours in a vacuum dryer to obtain 0.13 g of a polymer (a).

<Molecular Weight Measurement of Graft Chain>

A mixed solution of hydrofluoric acid (0.17 ml) and acetonitrile (0.83 ml) was prepared. The polymer (a) (15 mg) was dissolved in this mixed solution and stirred at a room temperature for 48 hours. Then, the solution was dried at 80° C. for 3 hours in a vacuum dryer to recover the polymer. The polymer recovered was subjected to GPC measurement, and the result thereof is shown in Table 26. The measurement was carried out on the following conditions.
Apparatus: JASCO GULLIVER 1500 (intelligent differential refractometer RI-1530) manufactured by Nippon Bunko Co., Ltd.
Solvent: tetrahydrofuran
Flow velocity: 1 ml/min
Column temperature: 40° C.
Column used: Shodex KF-G (GUARDCOLUMN+Shodex KF-804L (excluded critical molecular weight (polystyrene): 400,000)×2 columns, manufactured by Showa Denko Co., Ltd.
Standard sample for calibration curve: poly(methyl methacrylate); Shodex STANDARD M-75
   <Thermal analysis>

A glass transition temperature and a thermal decomposition temperature of the polymer (A) were determined, and the results thereof are shown in Table 26. The measurements were carried out on the following conditions.

Glass transition temperature: differential scanning type calorimeter DSC7 manufactured by Perkin Elmer Co., Ltd. was used. The programming rate: 10° C./min and the measuring temperature range: 10 to 180° C. Thermal decomposition temperature: thermogravimetric apparatus TGA7 manufactured by Perkin Elmer Co., Ltd. was used. The programming rate: 20° C./min and the measuring temperature range: 50 to 800° C.

### EXAMPLE 7

<Polymerization>

Photopolymerization was carried out in the same manner as in Example 6 to obtain 0.21 g of a polymer (b), except that the polymerizing time was changed to 60 minutes.

<Molecular Weight Measurement of Graft Chain>

A molecular weight of a graft chain in the polymer (b) was measured in the same manner as in the polymer (a). The result thereof is shown in Table 26.

<Thermal Analysis>

The polymer (b) was subjected to thermal analysis in the same manner as in the polymer (a). The results of the glass transition temperature measured by means of the differential scanning type calorimeter and the thermal decomposition temperature measured by the thermogravimetry are shown in Table 26.

### EXAMPLE 8

<Polymerization>

Photopolymerization was carried out in the same manner as in Example 6 to obtain 0.29 g of a polymer (c), except that the polymerizing time was changed to 120 minutes.

<Molecular Weight Measurement of Graft Chain>

A molecular weight of a graft chain in the polymer (c) was measured in the same manner as in the polymer (a). The result thereof is shown in Table 26.

<Thermal Analysis>

The polymer (c) was subjected to thermal analysis in the same manner as in the polymer (a). The results of the glass transition temperature measured by means of the differential scanning type calorimeter and the thermal decomposition temperature measured by the thermogravimetry are shown in Table 26.

### EXAMPLE 9

<Polymerization>

Photopolymerization was carried out in the same manner as in Example 6 to obtain 0.34 g of a polymer (d), except that the polymerizing time was changed to 180 minutes.

<Molecular Weight Measurement of Graft Chain>

A molecular weight of a graft chain in the polymer (d) was measured in the same manner as in the polymer (a). The result thereof is shown in Table 26.

<Thermal Analysis>

The polymer (d) was subjected to thermal analysis in the same manner as in the polymer (a). The results of the glass transition temperature measured by means of the differential scanning type calorimeter and the thermal decomposition temperature measured by the thermogravimetry are shown in Table 26.

### EXAMPLE 10

<Polymerization>

Photopolymerization was carried out in the same manner as in Example 6 to obtain 0.38 g of a polymer (e), except that the polymerizing time was changed to 240 minutes.

<Molecular Weight Measurement of Graft Chain>

A molecular weight of a graft chain in the polymer (e) was measured in the same manner as in the polymer (a). The result thereof is shown in Table 26.

<Thermal Analysis>

The polymer (e) was subjected to thermal analysis in the same manner as in the polymer (a). The results of the glass transition temperature measured by means of the differential scanning type calorimeter and the thermal decomposition temperature measured by the thermogravimetry are shown in Table 26.

### EXAMPLE 11

<Preparation of Polymerizing solution (B)>

A 200 ml Schrenk tube equipped with a stirrer was charged with the silicon compound (0.34 g) obtained in Example 5, methyl methacrylate (21 ml), toluene (45.5 ml) and decane (3.5 ml) under a dry nitrogen gas atmosphere in a draft in which a UV ray was cut, and the solution was sufficiently stirred at a room temperature to prepare a polymerizing solution (B).

<Polymerization>

The polymerizing solution (B) (3 ml) was sampled by means of a glass-made syringe under a dry nitrogen gas atmosphere and introduced into a 4 ml glass ampul, and then it was subjected to vacuum deaeration (vacuum degree: 1×10⁻² Pa) by means of a high vacuum device equipped with a diffusion pump and sealed in a vacuum state by means of a hand burner. The sealed ampul was set in a rotary photopolymerizing apparatus (400 W extra-high pressure mercury lamp: UVL-400HA, manufactured by Riko Kagaku Sangyo Co., Ltd.), and photopolymerization was carried out to obtain a pale yellow viscous polymer solution. The polymerization conditions were a light source distance: 150 mm, a UV ray illuminance (wavelength: 365 nm): 4.7 mW/cm², a rotating speed: 10 rpm and polymerizing time: 60 minutes. This polymer solution was subjected to reprecipitation refining treatment with methanol (100 ml), and then the precipitate was recovered by suction filtration. The precipitate was dried at 80° C. for 3 hours in a vacuum dryer to obtain 0.20 g of a polymer (f).

<Molecular Weight Measurement of Graft Chain>

A mixed solution of hydrofluoric acid (0.17 ml) and acetonitrile (0.83 ml) was prepared. The polymer (f) (15 mg) was dissolved in this mixed solution and stirred at a room temperature for 48 hours. Then, the solution was dried at 80° C. for 3 hours in a vacuum dryer to recover the polymer. The polymer recovered was subjected to GPC measurement, and the result thereof is shown in Table 27. The results of the glass transition temperature and the thermal decomposition temperature which were measured by thermal analysis are shown in Table 27. The measuring conditions thereof are the same as described in Example 6.

### EXAMPLE 12

<Polymerization>

Photopolymerization was carried out in the same manner as in Example 11 to obtain 0.29 g of a polymer (g), except that the polymerizing time was changed to 120 minutes.

<Molecular Weight Measurement of Graft Chain>

A molecular weight of a graft chain in the polymer (g) was measured in the same manner as in the polymer (f). The result thereof is shown in Table 27.

<Thermal Analysis>

The polymer (g) was subjected to thermal analysis in the same manner as in the polymer (f). The results of the glass transition temperature measured by means of the differential scanning type calorimeter and the thermal decomposition temperature measured by the thermogravimetry are shown in Table 27.

### EXAMPLE 13

<Polymerization>

Photopolymerization was carried out in the same manner as in Example 11 to obtain 0.37 g of a polymer (h), except that the polymerizing time was changed to 240 minutes.

<Molecular Weight Measurement of Graft Chain>

A molecular weight of a graft chain in the polymer (h) was measured in the same manner as in the polymer (f). The result thereof is shown in Table 27.

<Thermal analysis>

The polymer (h) was subjected to thermal analysis in the same manner as in the polymer (f) . The results of the glass transition temperature measured by means of the differential scanning type calorimeter and the thermal decomposition temperature measured by the thermogravimetry are shown in Table 27.

### EXAMPLE 14

<Polymerization>

Photopolymerization was carried out in the same manner as in Example 6 to obtain 0.44 g of a polymer (i), except that the polymerizing time was changed to 420 minutes.

<Molecular Weight Measurement of Graft Chain>

A molecular weight of a graft chain in the polymer (i) was measured in the same manner as in the polymer (f). The result thereof is shown in Table 27.

<Thermal Analysis>

The polymer (i) was subjected to thermal analysis in the same manner as in the polymer (f). The results of the glass transition temperature measured by means of the differential scanning type calorimeter and the thermal decomposition temperature measured by the thermogravimetry are shown in Table 27.

### EXAMPLE 15

<Polymerization>

Photopolymerization was carried out in the same manner as in Example 11 to obtain 0.52 g of a polymer (j), except that the polymerizing time was changed to 600 minutes.

<Molecular Weight Measurement of Graft Chain>

A molecular weight of a graft chain in the polymer (j) was measured in the same manner as in the polymer (f). The result thereof is shown in Table 26.

<Thermal Analysis>

The polymer (j) was subjected to thermal analysis in the same manner as in the polymer (f). The results of the glass transition temperature measured by means of the differential scanning type calorimeter and the thermal decomposition temperature measured by the thermogravimetry are shown in Table 27.

TABLE 26

| No. | Mn | Mw | Tg | Td |
|---|---|---|---|---|
| 6 | 6,200 | 15,000 | 110 | 288 |
| 7 | 8,400 | 19,000 | 112 | 293 |
| 8 | 13,000 | 24,000 | 114 | 294 |
| 9 | 12,000 | 27,000 | 115 | 298 |
| 10 | 13,000 | 31,000 | 114 | 302 |

TABLE 27

| No. | Mn | Mw | Tg | Td |
|---|---|---|---|---|
| 11 | 7,500 | 12,000 | 105 | 287 |
| 12 | 9,700 | 16,000 | 108 | 292 |
| 13 | 10,000 | 21,000 | 113 | 294 |
| 14 | 12,000 | 23,000 | 109 | 302 |
| 15 | 15,000 | 27,000 | 112 | 308 |

Symbols shown in Table 26 and Table 27 mean the following:
No.: example No.
Mw: weight average molecular weight of graft chain
Tg: glass transition point (° C.)
Td: thermal decomposition temperature (° C.)

### Industrial Applicability

The silicon compound provided by the present invention is a silsesquioxane derivative having a photopolymerization-initiating ability to a radically polymerizable monomer, and it is expected to reveal the characteristic completely different from those of conventional silsesquioxanes. That is, it is cage type silsesquioxane having a polymerization-initiating ability, and therefore coexistence of, for example, an acrylic monomer makes it possible to initiate polymerization to form an organic polymer with this silsesquioxane being used as a polymerization-initiating point. Accordingly, a very homogeneous organic-inorganic composite material can be obtained without causing coagulation of silsesquioxane which is a problem in conventional methods. Further, in the case of the silsesquioxane derivative of the present invention having a dialkylsiloxy group, the polymerization-initiating point is strongly bonded to cage type silsesquioxane via the dialkylsiloxy group which is highly flexible. Accordingly, it is anticipated that an organic-inorganic composite material which reveals characteristic completely different from those of conventional ones is obtained by using this silicon compound. The silicon compound of the present invention further has characteristics other than a function as a polymerization initiator. For example, a silsesquioxane derivative having halogenated alkylphenyl can effectively be used as an intermediate raw material which facilitates introduction of various functional groups. A silsesquioxane derivative having a dithiocarbamate group can be used in the fields in which a radiation resistance, a pharmacological activity such as a herbicidal effect, a complex-forming ability and a hydrophilicity thereof are effectively used. Accordingly, it is expected that the present invention brings about variety to the characteristics and the uses of silsesquioxane.

1. A silicon compound represented by Formula (1): 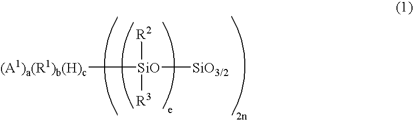
wherein symbols in Formula (1) are defined as follows;
A¹ is a group having a polymerization-initiating ability to a monomer;
R¹ is alkyl having 2 to 10 carbon atoms; in these alkyls, at least one hydrogen may be replaced by halogen, one —CH₂— may be replaced by —O—, and one hydrogen may be replaced by an aromatic group or an alicyclic group; and this aromatic group or alicyclic group may have a substituent;
R² and R³ are independently alkyl having 1 to 8 carbon atoms, phenyl or cyclohexyl;
n is an integer of 2 to 30;
e is 0or 1;
a is an integer of 1 to 2n, b is an integer of 0 to (2n−1), c is an integer of 0 to (2n−1); and the total of a, b and c is 2n.

2. The silicon compound according to claim 1, wherein A¹ in Formula (1) is a group selected from a group having halogenated alkylphenyl, a group having an MgBr group and a group having a dithiocarbamate group.

3. The silicon compound according to claim 1, wherein A¹ in Formula (1) is the group having halogenated alkylphenyl.

4-8. (Cancelled)

9. The silicon compound according to claim 1, wherein A¹ in Formula (1) is the group having a dithiocarbamate group.

10-17. (Cancelled)

18. A silicon compound obtained by polymerizing a vinyl type monomer with the compound represented by Formula (1) as described in claim 1 being used as an initiator.

19-24. (Cancelled)

25. The silicon compound according to claim 1, wherein A¹ is a group represented by Formula (2): 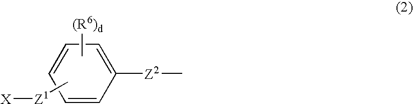
wherein symbols and the bonding positions of the substituents in Formula (2) are defined as follows;
X is halogen;
Z¹ is alkylene having 1 to 3 carbon atoms; Z² is alkylene having 2 to 10 carbon atoms; in these alkylenes, one —CH₂— may be replaced by —O—; and a bonding position of Z¹ to the benzene ring is a meta position or a para position to a bonding position of Z²;
R⁶ is alkyl having 1 to 3 carbon atoms; and a bonding position of R⁶ to the benzene ring is an optional position excluding the respective bonding positions of Z¹ and Z²; and
d is an integer of 0 to 2.

26. The silicon compound according to claim 25, wherein Z² in Formula (2) is Z³—C₂H₄—; Z³ is a single bond or alkylene having 1 to 8 carbon atoms; and in this alkylene, one —CH₂— may be replaced by —O—.

27. The silicon compound according to claim 1, wherein in Formula (1), both of R² and R³ are methyl, and n is an integer of 3 to 5.

28. The silicon compound according to claim 1, wherein in Formula (1), A¹ is a group represented by Formula (2); both of R² and R³ are methyl; a is 8; and n is 4: 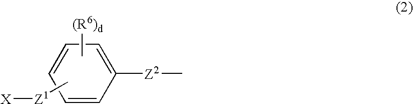
wherein symbols and the bonding positions of the substituents in Formula (2) are defined as follows;
X is halogen;
Z¹ is alkylene having 1 to 3 carbon atoms; Z² is alkylene having 2 to 10 carbon atoms; in these alkylenes, one —CH₂— may be replaced by —O—; and a bonding position of Z¹ to the benzene ring is a meta position or a para position to a bonding position of Z²;
R⁶ is alkyl having 1 to 3 carbon atoms; and a bonding position of R⁶ to the benzene ring is an optional position excluding the respective bonding positions of Z¹ and Z²; and
d is 0.

29. The silicon compound according to claim 28, wherein in Formula (2), Z¹ is —CH₂— and Z² is —CH₂CH₂—.

30. The silicon compound according to claim 1, wherein A¹ is a group represented by Formula (3): 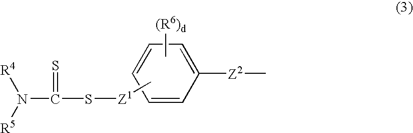
wherein symbols and the bonding positions of the substituents in Formula (3) are defined as follows;
R⁴ and R⁵ are independently hydrogen, alkyl having 1 to 12 carbon atoms, an alicyclic group having 5 to 10 carbon atoms or an aromatic group having 6 to 10 carbon atoms; R⁴ and R⁵ may be combined with each other to form a ring together with N;
Z¹ is alkylene having 1 to 3 carbon atoms; Z² is alkylene having 2 to 10 carbon atoms; in these alkylenes, one —CH₂— may be replaced by —O—; and a bonding position of Z¹ to the benzene ring is a meta position or a para position to a bonding position of Z²;
R⁶ is alkyl having 1 to 3 carbon atoms; and a bonding position of R⁶ to the benzene ring is an optional position excluding the respective bonding positions of Z¹ and Z²; and
d is an integer of 0 to 2.

31. The silicon compound according to claim 30, wherein Z² in Formula (3) is a group represented by Z³—C₂H₄—; Z³ is a single bond or alkylene having 1 to 8 carbon atoms; and in this alkylene, one —CH₂— may be replaced by —O—.

32. The silicon compound according to claim 1, wherein in Formula (1), A¹ is a group represented by Formula (3); both of R² and R³ are methyl, and n is an integer of 3 to 5: 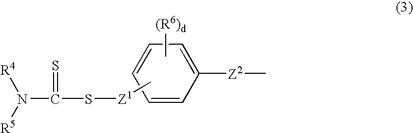
wherein symbols and the bonding positions of the substituents in Formula (3) are defined as follows;
R⁴ and R⁵ are independently hydrogen, alkyl having 1 to 12 carbon atoms, an alicyclic group having 5 to 10 carbon atoms or an aromatic group having 6 to 10 carbon atoms; R⁴ and R⁵ may be combined with each other to form a ring together with N;
Z¹ is alkylene having 1 to 3 carbon atoms; Z² is alkylene having 2 to 10 carbon atoms; in these alkylenes, one —CH₂— may be replaced by —O—; and a bonding position of Z¹ to the benzene ring is a meta position or a para position to a bonding position of Z² ;
R⁶ is alkyl having 1 to 3 carbon atoms; and a bonding position of R⁶ to the benzene ring is an optional position excluding the respective bonding positions of Z¹ and Z²; and
d is an integer of 0 to 2.

33. The silicon compound according to claim 1, wherein in Formula (1), A¹ is a group represented by Formula (3); both of R² and R³ are methyl; a is 8; and n is 4: 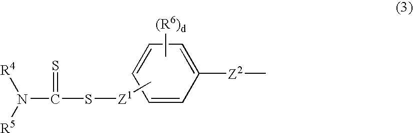
wherein symbols and the bonding positions of the substituents in Formula (3) are defined as follows;
R⁴ and R⁵ are ethyl;
Z¹ is alkylene having 1 to 3 carbon atoms; Z² is alkylene having 2 to 10 carbon atoms; in these alkylenes, one —CH₂— may be replaced by —O—; and a bonding position of Z¹ to the benzene ring is a meta position or a para position to a bonding position of Z²; and
d is 0.

34. The silicon compound according to claim 33, wherein in Formula (3), Z¹ is —CH₂— and Z² is —CH₂CH₂—.

35. A production process for a compound represented by Formula (1-1), characterized by carrying out, in the presence of a transition metal base catalyst, any of a process in which a compound represented by Formula (5) is reacted with a compound represented by Formula (6), a process in which the compound represented by Formula (5) is reacted with the compound represented by Formula (6) and a compound represented by Formula (7) at the same time, a process in which the compound represented by Formula (5) is reacted with the compound represented by Formula (6) and then reacted with the compound represented by Formula (7), and a process in which the compound represented by Formula (5) is reacted with the compound represented by Formula (7) and then reacted with the compound represented by Formula (6): 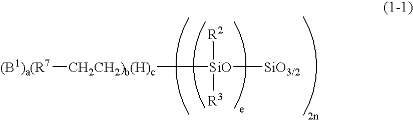
wherein symbols in Formula (1-1) are defined as follows;
R² and R³ are independently alkyl having 1 to 8 carbon atoms, phenyl or cyclohexyl;
n is an integer of 2 to 30;
e is 0 or 1;
a is an integer of 1 to 2n, b is an integer of 0 to (2n−1), c is an integer of 0 to (2n−1), and the total of a, b and c is 2n;
R⁷is hydrogen, halogen or alkyl having 1 to 8 carbon atoms; in these alkyls, at least one hydrogen may be replaced by halogen, one —CH₂— may be replaced by —O— and one hydrogen may be replaced by an aromatic group or an alicyclic group; and this aromatic group or alicyclic group may have a substituent;
B¹ is a group represented by the following Formula (4): 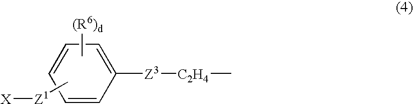
wherein symbols and the bonding positions of the substituents in Formula (4) are defined as follows;
X is halogen;
Z¹ is alkylene having 1 to 3 carbon atoms; Z² is alkylene having 2 to 10 carbon atoms; in these alkylenes, one —CH₂— may be replaced by —O—; and a bonding position of Z¹ to the benzene ring is a meta position or a para position to a bonding position of Z²;
R ⁶is alkyl having 1 to 3 carbon atoms; and a bonding position of R⁶ to the benzene ring is an optional position excluding the respective bonding positions of Z¹ and Z² ; and
d is an integer of 0 to 2;
Z³ is a single bond or alkylene having 1 to 8 carbon atoms; in this alkylene, one —CH₂— may be replaced by —O—;
a bonding position of Z¹ to the benzene ring is a meta position or a para position to a bonding position of Z³ ; and
a bonding position of R⁶ to the benzene ring is an optional position excluding the respective bonding positions of Z¹ and Z³; 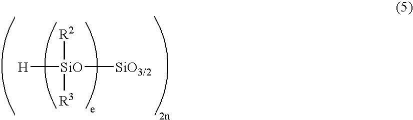
wherein R², R³, e and n in Formula (5) each are the same as these symbols in Formula (1-1); 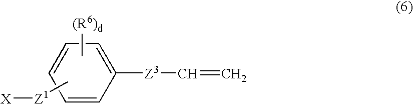
wherein symbols and the bonding positions of the substituents in Formula (6) each are the same as the symbols and the bonding positions of the substituents in Formula (4);
R⁷—CH═CH₂ (7)
wherein R⁷ in Formula (7) is the same as R⁷ in Formula (1-1).

36. A production process for a silicon compound represented by Formula (1-2), characterized by reacting the compound represented by Formula (1-1) as described in claim 35 with a compound represented by Formula (9): 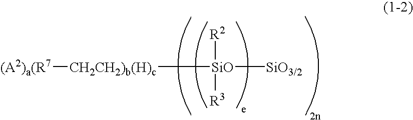
wherein symbols in Formula (1-2) are defined as follows;
R², R³, R⁷, a, b, c, e and n each are the same as these symbols in Formula (1-1) as described in claim 35;
A² is a group represented by the following Formula (8): 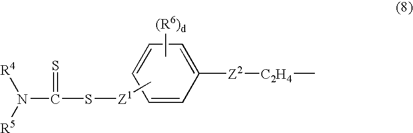
wherein symbols and the bonding positions of the substituents in Formula (8) are defined as follows;
R⁴ and R⁵ are independently hydrogen, alkyl having 1 to 12 carbon atoms, an alicyclic group having 5 to 10 carbon atoms or an aromatic group having 6 to 10 carbon atoms; R⁴ and R⁵ may be combined with each other to form a ring together with N;
Z¹ is alkylene having 1 to 3 carbon atoms;
R⁶ is alkyl having 1 to 3 carbon atoms;
d is an integer of 0 to 2;
Z³ is a single bond or alkylene having 1 to 8 carbon atoms; in this alkylene, one —CH₂— may be replaced by —O—;
a bonding position of Z¹ to the benzene ring is a meta position or a para position to a bonding position of Z³; and
a bonding position of R⁶ to the benzene ring is an optional position excluding the respective bonding positions of Z¹ and Z³; 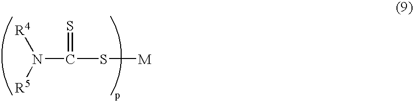
wherein symbols in Formula (9) are defined as follows;
R⁴ and R⁵ each are the same as these symbols in Formula (8);
M is a metal element of the first group or the second group in the periodic table; and
p is the same value as an atomic value of M.

37. A production process for the compound represented by Formula (1-2), characterized by carrying out the following step (a) and then (b): 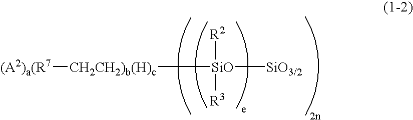
wherein symbols in Formula (1-2) are defined as follows;
R² and R³ are independently alkyl having 1 to 8 carbon atoms, phenyl or cyclohexyl;
n is an integer of 2 to 30;
e is 0 or 1;
a is an integer of 1 to 2n, b is an integer of 0to (2n−1), c is an integer of 0 to (2n−1), and the total of a, b and c is 2n;
R⁷ is hydrogen, halogen or alkyl having 1 to 8 carbon atoms; in these alkyls, at least one hydrogen may be replaced by halogen, one —CH₂— may be replaced by —O— and one hydrogen may be replaced by an aromatic group or an alicyclic group; and this aromatic group or alicyclic group may have a substituent;
A is a group represented by the following Formula (8): 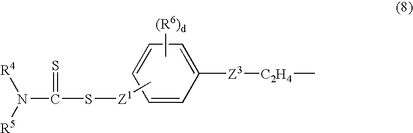
wherein symbols and the bonding positions of the substituents in Formula (8) are defined as follows;
R⁴ and R⁵ are independently hydrogen, alkyl having 1 to 12 carbon atoms, an alicyclic group having 5 to 10 carbon atoms or an aromatic group having 6 to 10 carbon atoms; R⁴ and R⁵ may be combined with each other to form a ring together with N;
Z¹ is alkylene having 1 to 3 carbon atoms;
R⁶ is alkyl having 1 to 3 carbon atoms;
d is an integer of 0 to 2;
Z³ is a single bond or alkylene having 1 to 8 carbon atoms; in this alkylene, one —CH₂— may be replaced by —O—;
a bonding position of Z¹ to the benzene ring is a meta position or a para position to a bonding position of Z³; and
a bonding position of R⁶ to the benzene ring is an optional position excluding the respective bonding positions of Z¹ and Z³;
(a) a step in which a compound represented by Formula (6) is reacted with a compound represented by Formula (9) to obtain a compound represented by Formula (10): 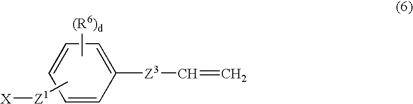
wherein symbols and the bonding positions of the substituents in Formula (6) are defined as follows;
X is halogen;
Z¹, Z³, R⁶, d and the bonding positions of the substituents each are the same as these symbols and the bonding positions of the substituents in Formula (8); 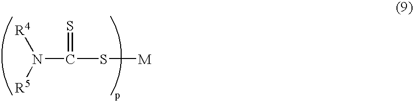
wherein symbols in Formula (9) are defined as follows;
R⁴ and R⁵ are the same as these symbols in Formula (8);
M is a metal element of the first group or the second group in the periodic table; and
p is the same value as an atomic value of M; 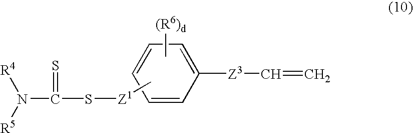
wherein symbols and the bonding positions of the substituents in Formula (10) each are the same as the symbols and the bonding positions of the substituents in Formula (8);
(b) a step for obtaining the compound represented by Formula (1-2) by carrying out, in the presence of a transition metal base catalyst, any of a process in which a compound represented by Formula (5) is reacted with the compound represented by Formula (10), a process in which the compound represented by Formula (5) is reacted with the compound represented by Formula (10) and a compound represented by Formula (7) at the same time, a process in which the compound represented by Formula (5) is reacted with the compound represented by Formula (10) and then reacted with the compound represented by Formula (7), and a process in which the compound represented by Formula (5) is reacted with the compound represented by Formula (7) and then reacted with the compound represented by Formula (10): 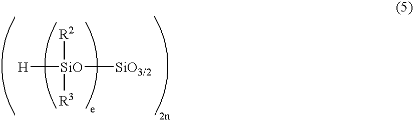
wherein R², R³, e and n in Formula (5) each are the same as these symbols in Formula (1-2);
R⁷—CH═CH₂ (7)
wherein R⁷ in Formula (7) is the same as R⁷ in Formula (1-2).

38. A silicon compound represented by Formula (11) obtained by polymerizing a vinyl type monomer with the compound represented by Formula (1-1) as described in claim 35 being used as an initiator and a transition metal complex being used as a catalyst: 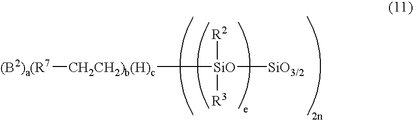
wherein symbols in Formula (11) are defined as follows;
R², R³, R⁷, a, b, c, e and n each are the same as these symbols in Formula (1-1) as described in claim 35;
B²is represented by the following Formula (4-1): 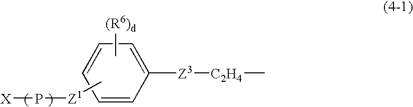
wherein symbols and the bonding positions of the substituents in Formula (4-1) are defined as follows;
X, Z¹ , R⁶, d, Z³ and the bonding positions of the substituents each are the same as these symbols and the bonding positions in Formula (4) as described in claim 35; and
P is a polymeric chain derived from a vinyl type monomer.

39. A silicon compound represented by Formula (12) obtained by photopolymerizing a vinyl type monomer with the compound represented by Formula (1-2) as described in claim 36 being used as an initiator: 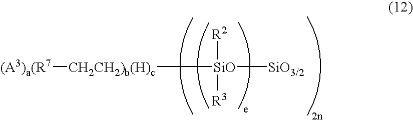
wherein symbols and the bonding positions of the substituents in Formula (12) are defined as follows;
R², R³, R⁷, a, b, c, e and n each are the same as these symbols in Formula (1-2) as described in claim 36;
A³is represented by the following Formula (8-1): 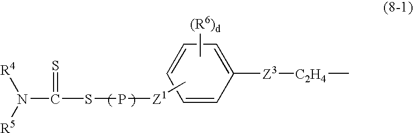
wherein symbols and the bonding positions of the substituents in Formula (8-1) are defined as follows;
R⁴ to R⁶, Z¹, d, Z³ and the bonding positions of the substituents each are the same as these symbols and the bonding positions of the substituents in Formula (8) as described in claim 36; and
P is a polymeric chain derived from a vinyl type monomer.

40. The silicon compound according to claim 38, wherein the vinyl type monomer is at least one compound selected from the group consisting of styrene derivatives and (meth)acrylic acid derivatives.

41. The silicon compound according to claim 39, wherein the vinyl type monomer is at least one compound selected from the group consisting of styrene derivatives and (meth)acrylic acid derivatives.

42. The silicon compound according to claim 38, wherein the vinyl type monomer is at least one compound selected from the group consisting of the (meth)acrylic acid derivatives.

43. The silicon compound according to claim 39, wherein the vinyl type monomer is at least one compound selected from the group consisting of the (meth)acrylic acid derivatives.
